(19) United States
(12) Patent Application Publication
(10) Pub. No.: US 2026/0071043 A1
(43) Pub. Date: Mar. 12, 2026

(54) ARTICLES COMPRISING A COMBINATION OF POLYMER AEROGEL AND MELAMINE-FORMALDEHYDE FOAM AND RELATED SYSTEMS AND METHODS

(71) Applicant: Aerogel Technologies, LLC, Boston, MA (US)

(72) Inventors: Stephen A. Steiner, III, Milwaukee, WI (US); Moriah C. Buckwalter, South Weymouth, MA (US); Justin S. Griffin, Watertown, MA (US); Ryan T. Nelson, Fort Collins, CO (US)

(73) Assignee: Aerogel Technologies, LLC, Boston, MA (US)

(21) Appl. No.: 18/856,218

(22) PCT Filed: Apr. 13, 2023
(86) PCT No.: PCT/US2023/018570

§ 371 Date: Oct. 11, 2024

Related U.S. Application Data
(60) Provisional application No. 63/331,718, filed on Apr. 15, 2022.
(60) Provisional application No. 63/331,750, filed on Apr. 15, 2022.

(51) Int. Cl. C08J 9/42; C09D 179/08; F16L 59/02

(52) U.S. Cl. CPC C08J 9/42; C09D 179/08; F16L 59/028; C08J 2361/28; C08J 2479/08

(57) ABSTRACT

Material combinations comprising a polymer aerogel and a melamine-formaldehyde foam, as well as methods of manufacture and applications thereof, are generally described herein.

### RELATED APPLICATIONS

This application claims priority under 35 U.S.C. § 119 (c) to U.S. Provisional Patent Application No. 63/331,718, filed Apr. 15, 2022, and entitled “Articles Comprising a Combination of Polymer Aerogel and Melamine-Formaldehyde Foam and Related Systems and Methods,” and to U.S. Provisional Patent Application No. 63/331,750, filed Apr. 15, 2022, and entitled “Articles Comprising a Combination of Polymer Acrogel and Melamine-Formaldehyde Foam and Related Systems and Methods,” each of which is incorporated herein by reference in its entirety for all purposes.

### TECHNICAL FIELD

Articles comprising a combination of polymer aerogel and melamine-formaldehyde foam, and related systems and methods, are generally described.

### SUMMARY

The present disclosure is related to articles comprising a combination of polymer aerogel and melamine-formaldehyde foams and related systems and methods. The subject matter of the present disclosure involves, in some cases, interrelated products, alternative solutions to a particular problem, and/or a plurality of different uses of one or more systems and/or articles.

In certain embodiments, material combinations are provided. In some embodiments, the material combination comprises a melamine-formaldehyde foam comprising an outer boundary; and a polyimide aerogel at least partially within the outer boundary of the melamine-formaldehyde foam.

In some embodiments, the material combination comprises a melamine-formaldehyde foam comprising an outer boundary; and a polymer aerogel at least partially within the outer boundary of the melamine-formaldehyde foam.

Certain aspects are related to methods. In some embodiments, the method comprises establishing contact between a melamine-formaldehyde foam and a liquid comprising polyimide aerogel precursor such that polyimide aerogel precursor penetrates an outer boundary of the melamine-formaldehyde foam; and forming a polyimide aerogel from the polyimide aerogel precursor such that the polyimide aerogel is present within the outer boundary of the melamine-formaldehyde foam.

In certain embodiments, the method comprises establishing contact between a melamine-formaldehyde foam and a liquid comprising polymer aerogel precursor such that polymer aerogel precursor penetrates an outer boundary of the melamine-formaldehyde foam; and forming a polymer aerogel from the polymer aerogel precursor such that the polymer aerogel is present within the outer boundary of the melamine-formaldehyde foam.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 depicts a melamine-formaldehyde foam, according to certain embodiments.

FIGS. 2A-2B depict a material combination comprising an aerogel and melamine-formaldehyde foam, according to certain embodiments.

FIG. 3A depicts a hydrophobic polyimide moiety, according to certain embodiments.

FIG. 3B depicts magnified views of the hydrophobic polyimide moiety in FIG. 3A, in accordance with certain embodiments. The left-hand side of the moiety in FIG. 3A is shown in magnified view at the top of FIG. 3B, and the right-hand side of the moiety in FIG. 3A is shown in magnified view at the bottom of FIG. 3B.

FIG. 4 depicts the molecular structures of several monomers, according to certain embodiments.

FIG. 5A depicts a foam/aerogel material combination with a water droplet on an exterior surface of the material combination and the contact angle of the water droplet and the surface of the material combination, in accordance with certain embodiments.

FIG. 5B depicts a foam/aerogel material combination (left), the material combination submerged in liquid water under a mesh to hold the material combination under water (middle), and the material combination after submersion in liquid water (right), in accordance with certain embodiments.

FIG. 6 depicts the apparatus used to measure thermal conductivity in accordance with the Calibrated Hot Plate (CHP) method described herein, according to certain embodiments.

FIG. 7 depicts the apparatus used to measure flexural strength and modulus of a material according to ASTM D790-10 as described herein, according to certain embodiments.

FIG. 8 depicts an aerogel comprising particulate material, according to certain embodiments.

FIG. 9 depicts a foam/aerogel material combination before exposure to an elevated temperature (left), the material combination while being exposed to an elevated temperature (middle), and the material combination after exposure to an elevated temperature (right), according to certain embodiments.

FIGS. 10A-10B depict the apparatus used to measure dust shedding of a material combination in its extended and contracted positions as described herein, according to certain embodiments.

FIG. 11 depicts a foam/aerogel material combination and its radius of curvature, according to certain embodiments.

FIG. 12A depicts a foam/aerogel material combination with a facing material over the entirety of an exterior surface of the material combination, in accordance with certain embodiments.

FIG. 12B depicts a foam/aerogel material combination with a facing material over portions of an exterior surface of the material combination, in accordance with certain embodiments.

FIG. 12C depicts a foam/aerogel material combination with an adhesive material over an exterior surface of the material combination, in accordance with certain embodiments.

FIG. 12D depicts a foam/aerogel material combination with an adhesive over an exterior of the material combination and a facing material over the adhesive, in accordance with certain embodiments.

FIG. 12E depicts a foam/aerogel material combination adhered to another foam/aerogel material combination, in accordance with some embodiments.

FIG. 13 depicts an apparel garment comprising a foam/aerogel material combination, in accordance with certain embodiments.

FIG. 14 depicts a shoe comprising a foam/aerogel material combination, according to certain embodiments.

FIG. 15A depicts foam/aerogel material combination between individual battery cells, in accordance with certain embodiments.

FIG. 15B depicts foam/aerogel material combination surrounding a plurality of battery cells, in accordance with certain embodiments.

FIG. 16 depicts a melamine-formaldehyde foam contacting an aerogel precursor and the precursor in at least one of the pores of the melamine-formaldehyde foam, according to certain embodiments.

FIG. 17 depicts a melamine-formaldehyde foam contacting a vapor comprising a hydrophobe, according to certain embodiments.

FIG. 18 depicts a melamine-formaldehyde foam before mechanical or thermal processing (left), the melamine-formaldehyde foam while undergoing mechanical and thermal processing (middle), and the melamine-formaldehyde foam after undergoing mechanical or thermal processing (right), according to certain embodiments.

FIG. 19A depicts aerogel precursor being poured onto melamine-formaldehyde foam, in accordance with certain embodiments.

FIG. 19B depicts aerogel precursor being sprayed onto melamine-formaldehyde foam, in accordance with certain embodiments.

FIG. 19C depicts aerogel precursor being injected into melamine-formaldehyde foam, in accordance with certain embodiments.

FIG. 19D depicts melamine-formaldehyde foam submerged in aerogel precursor, in accordance with certain embodiments.

FIG. 20A depicts melamine-formaldehyde foam running through a bath of aerogel precursor, in accordance with certain embodiments.

FIG. 20B depicts melamine-formaldehyde foam being compressed while in contact with aerogel precursor and re-expanding while still in contact with the aerogel precursor, in accordance with certain embodiments.

FIG. 21 depicts a foam/gel material combination submerged in a bath of transfer solvent where the transfer solvent is continuously replacing the liquid in the pores of the material combination, according to certain embodiments.

FIGS. 22A-22F are schematic diagrams of volumes showing inner percentages of those volumes, in accordance with certain embodiments.

FIG. 23 is, in accordance with certain embodiments, a pair of SEM images of the foam/aerogel material combination of Sample Number 2 of Example 1, showing both the nanostructured phase and macrostructured phase of the material combination. The image on the left shows pores of the melamine-formaldehyde foam and the solid skeletal melamine-formaldehyde material. Inside of these pores, polyimide aerogel can be seen in some cases not attached to the melamine-formaldehyde skeleton and in some places attached to the melamine-formaldehyde skeleton. The image on the right is a magnified (120,000×) image of the polyimide aerogel of the left image (2000× magnification), showing the nano-porous structure of the aerogel within the pores of the foam.

FIG. 24 is a nitrogen sorption isotherm (left) and a graph of pore volume vs pore width (right) of the foam/aerogel material combination of Sample 2 of Example 1, according to certain embodiments. These plots outlay the nanostructure and nano-porosity of the aerogel within the foam/aerogel material combination.

FIGS. 25A-25C are stress-strain curves of three different foam/aerogel material combinations, in accordance with certain embodiments. FIG. 25A is a stress-strain curve of Sample 1 from Example 1. FIG. 25B is a stress-strain curve of Sample 3 from Example 1. FIG. 25C is a stress-strain curve of Sample 5 from Example 1.

### DETAILED DESCRIPTION

Articles comprising a combination of polymer aerogel and melamine-formaldehyde foam and related systems and methods are generally described. A melamine-formaldehyde foam can be combined with (e.g., infused with) a polymer aerogel or polymer aerogel precursor to fabricate a material combination comprising the foam and the polymer aerogel. Such material combinations that include both an aerogel (e.g., a polymer aerogel such as a polyimide aerogel) and a foam (e.g., melamine-formaldehyde foam) in which the aerogel is located at least partially within the outer boundaries of the foam are also referred to herein as “aerogel/foam material combinations.”

In certain embodiments, the aerogel/foam material combination comprises a polyimide aerogel in combination with a melamine-formaldehyde foam, and such combinations can provide, in accordance with certain embodiments, a number of advantages. However, it should be understood that the present disclosure is not so limited, and other aerogel/foam material combinations can also be useful. Accordingly, the aerogel/foam material combinations described herein include combinations that comprise other types of aerogels (e.g., other types of polymer aerogels, such as other types of organic polymer aerogels) and/or other types of foams.

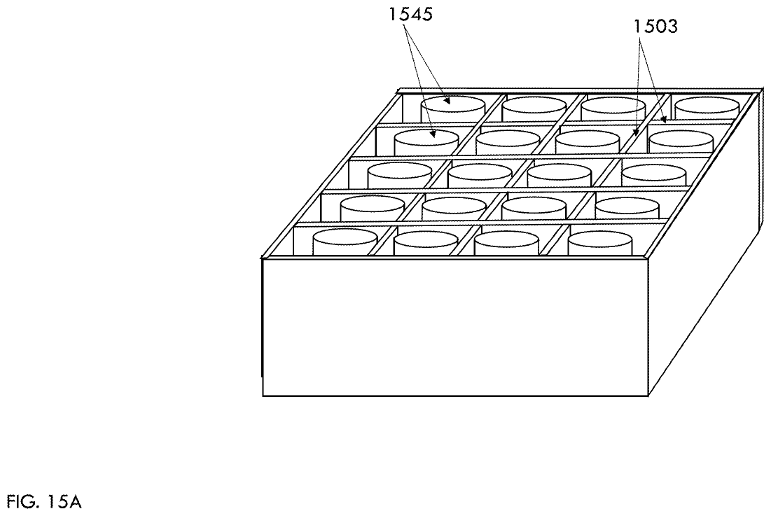

Material combinations comprising polymer aerogels and melamine-formaldehyde foams (e.g., polymer aerogel-infused melamine-formaldehyde foams) can potentially combine numerous valuable materials properties into a single material envelope, such as high mass-normalized strength and stiffness properties, low density, low and constant dielectric constant and loss tangent over wide frequency range, low speed of sound, high sound transmission loss, low flammability or nonflammability, machinability, and low thermal conductivity. Potential applications of aerogel/foam material combinations (such as aerogel/foam material combinations comprising polymer aerogels and melamine-formaldehyde foams) include aircraft interior parts, e.g., wall panels, floor boards, cockpit doors, and galley furnishings; engine covers or body frame insulation for automobiles; electric vehicle battery pack insulation; shockwave-reflecting and/or energy-absorbing materials in ballistics shields; insulative components for shoes, boots, and insoles; vibration and acoustic insulation for rocket fairings; low-k substrates for electronics and antennas, among other applications. For example, FIGS. 15A-15B schematically illustrate a foam/aerogel material combination 1503 adjacent to batteries 1545. In FIG. 15A, aerogel/foam material combination 1503 has been positioned between battery cells. In particular, aerogel/foam material combination 1503 has been arranged to form a matrix of compartments into which the cells have been positioned. In FIG. 15B, aerogel/foam material combination has been used to form the outer walls of a compartment containing cells 1545. Combinations of these arrangements are also possible.

Aerogels are a diverse class of low-density solid materials comprised of a porous three-dimensional solid-phase network. Aerogels often exhibit a wide array of desirable materials properties including high specific surface area, low bulk density, high specific strength and stiffness, low thermal conductivity, and/or low dielectric constant, among others.

In some embodiments, the aerogel comprises a polymer aerogel. A polymer aerogel is an aerogel that is at least partially made of polymeric material. The use of aerogels comprising a relatively high amount of polymeric material can be particularly advantageous, in some embodiments. Thus, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel in the aerogel/foam material combination is made of polymeric material. In some embodiments, at least 25 wt %, at least 50 wt %, at least 75 wt %, at least 90 wt %, at least 95 wt %, at least 98 wt %, at least 99 wt %, at least 99.9 wt %, or all of the aerogel within the aerogel/foam material combination is made of organic polymer, i.e., a polymer having carbon atoms in its backbone. In some embodiments, it can be particularly advantageous to employ polymeric aerogels in which at least 75 atomic percent (at %) (or at least 85 at %, at least 95 at %, at least 99 at %, at least 99.9 at %, or more) of the aerogel material is polymeric material comprising covalently-bonded carbon in its backbone and in which at least 75 at % of the backbone atoms are carbon, nitrogen, oxygen, phosphorous, or sulfur. Examples of organic polymers that can be used as all or part of the aerogel component of the aerogel/foam material combination include, but are not limited to, polyamides, polyimides, polyureas, polyurethanes, polybenzoxazines, polycylopentadienes, polyolefins, polynorbornenes, and biopolymers.

In accordance with certain embodiments, polymer aerogels when combined with melamine-formaldehyde foam may provide an aerogel infused foam with desirable properties. Polymer aerogel systems that are particularly suited for use in material combinations with melamine-formaldehyde foam include polyimides and polyisocyanates (e.g., polyureas and polyamides).

In certain cases, the combination of melamine-formaldehyde foam with polyimide aerogels leads to particularly advantageous properties. The inventors have observed the unexpected result that combining a melamine-formaldehyde foam with a polyimide aerogel (e.g., by any of the various methods described herein) yields improved thermal and/or mechanical performance as compared to either material when measured independently. This result was observed to a larger degree in polyimide aerogel/melamine-formaldehyde foam combinations than in other aerogel infused foams. The inventors have also observed unexpected increases in thermal stability, while maintaining hydrophobicity and favorable mechanical properties, in polyurea aerogel/foam material combinations.

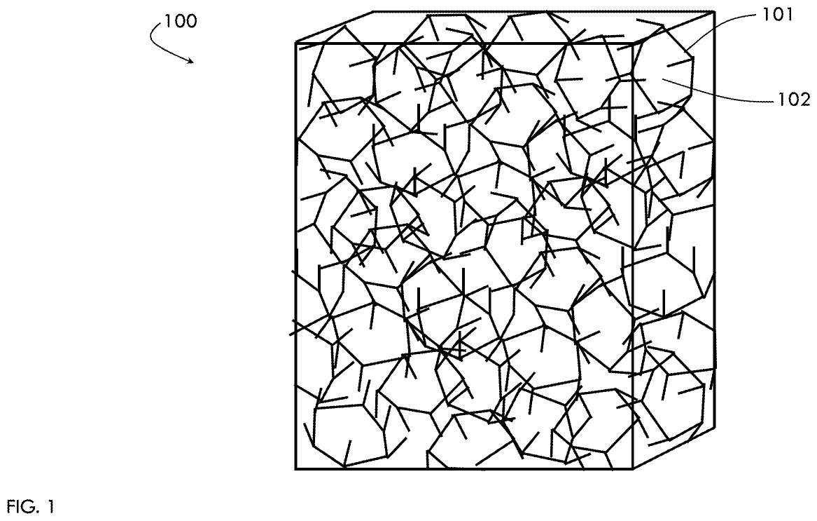

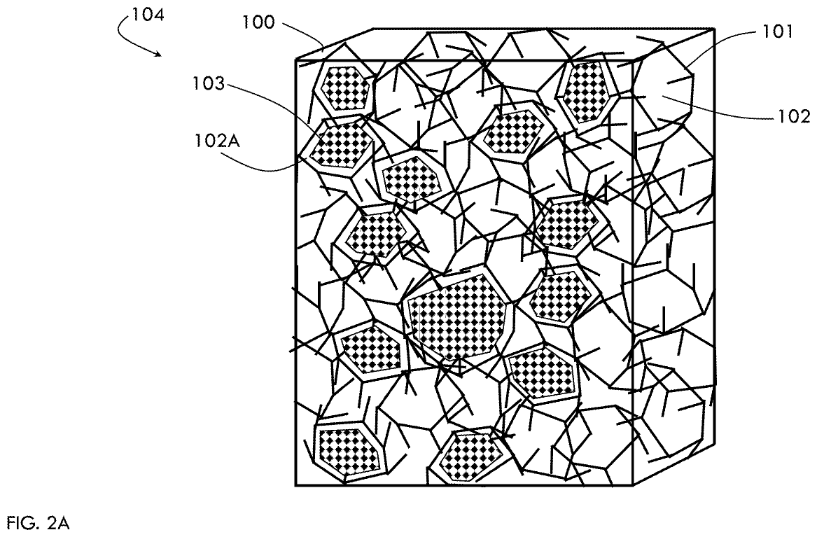

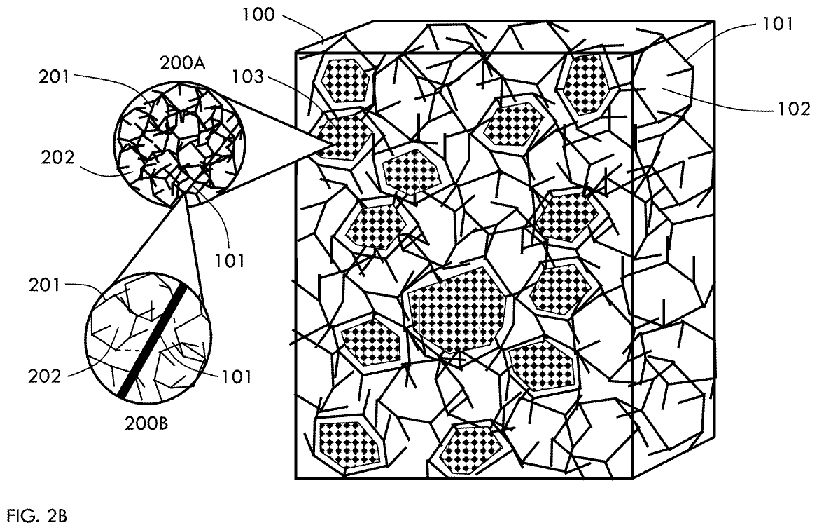

In some embodiments, a material combination is provided comprising a melamine-formaldehyde foam and a polymer aerogel at least partially within the outer boundaries of the melamine-formaldehyde foam. By way of illustration and not limitation, FIG. 1 is a schematic diagram of a foam 100. Foam 100 is porous and comprises a solid foam material 101 within which a plurality of pores 102 are arranged. Aerogel or aerogel precursor may be introduced into the pores of the foam (e.g., into open cell pores of the foam by filling, infusion, or any other form of infiltration) and be processed to form a material combination of foam and aerogel. For example, as shown schematically in FIG. 2A, aerogel precursor has been introduced into pore 102A (and into other pores) of foam 100 and processed to form aerogel 103 within pore 102A (and, again, other pores of the foam). The schematic illustration in FIG. 2A is, thus, an example of an aerogel/foam material combination 104.

FIG. 2B is a schematic illustration of the aerogel/foam material combination of FIG. 2A, with magnified views 200A and 200B of the aerogel component. As shown in views 200A and 200B, aerogel 103 comprises solid aerogel material 201 within which a plurality of pores 202 are arranged. When arranged in this manner, the foam can form a relatively large foam domain with relatively large pores, with the relatively large pores at least partially occupied by smaller aerogel sub-domains having smaller pores. In some embodiments, the smaller aerogel sub-domains are connected to each other such that they, together, form a larger, contiguous aerogel domain.

As mentioned above, in accordance with certain embodiments, aerogel/foam material combinations may be made by infusing or otherwise combining an aerogel precursor into a foam. For example, some embodiments comprise combining an aerogel precursor with a foam, optionally gelling the precursor to form a gel at least partially within pores of the foam, and forming an aerogel from the gel (e.g., by removing liquid from the gel) to form an aerogel/foam material combination. Various methods of forming aerogel/foam material combinations are described below and elsewhere herein. Similarly, various methods of forming precursors of such combinations (e.g., combinations of gel precursors and foams, combinations of gels and foams, etc.) are described below.

A gel is a colloidal system in which a porous, solid-phase network spans the volume occupied by a liquid medium. Accordingly, gels have two components: a sponge-like solid skeleton, which gives the gel its solid-like cohesiveness, and a liquid that permeates the pores of that skeleton.

Certain aspects are related to methods of forming aerogels, gels, material combinations (e.g., combinations of gel and foam, combinations of aerogel and foam), and/or precursors thereof.

In some embodiments, a method for producing an aerogel/foam material combination comprising polymer aerogel (e.g., polyimide aerogel) and a melamine-formaldehyde foam is provided. In some embodiments, contact is established between a melamine-formaldehyde foam and a liquid comprising polymer aerogel precursor such that polymer aerogel precursor penetrates outer boundaries of the melamine-formaldehyde foam.

The polymer aerogel precursor can be present in the liquid in any of a variety of suitable forms. In some embodiments, the liquid is a carrier liquid, and pre-polymer (e.g., monomer, short-chain polymer, or the like) can be dissolved, suspended, or otherwise carried in the carrier liquid. In some embodiments, the combination of the liquid and the pre-polymer can be gelled (e.g., such that the pre-polymer is polymerized and/or cross-linked), optionally in the presence of a catalyst, such that, in the gel that is formed, the carrier liquid is present within pores of the polymerized and/or cross-linked pre-polymer. In some embodiments, the carrier liquid can first be exchanged with another carrier liquid, and gelation can then be performed such that the second carrier liquid is present within pores of the polymerized and/or cross-linked pre-polymer.

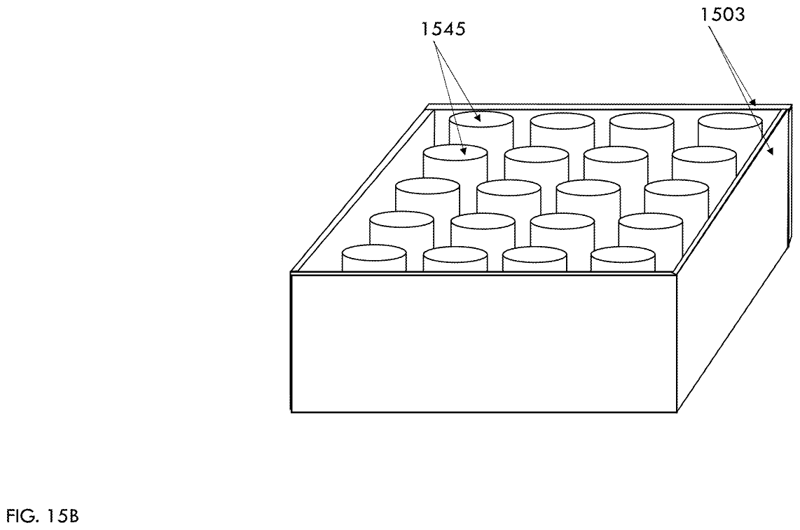

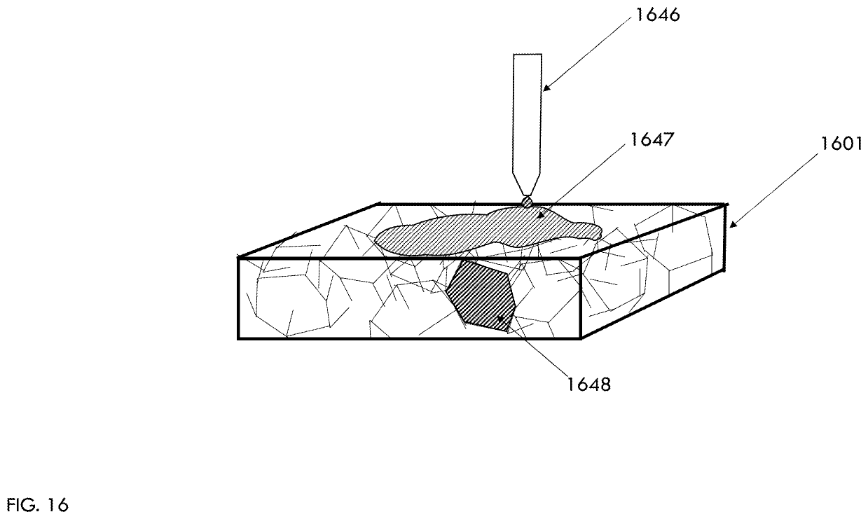

Contact between the foam and the liquid can be achieved using any of the variety of suitable methods. In some embodiments, a liquid comprising polymer aerogel precursor is contacted with a melamine-formaldehyde foam. In some embodiments, the liquid can be added to the foam, for example, by pouring the liquid onto the foam, spraying the liquid onto the foam, or otherwise adding the liquid to the foam. By way of illustration and not limitation, FIG. 16 schematically illustrates an example of this process. In FIG. 16, a conduit 1646 dispenses a liquid 1647 (comprising polymer aerogel precursor) on foam 1601. In FIG. 16, the liquid 1647 infiltrates a pore 1648 of the foam 1601.

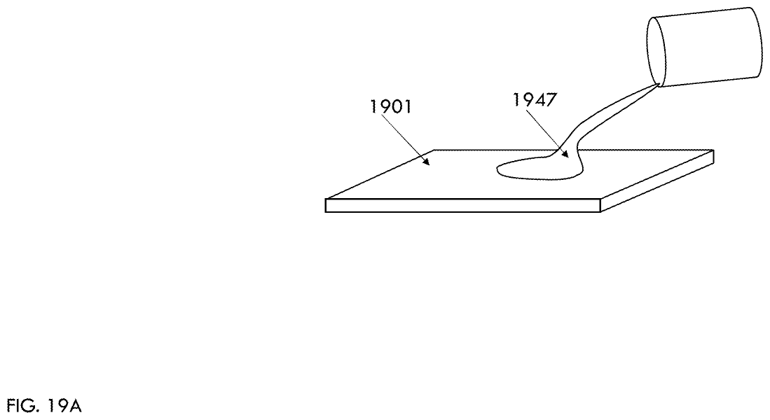

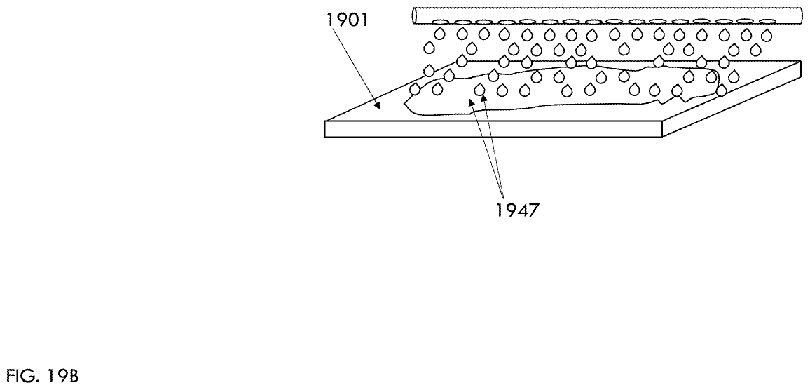

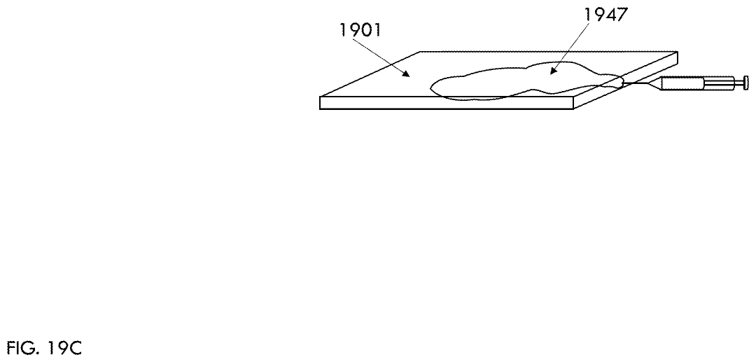

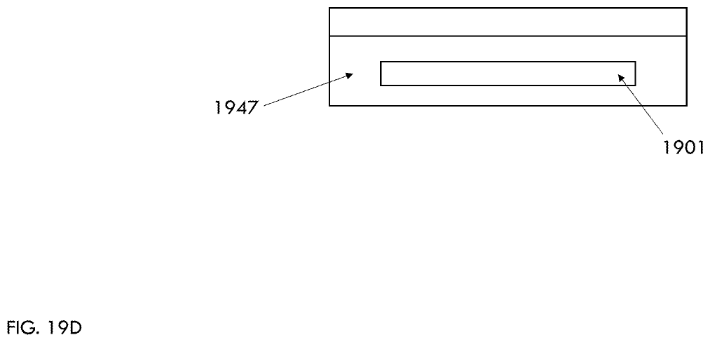

In some embodiments, a melamine-formaldehyde foam is contacted with a liquid comprising polymer aerogel precursor. In some embodiments, the foam can be added to the liquid by dipping the foam in, contacting the foam with the liquid such that the liquid infiltrates the pores of the foam via capillary action, or otherwise placing the foam into contact with the liquid. In FIG. 19A, liquid 1947 is poured over foam 1901. In FIG. 19B, liquid 1947 is sprayed over foam 1901. In FIG. 19C, liquid 1947 is injected into foam 1901. In FIG. 19D, foam 1901 is submerged in a bath of liquid 1947. Of course, other techniques for bringing the liquid (comprising aerogel precursor) into contact with the foam are possible, as this disclosure is not so limited.

In certain embodiments, polymer aerogel is formed from the polymer aerogel precursor such that the polymer aerogel is present within the outer boundaries of the melamine-formaldehyde foam.

Various embodiments are described in which an aerogel is located within the bulk of a foam. Such arrangements may be achieved, for example, by combining an aerogel precursor and a foam such that the aerogel precursor is located within the bulk of the foam (e.g., via infusion, injection, or otherwise) and forming the aerogel within the bulk of the foam.

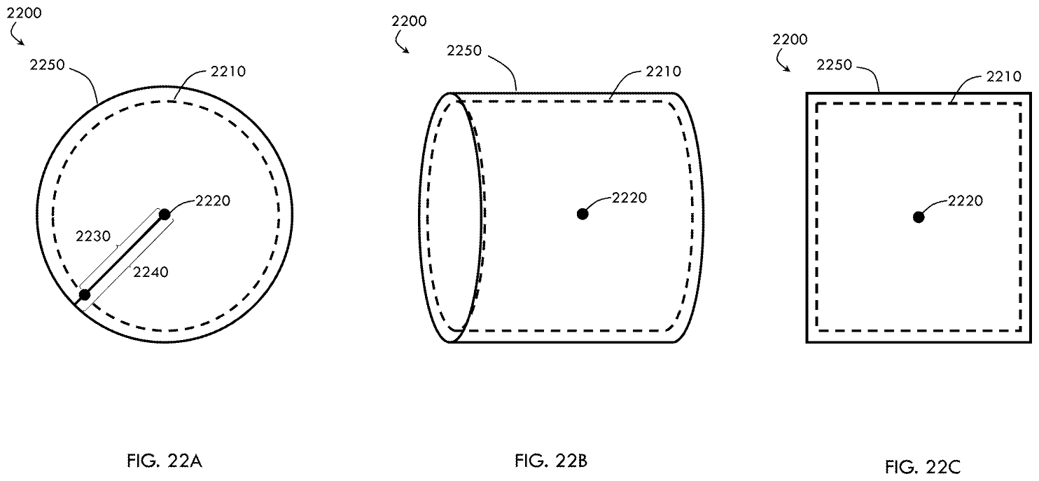

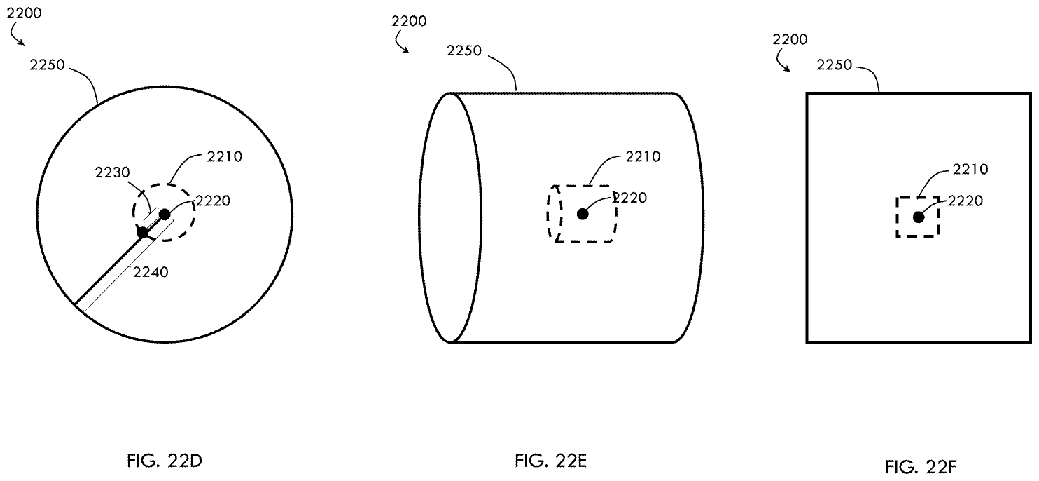

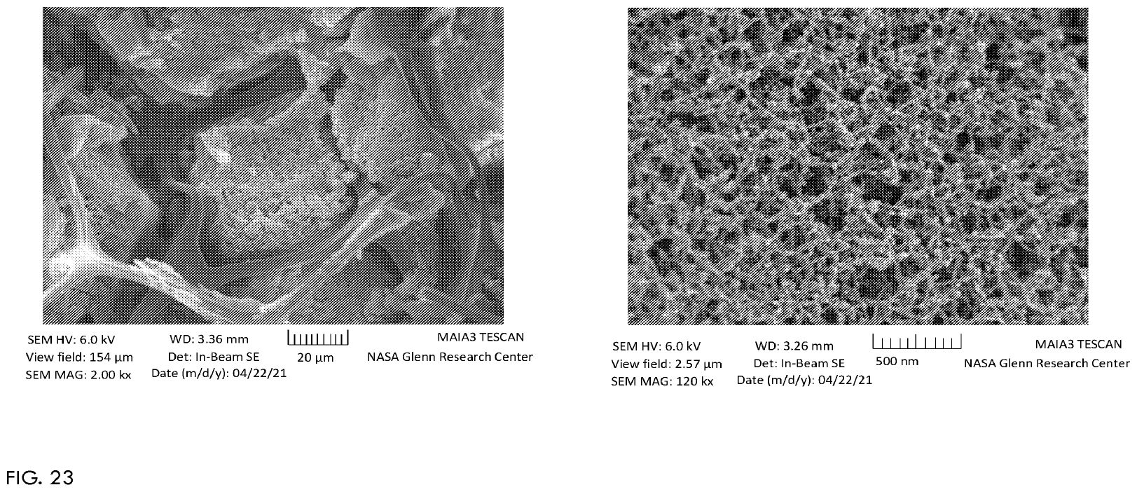

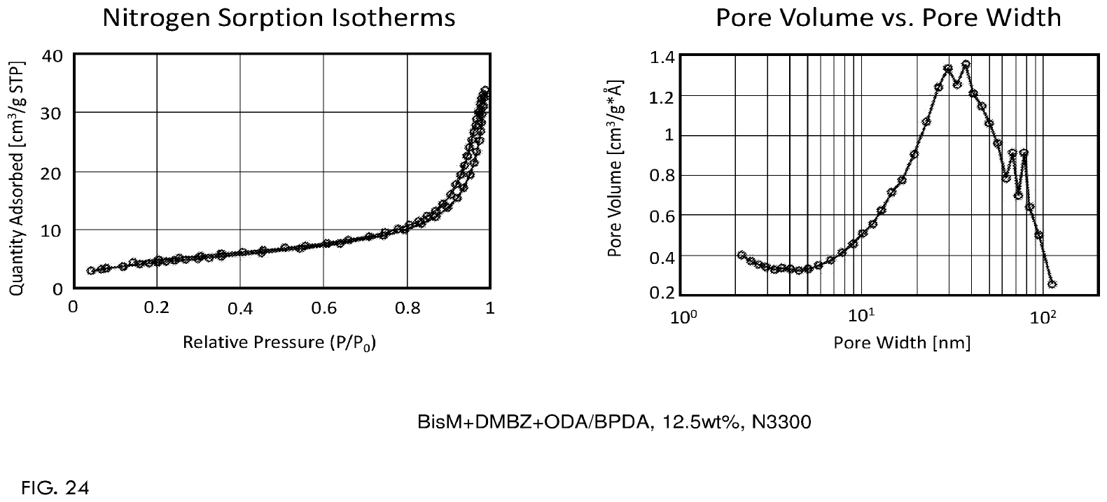

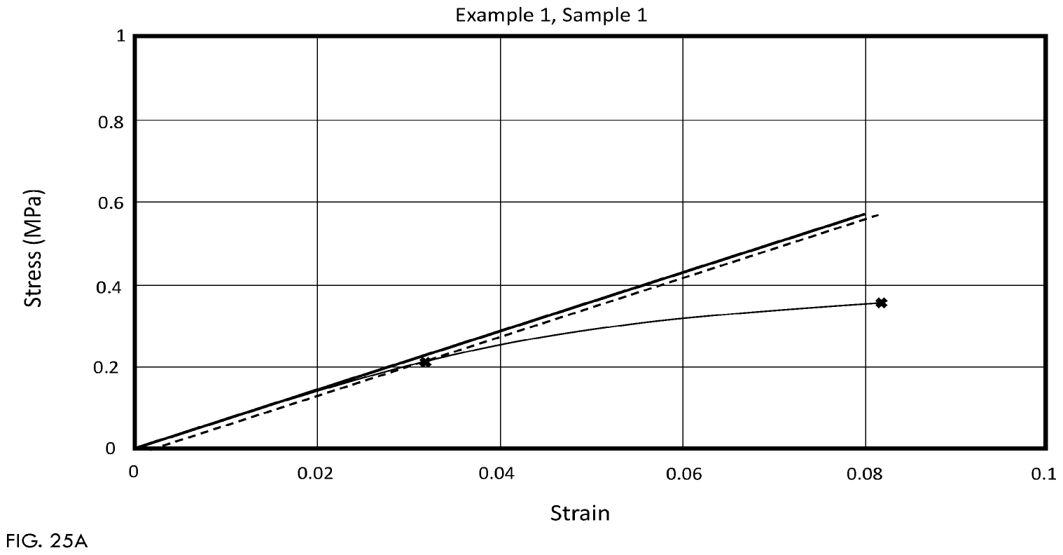

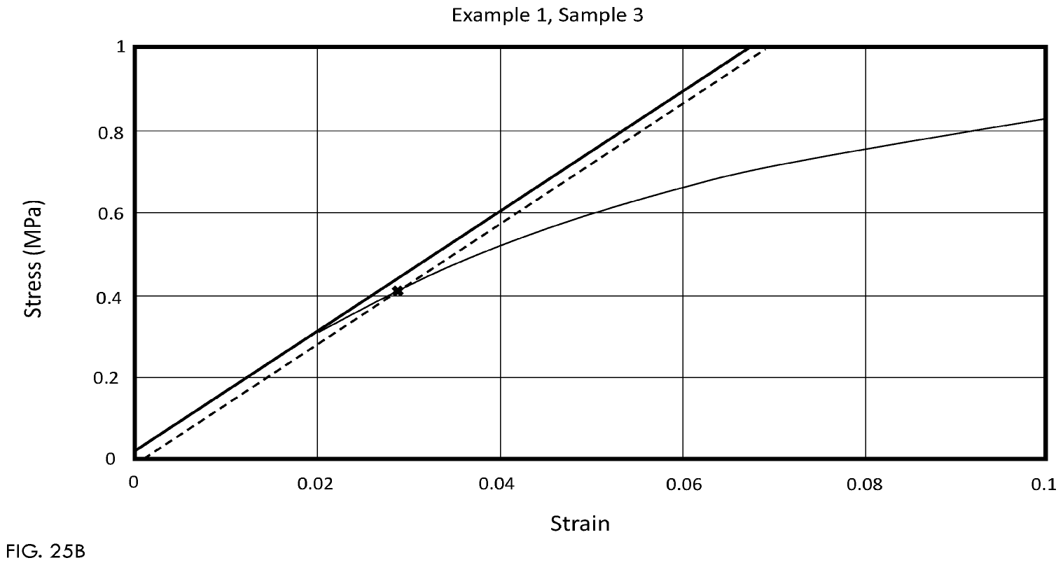

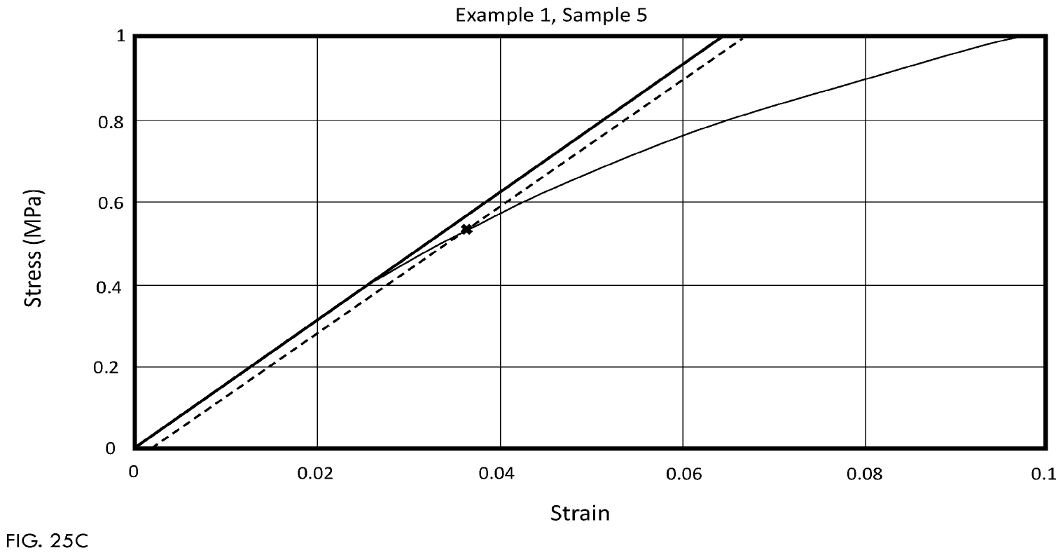

In some embodiments, the aerogel precursor, the gel, and/or the aerogel is present within the inner 90%, within the inner 75%, within the inner 50%, within the inner 25%, within the inner 15%, within the inner 10%, within the inner 5%, or within the inner 2% of the foam. The “inner 90%” of the foam represents the sub-volume of the foam that is made up of the geometric center of the foam and all points occupied by all line segments that begin at the geometric center of the foam and extend a distance that is 90% of the way to the outer boundary of the foam. Similarly, the “inner 20%” of the foam represents the sub-volume of the foam that is made up of the geometric center of the foam and all points occupied by all line segments that begin at the geometric center of the foam and extend a distance that is 20% of the way to the outer boundary of the foam. Such sub-volumes of the foam will have the same shape as the overall foam, but will be smaller in size. One example of such sub-volumes is shown in FIGS. 22A-22C, each of which shows a view of volume 2200 (e.g., a foam). FIG. 22A is a side view of volume 2200, FIG. 22B is a perspective view of volume 2200, and FIG. 22C is a front view of volume 2200. The “inner 90 vol %” of volume 2200 corresponds to sub-volume 2210 because sub-volume 2210 is made up of geometric center 2220 of volume 2200, all points on line segment 2230 (which extends from geometric center 2220 to a distance that is 90% of the way along line segment 2240, which is the shortest distance from geometric center 2220 to outer boundary 2250 of volume 2200), and all other points on all other line segments that extend from geometric center 2220 to a distance that is 90% of the way to outer boundary 2250 of volume 2200. FIGS. 22D-22F provide a similar illustration in which sub-volume 2210 is the inner 20 vol % of volume 2200.

In some embodiments, at least 20 vol %, at least 30 vol %, at least 40 vol %, at least 50 vol %, at least 60 vol %, at least 70 vol %, at least 80 vol %, at least 90 vol %, at least 95 vol %, at least 98 vol %, at least 99 vol %, at least 99.9 vol %, or more of the pore volume of the foam is occupied by aerogel precursor after the aerogel precursor and the foam have been combined.

In some embodiments, establishing contact between the melamine-formaldehyde foam and the liquid comprising the polymer aerogel precursor comprises spraying the liquid comprising the polymer aerogel precursor onto the melamine-formaldehyde foam. In some embodiments, the liquid comprising the polymer aerogel precursor is sprayed onto an entire surface of the melamine-formaldehyde foam. In some embodiments, the liquid comprising the polymer aerogel precursor is sprayed onto part of a surface of the melamine-formaldehyde foam. In some embodiments, the liquid comprising the polymer aerogel precursor is sprayed onto the melamine-formaldehyde foam in a continuous manner. In some embodiments, the liquid comprising the polymer aerogel precursor is sprayed onto the melamine-formaldehyde foam in a discontinuous manner. In some embodiments, a volume of liquid comprising the polymer aerogel precursor is sprayed onto the melamine-formaldehyde foam such that the void space within the outer boundaries of the melamine-formaldehyde foam is partially filled with liquid comprising the polymer aerogel precursor. In some embodiments, a volume of liquid comprising the polymer aerogel precursor is sprayed onto the melamine-formaldehyde foam such that essentially all (e.g., at least 90%, at least 95%, at least 99%, or 100%) of the void space within the outer boundaries of the melamine-formaldehyde foam is filled with liquid comprising the polymer aerogel precursor. In some embodiments, the liquid comprising the polymer aerogel precursor is sprayed onto the melamine-formaldehyde foam such that strategic portions of the void pace within outer boundaries of the melamine-formaldehyde foam are filled with liquid comprising the polymer aerogel precursor.

In some embodiments, establishing contact between the melamine-formaldehyde foam and the liquid comprising the polymer aerogel precursor comprises pouring the liquid comprising the polymer aerogel precursor onto the melamine-formaldehyde foam. In some embodiments, the liquid comprising the polymer aerogel precursor is poured onto an entire surface of the melamine-formaldehyde foam. In some embodiments, the liquid comprising the polymer aerogel precursor is poured onto part of a surface of the melamine-formaldehyde foam. In some embodiments, the liquid comprising the polymer aerogel precursor is poured onto the melamine-formaldehyde foam in a continuous manner. In some embodiments, the liquid comprising the polymer aerogel precursor is poured onto the melamine-formaldehyde foam in a discontinuous manner. In some embodiments, a volume of liquid comprising the polymer aerogel precursor is poured onto the melamine-formaldehyde foam such that the void space within the outer boundaries of the melamine-formaldehyde foam is partially filled with liquid comprising the polymer aerogel precursor. In some embodiments, a volume of liquid comprising the polymer aerogel precursor is poured onto the melamine-formaldehyde foam such that essentially all (e.g., at least 90%, at least 95%, at least 99%, or 100%) of the void space within the outer boundaries of the melamine-formaldehyde foam is filled with liquid comprising the polymer aerogel precursor. In some embodiments, the liquid comprising the polymer aerogel precursor is poured onto the melamine-formaldehyde foam such that strategic portions of the voids pace within outer boundaries of the melamine-formaldehyde foam are filled with liquid comprising the polymer aerogel precursor.

In some embodiments, establishing contact between the melamine-formaldehyde foam and the liquid comprising the polymer aerogel precursor comprises injecting the liquid comprising the polymer aerogel precursor into the melamine-formaldehyde foam. In some embodiments, the liquid comprising the polymer aerogel precursor is injected into the melamine-formaldehyde foam through one surface of the melamine-formaldehyde foam. In some embodiments, the liquid comprising the polymer aerogel precursor is injected into the melamine-formaldehyde foam through more than one point on the same surface of the melamine-formaldehyde foam. In some embodiments, the liquid comprising the polymer aerogel precursor is injected into the melamine-formaldehyde foam through more than one point on different surfaces of the melamine-formaldehyde foam. In some embodiments, the liquid comprising the polymer aerogel precursor is injected into the melamine-formaldehyde foam in a continuous manner. In some embodiments, the liquid comprising the polymer aerogel precursor is injected into the melamine-formaldehyde foam in a discontinuous manner. In some embodiments, a volume of liquid comprising the polymer aerogel precursor is injected into the melamine-formaldehyde foam such that the void space within the outer boundaries of the melamine-formaldehyde foam is partially filled with polymer aerogel precursor. In some embodiments, a volume of liquid comprising the polymer aerogel precursor is injected into the melamine-formaldehyde foam such that essentially all (e.g., at least 90%, at least 95%, at least 99%, or 100%) of the void space within the outer boundaries of the melamine-formaldehyde foam is filled with liquid comprising the polymer aerogel precursor. In some embodiments, the liquid comprising the polymer aerogel precursor is injected into the melamine-formaldehyde foam such that strategic portions of the void space within the outer boundaries of the melamine-formaldehyde foam are filled with liquid comprising the polymer aerogel precursor.

In some embodiments, establishing contact between the melamine-formaldehyde foam and the liquid comprising the polymer aerogel precursor comprises submerging the melamine-formaldehyde foam in the liquid comprising the polymer aerogel precursor. In some embodiments, the melamine-formaldehyde foam is partially submerged in the liquid comprising the polymer aerogel precursor. In some embodiments, the melamine-formaldehyde foam is fully submerged in the liquid comprising the polymer aerogel precursor. In some embodiments, the melamine-formaldehyde foam is submerged in the liquid comprising the polymer aerogel precursor such that strategic portions of the void space within the outer boundaries of the melamine-formaldehyde foam are filled with liquid comprising the polymer aerogel precursor. In some embodiments, the melamine-formaldehyde foam is submerged in liquid comprising the polymer aerogel precursor for an amount of time to allow the polymer aerogel precursor in the void space within the outer boundaries of the melamine-formaldehyde foam to gel.

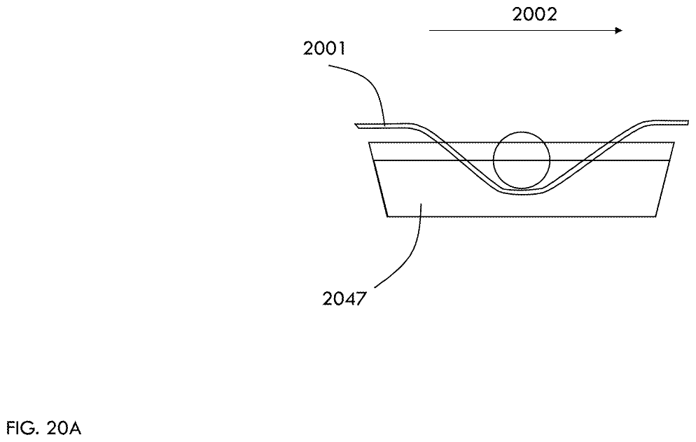

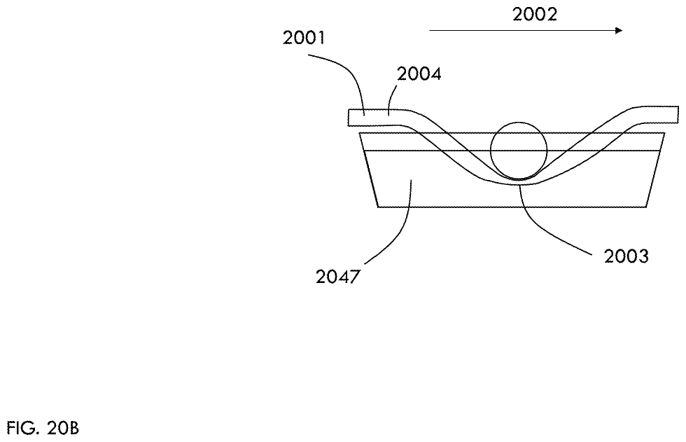

In some embodiments, establishing contact between the melamine-formaldehyde foam and the liquid comprising the polymer aerogel precursor comprises moving the melamine-formaldehyde foam through a bath of the liquid comprising the polymer aerogel precursor such that the liquid comprising the polymer aerogel precursor is absorbed by the melamine-formaldehyde foam. One example of this arrangement is shown in FIG. 20A, in which contact is established between melamine-formaldehyde foam 2001 and liquid comprising the polymer aerogel precursor by moving melamine-formaldehyde foam 2001 in the direction of arrow 2002 and through bath 2047 of the liquid comprising the polymer aerogel precursor such that the liquid comprising the polymer aerogel precursor is absorbed by the melamine-formaldehyde foam. In some embodiments, the melamine-formaldehyde foam is moved through a bath of the liquid comprising the polymer aerogel precursor in a continuous manner. In some embodiments, the melamine-formaldehyde foam is moved through a bath of the liquid comprising the polymer aerogel precursor via a moving element (e.g., a conveyor belt). In some embodiments, the melamine-formaldehyde foam is pushed through a bath of the liquid comprising the polymer aerogel precursor. In some embodiments, the melamine-formaldehyde foam is fed through a bath of the liquid comprising the polymer aerogel precursor (e.g., via powered rollers). In some embodiments, the melamine-formaldehyde foam is pulled through a bath of the liquid comprising the polymer aerogel precursor.

In some embodiments, the melamine-formaldehyde foam is pulled through the bath of the liquid comprising the polymer aerogel precursor in a continuous manner by sandwiching the melamine-formaldehyde foam between layers of a scrim material. In some embodiments, the scrim material is removed from the melamine-formaldehyde foam after the polymer aerogel precursor is processed to become a polymer aerogel. In some embodiments, the scrim material is removed from the melamine-formaldehyde foam after the polymer aerogel precursor is processed to become a polymer gel. In some embodiments, the scrim material is removed from the melamine-formaldehyde foam while the polymer aerogel precursor is being processed to become a polymer aerogel. In some embodiments, the scrim material is not removed from the melamine-formaldehyde foam before, during, or after processing of the polymer aerogel precursor. In some embodiments, the scrim material is a fibrous sheet. In some other embodiments, the scrim material is a mesh. Without wishing to be bound by any particular theory, is it believed that pulling the melamine-formaldehyde foam through a bath of the liquid comprising the polymer aerogel precursor will prevent the foam from tearing, ripping, stretching, or otherwise deforming by distributing tensile forces across the scrim instead of these forces acting on the foam itself.

In some embodiments, the melamine-formaldehyde foam is moved through a bath of the liquid comprising the polymer aerogel precursor and is compressed while in contact with the liquid comprising the polymer aerogel precursor, such that the liquid comprising the polymer aerogel precursor is wicked into the pores of the melamine-formaldehyde foam as the foam decompresses. One example of such an arrangement is shown in FIG. 20B, in which foam 2001 is moved in the direction of arrow 2002 through bath 2047 of polymer aerogel precursor such that the thickness of foam 2001 at position 2003 is thinner than the thickness of foam 2001 at position 2004. In some embodiments, the melamine-formaldehyde foam is compressed between two rollers while in contact with the liquid comprising the polymer aerogel precursor. In some embodiments, the melamine-formaldehyde foam is compressed by a surface while in contact with the liquid comprising the polymer aerogel precursor. In some embodiments, the melamine-formaldehyde foam is compressed to a thickness that is less than or equal to 99%, less than or equal to 95%, less than or equal to 90%, less than or equal to 80%, less than or equal to 70%, less than or equal to 60%, less than or equal to 50%, less than or equal to 40%, less than or equal to 30%, less than or equal to 20%, less than or equal to 15%, less than or equal to 10%, less than or equal to 5%, less than or equal to 3%, less than or equal to 1% (and/or, in some embodiments, to a thickness that is as little as 0.1%, as little as 0.01%, or less) of the thickness of the foam just prior to compression while in contact with the liquid comprising the polymer aerogel precursor. In some embodiments, the melamine-formaldehyde foam is moved out of the bath of liquid comprising the polymer aerogel precursor after decompression but before the polymer aerogel precursor forms a gel within the pores of the melamine-formaldehyde foam. In some embodiments, at least 20 vol %, at least 30 vol %, at least 40 vol %, at least 50 vol %, at least 60 vol %, at least 70 vol %, at least 80 vol %, at least 90 vol %, at least 95 vol %, at least 98 vol %, at least 99 vol %, at least 99.9 vol %, or more of the pore volume of the foam is occupied by gel after the gel has been formed. In some embodiments, the melamine-formaldehyde foam is moved through the bath of liquid comprising the polymer aerogel precursor via a moving element (e.g., a conveyor belt). In some embodiments, the melamine-formaldehyde foam is fed through the bath of liquid comprising the polymer aerogel precursor (e.g., via a series of powered rollers). In some embodiments, the melamine-formaldehyde foam is pulled through the bath of liquid comprising the polymer aerogel precursor.

In some embodiments, the melamine-formaldehyde foam is contacted with a hydrophobe prior to the melamine-formaldehyde foam contacting the liquid comprising the polyimide aerogel precursor. As used herein, a “hydrophobe” is a reactive chemical agent used to impart hydrophobicity unto a material by changing the composition of surface functional groups of that material. A hydrophobe can improve the hydrophobicity of a material such as a foam, such as an aerogel, or such as a material combination of an aerogel and a foam. In some embodiments, the hydrophobe reacts with functional groups on the foam, function groups on the aerogel, or functional groups on both the foam and the aerogel.

The hydrophobe can, in accordance with certain embodiments, react with the melamine-formaldehyde foam to impart hydrophobic character to the melamine-formaldehyde foam. In some embodiments, the melamine-formaldehyde foam is submerged in a liquid comprising a hydrophobe prior to contacting the liquid comprising the polyimide aerogel precursor. In some embodiments, the liquid comprising the hydrophobe fills essentially all (e.g., at least 90%, at least 95%, at least 99%, or 100%) of the void space within the outer boundaries of the melamine-formaldehyde foam. In some embodiments, the liquid comprising the hydrophobe partially fills the void space within the outer boundaries of the melamine-formaldehyde foam. In some embodiments, only the exterior surfaces of the outer boundaries of the melamine-formaldehyde foam are contacted with the hydrophobe. In some embodiments, a liquid comprising a hydrophobe is sprayed on to the melamine-formaldehyde foam prior to contact with the liquid comprising the polyimide aerogel precursor. In some embodiments, a vapor comprising a hydrophobe is blown over the melamine-formaldehyde foam prior to contact with the liquid comprising the polyimide aerogel precursor. In some embodiments, the melamine-formaldehyde foam is moved through a chamber with a vapor atmosphere comprising a hydrophobe before contacting the liquid comprising the polyimide aerogel precursor. In some embodiments, the melamine-foam is contacted with a hydrophobe for a time period of greater than or equal to 1 second, greater than or equal to 3 seconds, greater than or equal to 5 seconds, greater than or equal to 10 seconds, greater than or equal to 30 seconds, greater than or equal to 1 minute, greater than or equal to 5 minutes, greater than or equal to 10 minutes, greater than or equal to 20 minutes, greater than or equal to 30 minutes, greater than or equal to 1 hour, greater than or equal to 2 hours, greater than or equal to 3 hours, greater than or equal to 6 hours, or greater than or equal to 12 hours (and/or, in some embodiments, as much as 24 hours, as much as 7 days, as much as 30 days, or longer).

In some embodiments, the melamine-formaldehyde foam is coated with a hydrophobe prior to contact with the polyimide aerogel precursor. In some embodiments, the melamine-formaldehyde foam reacts with a hydrophobe prior to contact with the polyimide aerogel precursor. In some embodiments, only specific portions of the melamine-formaldehyde foam are contacted with a hydrophobe. In some embodiments, the melamine-formaldehyde foam is sprayed with a hydrophobe. In some embodiments, the melamine-formaldehyde foam is submerged in a hydrophobe.

In some embodiments, the melamine-formaldehyde foam is submerged in a liquid comprising a hydrophobe. In some embodiments, the volume percent of hydrophobe in the liquid is less than or equal to 99.9%, less than or equal to 99.5%, less than or equal to 99%, less than or equal to 95%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, less than or equal to 1%, less than or equal to 0.9%, less than or equal to 0.8%, less than or equal to 0.7%, less than or equal to 0.6%, less than or equal to 0.5%, less than or equal to 0.4%, or less than or equal to 0.3% (and/or, in some embodiments, as little as 0.2%, as little as 0.1%, as little as 0.05%, as little as 0.01%, or less). In certain embodiments, it can be advantageous to use a liquid comprising the hydrophobe in an amount of from 0.01% to 0.5%, or from 0.1% to 0.5%.

In some embodiments, the melamine-formaldehyde foam is dried via evaporation after contact with a hydrophobe and before contacting the polymer aerogel precursor. In some embodiments, the melamine-formaldehyde foam is heated to accelerate drying of the foam after contact with the hydrophobe and prior to contact with the polymer aerogel precursor. In some embodiments, the melamine-formaldehyde foam is not dried after contact with a hydrophobe and before contact with the polymer aerogel precursor.

In some embodiments, the melamine-formaldehyde foam is contacted with a hydrophobe after contacting the polymer aerogel precursor. In some embodiments, the melamine-formaldehyde foam is contacted with a hydrophobe immediately after contacting the polymer aerogel precursor. In some embodiments, a portion of the melamine-formaldehyde foam is contacted with a hydrophobe while a different portion of the same melamine-formaldehyde foam is contacted with the polymer aerogel precursor.

In some embodiments, the gel/foam material combination is contacted with a hydrophobe. In some embodiments, the gel/foam material combination is soaked in a bath of liquid comprising a hydrophobe. In some embodiments, it can be particularly advantageous if the first bath of transfer solvent also comprises a hydrophobe. In some embodiments the gel/foam material combination is contacted with a hydrophobe for a period of time greater than or equal to 1 second, greater than or equal to 10 seconds, greater than or equal to 30 seconds, greater than or equal to 1 minute, greater than or equal to 5 minutes, greater than or equal to 10 minutes, greater than or equal to 20 minutes, greater than or equal to 30 minutes, greater than or equal to 45 minutes, greater than or equal to 1 hour, greater than or equal to 2 hours, greater than or equal to 3 hours, greater than or equal to 4 hours, greater than or equal to 5 hours, or greater than or equal to 6 hours (and/or, in some embodiments, as much as 12 hours, as much as 24 hours, as much as 7 days, as much as 30 days, or more). In some embodiments, the gel/foam material combination is contacted with more than one hydrophobe.

In some embodiments, the aerogel/foam material combination is contacted with a hydrophobe. In some embodiments the aerogel/foam material combination is contacted with a hydrophobe for a period of time greater than or equal to 1 second, greater than or equal to 10 seconds, greater than or equal to 30 seconds, greater than or equal to 1 minute, greater than or equal to 5 minutes, greater than or equal to 10 minutes, greater than or equal to 20 minutes, greater than or equal to 30 minutes, greater than or equal to 45 minutes, greater than or equal to 1 hour, greater than or equal to 2 hours, greater than or equal to 3 hours, greater than or equal to 4 hours, greater than or equal to 5 hours, or greater than or equal to 6 hours (and/or, in some embodiments, as much as 12 hours, as much as 24 hours, as much as 7 days, as much as 30 days, or more). In some embodiments, the aerogel/foam material combination is contacted with more than one hydrophobe. In some embodiments, the aerogel/foam material combination is contacted with a liquid solution comprising a hydrophobe.

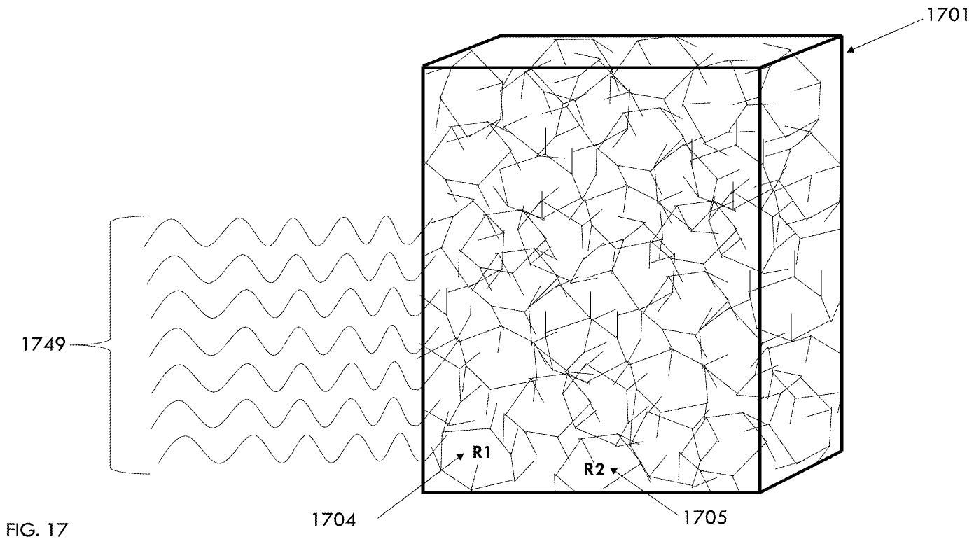

In some embodiments, the aerogel/foam material combination is contacted with a vapor comprising a hydrophobe such that exposed reactive sites on the melamine-formaldehyde foam react with the hydrophobe. For example, in FIG. 17 vapors 1749 contact an aerogel/foam material 1701 such that reactive sites 1704 and 1705 are exposed to the vapors 1749. In some embodiments, the aerogel/foam material combination is contacted with a vapor comprising a hydrophobe for a time period greater than or equal to 1 second, greater than or equal to 10 seconds, greater than or equal to 30 seconds, greater than or equal to 1 minute, greater than or equal to 5 minutes, greater than or equal to 10 minutes, greater than or equal to 20 minutes, greater than or equal to 30 minutes, greater than or equal to 45 minutes, greater than or equal to 1 hour, greater than or equal to 2 hours, greater than or equal to 3 hours, greater than or equal to 4 hours, greater than or equal to 5 hours, or greater or equal to than 6 hours (and/or, in some embodiments, as much as 12 hours, as much as 24 hours, as much as 7 days, as much as 30 days, or more). In some embodiments, the vapor comprising a hydrophobe is blown over the aerogel/foam material combination. In some embodiments, the aerogel/foam material combination is moved through a stagnant atmosphere of the vapor comprising a hydrophobe.

Any of a variety of hydrophobes can be used. In some embodiments, the hydrophobe comprises hexamethyldisilazane, hexamethylenedisiloxane, dioctylamine, didodecylamine, hexylamine, dihexylamine, an isocyanate, an aldehyde, an amine, an alkyl-chlorosilane, and/or a compound of the formula H—N(R¹)(R²) wherein: each of R¹ is independently a first organic moiety; and each of R² is independently H or a second organic moiety; provided that: each of the first and second organic moieties is not H; and the log P of H—R¹ and/or H—R² determined at about 25° C. and about 1 atm is not lower than 1. In some embodiments, the log P of H—R¹ and H—R² determined at about 25° C. and about 1 atm is not lower than 1. In some embodiments in which neither R¹ nor R² is hydrogen, the log P of H—R¹ and H—R² determined at about 25° C. and about 1 atm is not lower than 1. Without wishing to be bound by any particular theory it is believed that bulky hydrophobic groups on the hydrophobe prevent water molecules from contacting more hydrophilic portions of the polymer aerogel backbone (e.g., the polyimide aerogel backbone) thus improving the overall hydrophobicity of the aerogel/foam material combination. In some embodiments, increasing the size of the hydrophobic functional groups on the hydrophobe increases the overall hydrophobicity of the material combination when compared to an aerogel/foam material combination contacted with a hydrophobe with smaller hydrophobic functional groups.

A “partition coefficient” (P) of a compound is the ratio of concentrations of the compound in a mixture of n-octan-1-ol and water at equilibrium. “Log P” of the compound is the logarithm (Log) of the compound's partition coefficient. The compound's Log P is determined according to the equation below:

$$Log P = Log ( ( Concentration of the compound in the n - octan - 1 - ol phase of the mixture ) / ( Concentration of the compound in the aqueous phase of the mixture ) ) ;$$

e.g., when the compound is not ionized in n-octan-1-ol and water. Log P may be determined at about 25° C. and about 1 atm. A higher Log P value may suggest a higher hydrophobicity. In some embodiments, a hydrophobe may have a Log P of greater than or equal to 1, greater than or equal to 1.5, greater than or equal to 2, greater than or equal to 2.5, greater than or equal to 3, greater than or equal to 3.5, or greater than or equal to 4 (and/or, in some embodiments, as much as 5, as much as 6, as much as 8, as much as 10, or more).

In some embodiments, after reacting an aerogel/foam material combination with a suitable hydrophobe, the Log P of the aerogel/foam material combination is increased. In some embodiments, after reacting an aerogel/foam material combination with a suitable hydrophobe, the Log P of the reacted aerogel/foam material combination is increased by greater than or equal to 0.5 points, greater than or equal to 1 point, greater than or equal to 1.5 points, greater than or equal to 2 points, greater than or equal to 2.5 points, or greater than or equal to 3 points. In some embodiments, the Log P of the reacted aerogel/foam material combination is greater than or equal to 1, greater than or equal to 2, greater than or equal to 2.5, greater than or equal to 3, greater than or equal to 3.5, or greater than or equal to 4 (and/or, in some embodiments, as much as 5, as much as 6, as much as 8, as much as 10, or more).

In some embodiments, the aerogel/foam material combinations described herein may have a Log P of greater than or equal to 1, greater than or equal to 1.5, greater than or equal to 2, greater than or equal to 2.5, greater than or equal to 3, greater than or equal to 3.5, or greater than or equal to 4 (and/or, in some embodiments, as much as 5, as much as 6, as much as 8, as much as 10, or more).

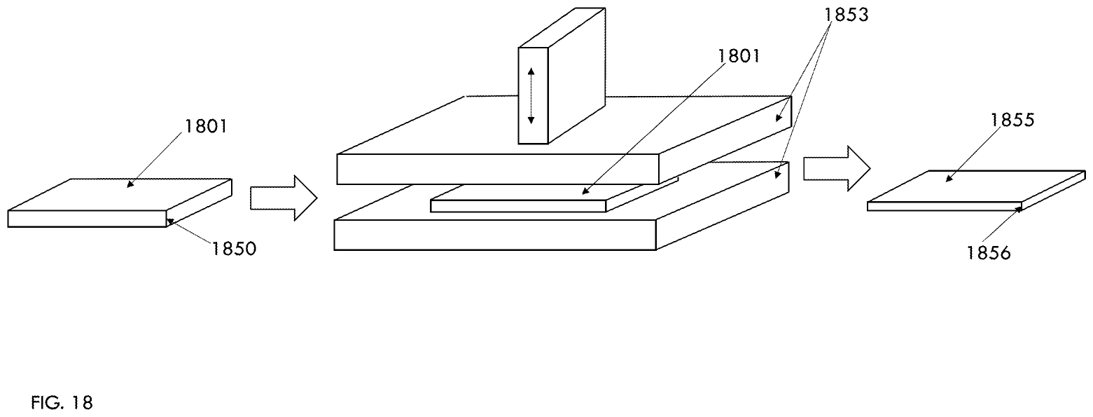

In some embodiments, the melamine-formaldehyde foam is formed from a precursor foam. In some embodiments, the precursor foam is thermally or mechanically processed to increase the density of the melamine-formaldehyde foam, relative to a precursor foam, prior to contacting the polymer aerogel precursor. For example, FIG. 18 schematically depicts a system in which foam 1801 (having a first thickness 1850) is placed between plates 1853, which compress foam 1801 by applying force to the major faces of foam 1850. After this process is complete, densified foam 1855 is produced having a thickness 1856 that is less than thickness 1850. Without wishing to be bound by any particular theory, it is believed that increasing the density of the melamine-formaldehyde foam prior to contact with the polymer aerogel precursor yields an aerogel/foam material combination with increased mechanical strength and durability when compared to an aerogel/foam material combination comprising un-densified melamine-formaldehyde foam. In some embodiments, increasing the density of the melamine-formaldehyde foam prior to contact with the polymer aerogel precursor increases the mechanical strength and durability of the aerogel/foam material combination without substantially increasing the thermal conductivity of the aerogel/foam material combination when compared to an aerogel/foam material combination comprising un-densified melamine-formaldehyde foam. In some embodiments, the density of the melamine-formaldehyde foam is increased by greater than or equal to 0.01 g/cc, greater than or equal to 0.02 g/cc, greater than or equal to 0.03 g/cc, greater than or equal to 0.04 g/cc, greater than or equal to 0.05 g/cc, greater than or equal to 0.06 g/cc, greater than or equal to 0.07 g/cc, greater than or equal to 0.08 g/cc, greater than or equal to 0.09 g/cc, greater than or equal to 0.1 g/cc, greater than or equal to 0.2 g/cc, greater than or equal to 0.3 g/cc, greater than or equal to 0.4 g/cc, greater than or equal to 0.5 g/cc, greater than or equal to 0.6 g/cc, greater than or equal to 0.7 g/cc, greater than or equal to 0.8 g/cc, greater than or equal to 0.9 g/cc, or greater than or equal to 1 g/cc (and/or, in some embodiments, up to 1.1 g/cc, up to 1.15 g/cc, up to 1.2 g/cc, or greater).

In some embodiments, prior to contacting the polymer aerogel precursor, the melamine-formaldehyde foam is heated to a temperature greater than or equal to 200° C. and less than or equal to 300° C. and compressed to a thickness of greater than or equal to 15% and less than or equal to 90% of the thickness of the melamine-formaldehyde foam just prior to compression. In some embodiments, the melamine-formaldehyde foam is compressed for a time period of greater than or equal to 1 second, greater than or equal to 5 minutes, greater than or equal to 10 minutes, greater than or equal to 15 minutes, greater than or equal to 20 minutes, greater than or equal to 25 minutes, greater than or equal to 30 minutes, and/or less than or equal to 120 minutes, less than or equal to 60 minutes, less than or equal to 30 minutes, less than or equal to 25 minutes, less than or equal to 20 minutes, less than or equal to 15 minutes, less than or equal to 10 minutes, or less than or equal to 5 minutes.

In some embodiments, the melamine-formaldehyde foam is compressed between two solid surfaces. For example, in some embodiments, the melamine-formaldehyde foam is compressed between a solid plate and another surface. In some embodiments, the melamine-formaldehyde foam is compressed between a roller and another surface. In some embodiments, the melamine-formaldehyde foam is compressed between two or more solid plates. In some other embodiments, the melamine-formaldehyde foam is compressed between two or more rollers. In some embodiments, the melamine-formaldehyde foam is compressed to a thickness of less than or equal to 95%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, and/or greater than or equal to 5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, or greater than or equal to 90% of the thickness of the melamine-formaldehyde foam just prior to compression. In some embodiments, the melamine-formaldehyde foam is heated to a temperature greater than or equal to 100° C., greater than or equal to 150° C., greater than or equal to 200° C., greater than or equal to 250° C., greater than or equal to 300° C., or greater than or equal to 350° C. (and/or, in some embodiments, up to 400° C., or greater). In some embodiments, the melamine-formaldehyde foam is compressed before it is heated. In some other embodiments, the melamine-formaldehyde foam is heated before it is compressed. In further embodiments, the melamine-formaldehyde foam is compressed at the same time it is heated.

In some embodiments, the polymer aerogel precursor forms a polymer gel (e.g., a polyimide gel) on or within the pores of the melamine-formaldehyde foam forming a material combination of a polymer gel and a melamine-formaldehyde foam. Material combinations of gel and foam are also sometimes referred to herein as a “gel/foam material combination.” In certain embodiments, uses of polymer gel/melamine-formaldehyde foam combinations can be particularly advantageous. In some embodiments, at least 20 vol %, at least 30 vol %, at least 40 vol %, at least 50 vol %, at least 60 vol %, at least 70 vol %, at least 80 vol %, at least 90 vol %, at least 95 vol %, at least 98 vol %, at least 99 vol %, at least 99.9 vol %, or more of the pore volume of the foam is occupied by aerogel after the aerogel has been formed.

In some embodiments, the polymer aerogel precursor forms a polymer gel occupying essentially all (e.g., at least 90%, at least 95%, at least 99%, or 100%) of the void space within the outer boundaries of the melamine-formaldehyde foam. In some embodiments, the polymer aerogel precursor forms a polymer gel partially within the void space within the outer boundaries of the melamine-formaldehyde foam. In some embodiments, the polymer aerogel precursor forms a polymer gel on or within the pores of the melamine-formaldehyde foam forming a gel/foam material combination (e.g., comprising a polymer gel and a melamine-formaldehyde foam) while the material combination is on a moving element (e.g., a conveyor belt). In some embodiments, the polymer aerogel precursor forms a polymer gel on or within the pores of the melamine-formaldehyde foam in a time period of less than or equal to 1 minute, less than or equal to 2 minutes, less than or equal to 3 minutes, less than or equal to 5 minutes, less than or equal to 10 minutes, less than or equal to 15 minutes, less than or equal to 20 minutes, less than or equal to 30 minutes, less than or equal to 45 minutes, less than or equal to 60 minutes, less than or equal to 120 minutes, less than or equal to 180 minutes, less than or equal to 240 minutes, or less than or equal to 300 minutes. In some embodiments, the polymer aerogel precursor forms a polymer gel on or within the pores of the melamine-formaldehyde foam in a time period of greater than or equal to 0.01 seconds, greater than or equal to 0.1 seconds, or greater than or equal to 1 second.

In some embodiments, the polymer aerogel precursor forms a polymer gel on or within the pores of the melamine-formaldehyde foam in an environment with a temperature of greater than or equal to −25° C., greater than or equal to −10° C., greater than or equal to 0° C., greater than or equal to 10° C., greater than or equal to 25° C., greater than or equal to 50° C., greater than or equal to 75° C., or greater than or equal to 100° C. In some embodiments, the polymer aerogel precursor forms a polymer gel on or within the pores of the melamine-formaldehyde foam in an environment with a temperature of less than or equal to 202° C., less than or equal to 150° C., less than or equal to 100° C. less than or equal to 90° C., less than or equal to 80° C., less than or equal to 70° C., less than or equal to 50° C., less than or equal to 40° C., less than or equal to 30° C., less than or equal to 20° C., less than or equal to 10° C., less than or equal to 0° C., or less than or equal to −10° C. In certain embodiments, the temperature of the environment in which the polymer aerogel precursor forms a polymer gel on or within the pores of the melamine-formaldehyde foam is between the freezing point of the sol and the boiling point of the sol.

In some embodiments, at least a portion (e.g., at least 50 vol %, at least 75 vol %, at least 90 vol %, at least 95 vol %, at least 99 vol %, at least 99.9 vol %, or all) of the liquid in the pores of the gel/foam material combination is exchanged for a transfer solvent. Generally, when used, the transfer solvent is different than the liquid in the pores of the gel/foam material combination. In some embodiments, the transfer solvent is chosen because it is useful or necessary for a chosen drying method that is used to form the aerogel. In some embodiments, the transfer solvent is chosen because it imparts a desired effect on the final aerogel/foam material combination. In some embodiments, the gel is solvent exchanged into an organic solvent. For example, in some embodiments, the pore fluid within the gel is substantially replaced by the organic solvent (e.g., through diffusive soaking in a bath of the transfer organic solvent), after which the gel was subsequently dried via any suitable method for making an aerogel (e.g., described in more detail below).

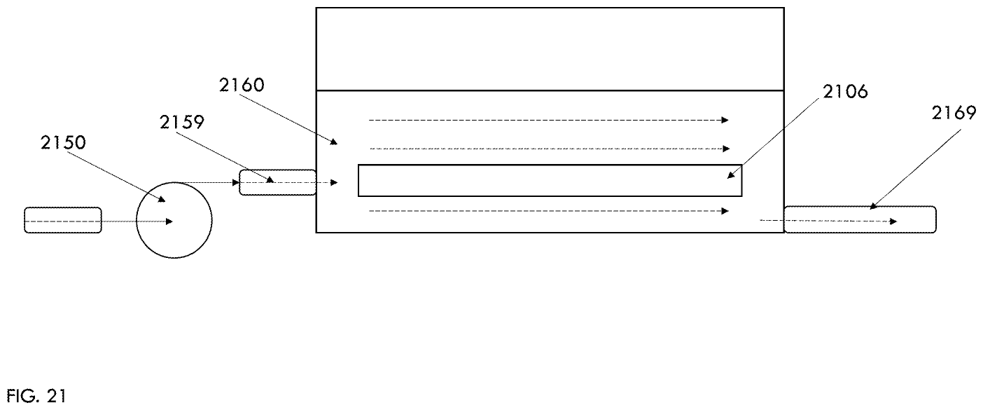

In some embodiments, liquid in the pores of the gel/foam material combination is exchanged for a transfer solvent in a continuous manner. For example, in some embodiments, the liquid in the pores of the gel/foam material combination is exchanged for a transfer solvent by moving the gel/foam material combination through a bath of the transfer solvent (e.g., using countercurrent flow). For example, FIG. 21 schematically depicts pump 2150 continuously pumping liquid through conduit 2159 into bath 2160, within which gel/foam material combination 2106 is located, which refreshes the transfer liquid (e.g., transfer solvent) as the exchanged liquid from the original gel is transported out of conduit 2169 (along with some of the transfer liquid). In some embodiments, the liquid in the pores of the gel/foam material combination is exchanged for a transfer solvent by moving the gel/foam material combination through a series of baths of the transfer solvent. In some embodiments, the liquid in the pores of the gel/foam material combination is considered to be sufficiently exchanged when the purity of the transfer solvent in the pores of the gel/foam material combination is greater than or equal to 10 wt %, greater than or equal to 15 wt %, greater than or equal to 30 wt %, greater than or equal to 50 wt %, greater than or equal to 60 wt %, greater than or equal to 70 wt %, greater than or equal to 80 wt %, greater than or equal to 90 wt %, greater than or equal to 95 wt %, greater than or equal to 99 wt %, greater than or equal to 99.5 wt %, greater than or equal to 99.95 wt %, or greater than or equal to 99.995 wt %. The purity of the transfer solvent in the pores of the material combination can be measured using well known characterization methods such as UV spectroscopy or IR spectroscopy.

In some embodiments, the transfer solvent comprises an alcohol, a ketone, a nitrile, an acetate, a pyrrolidone, an alkane, a pentone, dimethyl sulfoxide, and/or liquid carbon dioxide. In some embodiments, the transfer solvent comprises an alcohol (e.g., methanol, ethanol, isopropyl alcohol, and/or tertiary-butyl alcohol), a ketone (e.g., acetone, methyl ethyl ketone, propyl methyl ketone, and/or ethyl ethyl ketone), a nitrile (e.g., acetonitrile), an acetate (e.g., ethyl acetate), a pyrrolidone (e.g., n-methyl-2-pyrrolidone), a pentone, an alkane (e.g., hexane), dimethyl sulfoxide, and/or liquid carbon dioxide. In certain embodiments, it can be particularly advantageous to use tertiary-butyl alcohol as a transfer solvent. In some embodiments, the transfer solvent comprises a hydrophobe. In some embodiments, the transfer solvent is more compatible with a drying method than the liquid in the pores of the gel/foam material combination after the polyimide aerogel precursor has gelled. In some embodiments, the transfer solvent is used to purify the liquid in the pores of the material combination.

In some embodiments, the transfer solvent is frozen after exchange. In some embodiments, the transfer solvent is frozen in a continuous manner. In some embodiments, the gel/foam material combination is moved through a bath of liquid nitrogen to freeze the transfer solvent. In some embodiments, the gel/foam material combination is moved through a stream of liquid nitrogen to freeze the transfer solvent. In some embodiments, the gel/foam material combination is moved through a stream of cold, dry air to freeze the transfer solvent. In some embodiments, the gel/foam material combination is moved through a stream of carbon dioxide snow to freeze the transfer solvent. In some embodiments, the transfer solvent is frozen in a time period of less than or equal to 24 hours, less than or equal to 20 hours, less than or equal to 15 hours, less than or equal to 10 hours, less than or equal to 5 hours, less than or equal to 4 hours, less than or equal to 3 hours, less than or equal to 2 hours, less than or equal to 1 hour, less than or equal to 30 minutes, less than or equal to 20 minutes, less than or equal to 10 minutes, less than or equal to 5 minutes, less than or equal to 1 minutes, less than or equal to 30 seconds, less than or equal to 5 seconds, or less than or equal to 1 second (and/or, in some embodiments, greater than or equal to 0.01 seconds, greater than or equal to 0.1 seconds, or greater than or equal to 1 second.

In some embodiments, the gel/foam material combination is dried to produce an aerogel/foam material combination. Formation of the aerogel can involve removal of liquid (e.g., the transfer solvent, when used) from the gel. In this context, “removal” does not necessarily require that all of the liquid be removed, and in some cases, there may remain some amount of residual liquid in the aerogel. In certain embodiments, the removal of liquid from the gel to form the aerogel involves removing at least 95 vol %, at least 98 vol %, at least 98.5 vol %, at least 99 vol %, at least 99.9 vol %, at least 99.99 vol %, at least 99.999 vol %, at least 99.9999 vol %, or at least 99.99999 vol % of the liquid from the gel. In some embodiments, the liquid in the pores of the gel/foam material combination is removed by supercritical extraction. In some embodiments, the liquid in the pores of the gel/foam material combination is removed by supercritical extraction. In some embodiments, the liquid in the pores of the gel/foam material combination is first at least partially replaced by carbon dioxide after which the carbon dioxide is then removed from the gel/foam material combination. In some embodiments, the liquid in the pores of the gel/foam material combination is first at least partially replaced by carbon dioxide after which the carbon dioxide is then removed from the gel/foam material combination. In some embodiments the carbon dioxide is removed from the gel/foam material combination via supercritical extraction. In some embodiments, the carbon dioxide is removed from the gel/foam material combination via subcritical extraction.

Acrogel/foam material combinations may be fabricated by removing the liquid from a gel in a way that substantially preserves both the porosity and integrity of the gel/foam material combination's intricate nanostructured solid network. For most gel/foam material combinations, if the liquid in the gel is evaporated, capillary stresses will arise as the vapor-liquid interface recedes into and/or from the gel/foam material combination, causing the gel/foam material combination's solid network to shrink and/or pull inwards on itself, and collapse. The resulting material is a dry, comparatively dense, low-porosity (generally <10% by volume) material that is often referred to as a xerogel infused foam material, or a solid formed from the gel infused foam by drying with unhindered shrinkage. However, the liquid in the gel/foam material combination may instead be heated and pressurized past its critical point, a specific temperature and pressure at which the liquid will transform into a semi-liquid/semi-gas, or supercritical fluid, that exhibits little, if any, surface tension. Below the critical point, the liquid is in equilibrium with a vapor phase. As the system is heated and pressurized towards its critical point, however, molecules in the liquid develop an increasing amount of kinetic energy, moving past each other increasingly fast until eventually their kinetic energy exceeds the intermolecular adhesion forces that give the liquid its cohesion. Simultaneously, the pressure in the vapor also increases, bringing molecules on average closer together until the density of the vapor becomes nearly and/or substantially as dense as the liquid phase. As the system reaches the critical point, the liquid and vapor phases become substantially indistinguishable and merge into a single phase that exhibits a density and thermal conductivity comparable to a liquid, yet is also able to expand and compress in a manner similar to a gas. Although technically a gas, the term supercritical fluid may refer to fluids near but past their critical point as such fluids, due to their density and kinetic energy, exhibit liquid-like properties that are not typically exhibited by ideal gases, for example, the ability to dissolve other substances. Since phase boundaries do not typically exist past the critical point, a supercritical fluid exhibits no surface tension and thus exerts no capillary forces, and can be removed from a gel/foam material combination without causing the gel's solid skeleton to collapse by isothermal depressurization of the fluid. After fluid removal, the resulting dry, low-density, high-porosity material is an aerogel/foam material combination.

The critical point of most substances typically lies at relatively high temperatures and pressures; thus, supercritical drying generally involves heating gels to elevated temperatures and pressures and, hence, is performed in a pressure vessel. For example, if a gel/foam material combination contains ethanol as its pore fluid, the ethanol can be supercritically extracted from the gel/foam material combination by placing the gel/foam material combination in a pressure vessel containing additional ethanol, slowly heating the vessel past the critical temperature of ethanol (241° C.), and allowing the autogenic vapor pressure of the ethanol to pressurize the system past the critical pressure of ethanol (60.6 atm). At these conditions, the vessel can then be quasi-isothermally depressurized so that the ethanol diffuses out of the pores of the gel/foam material combination without recondensing into a liquid. Likewise, if a gel/foam material combination contains a different solvent in its pores, the vessel may be heated and pressurized past the critical point of that solvent. Extraction of organic solvent from a gel/foam material combination generally requires specialized equipment, however, since organic solvents at their critical points can be dangerously flammable and explosive. Instead of supercritically extracting an organic solvent directly from a gel/foam material combination, the liquid in the pores of the gel/foam material combination may instead first be exchanged with a safer, nonflammable liquid, such as carbon dioxide, which is typically miscible with most organic solvents and which has a relatively low critical point of 31.1° C. and 72.9 atm. In some embodiments, instead of first replacing the liquid in the pores of the gel/foam material combination with liquid CO₂ and then performing supercritical extraction of the CO₂, the liquid in a gel/foam material combination may instead be extracted by flowing supercritical CO₂ over the gel/foam material combination. Such so-called supercritical CO₂ drying processes are commonly employed in the manufacture of aerogel materials. In accordance some embodiments described herein, supercritical CO₂ drying may be used to make aerogel/foam material combinations.

In some embodiments, the liquid in the pores of the gel/foam material combination is removed by evaporation and/or boiling. In some embodiments, the transfer solvent in the pores of the gel/foam material combination is removed by evaporation and/or boiling. In some embodiments, material combinations may be fabricated by removing the liquid from a gel/foam material combination by evaporative drying of the liquid. In some embodiments, the pore fluid exhibits a sufficiently low surface tension to prevent damaging the gel/foam material combination when evaporated, for example, less than or equal to 20 dynes/cm, less than or equal to 15 dynes/cm, less than or equal to 12 dynes/cm, or less than or equal to 10 dynes/cm, and/or greater than or equal to 0.1 dynes/cm, greater than or equal to 1 dyne/cm, or greater than or equal to 5 dynes/cm. In certain embodiments, the surface tension of the liquid is less than or equal to 20 dynes/cm, less than or equal to 15 dynes/cm, less than or equal to 12 dynes/cm, or less than or equal to 10 dynes/cm, and/or greater than or equal to 0.1 dynes/cm, greater than or equal to 1 dyne/cm, or greater than or equal to 5 dynes/cm. Combinations of these ranges are also possible (e.g., greater than or equal to 5 dynes/cm and less than or equal to 25 dynes/cm). Other ranges are also possible.

In some embodiments, the pore liquid comprises a carbon atom, a fluorine atom, and an oxygen atom. In some embodiments, Novec™ brand solvents obtainable from 3M® may be particularly well-suited. In some embodiments, the pore liquid comprises 1-methoxyheptafluoropropane (e.g., Novec 7000), methoxynonafluorobutane (e.g., Novec 7100), ethoxynonafluorobutane (e.g., Novec 7200), 3-methoxy-4-trifluoromethyldecafluoropentane (e.g., Novec 7300), 2-trifluoromethyl-3-ethoxydodecafluorohexane (e.g., Novec 7500), 1,1,1,2,3,3-hexafluoro-4-(1,1,2,3,3,3-hexafluoropropoxy)-pentane (e.g., Novec 7600), 2,3,3,4,4-pentafluorotetrahydro-5-methoxy-2,5-bis[1,2,2,2-tetrafluoro-1-(trifluoromethyl)ethyl]-furan (Novec 7700), a fluorinated ketone such as CF₃CF₂C(═O)CF(CF₃)₂ dodecafluoro-2-methylpentan-3-one (e.g., Novec 1230/649), tetradecafluoro-2-methylhexan-3-one/tetradecafluoro-2,4-dimethylpentan-3-one (e.g., Novec 774), a fluorinated ether, tetradecafluorohexane/perfluoropentane/perfluorobutane (e.g., Fluorinert FC-72), a fluorinated hydrocarbon such as 2,3-dihydrodecafluoropentane (e.g., Vertrel® XF), or any other appropriate organic solvent that includes fluorine. In some embodiments, it can be particularly advantageous if the pore liquid selected for evaporative drying is methoxynonafluorobutane (e.g., Novec 7100). In some embodiments, it can be particularly advantageous if the pore fluid selected for evaporative drying is ethoxynonafluorobutane (e.g., Novec 7200).

In some embodiments, the pore liquid is evaporated at room temperature. In some embodiments, it can be particularly advantageous if the pore liquid is evaporated in an atmosphere of dry air (i.e., substantially water-free), nitrogen, and/or another substantially water-free inert gas. In some embodiments, it can be particularly advantageous if the pore fluid selected for evaporative drying is carbon dioxide at a temperature below its critical temperature and pressure of approximately 31.1° C. and 72.8 atm (1071 psi). In one such embodiment, the gel/foam material combination is evaporatively dried from liquid carbon dioxide at a temperature of approximately 28° C. and a pressure of about 68.0 atm (1000 psi).

In some embodiments, aerogel/foam material combination may be fabricated from a gel/foam material combination by sublimation of a frozen pore fluid rather than evaporation of liquid-phase pore fluid. The pore fluid may be suitably frozen and sublimated with little to no capillary force, resulting in a gel/foam material combination that includes frozen pore fluid. That is, rather than removing the solvent via evaporation from a liquid state, the solvent can be sublimated from a solid state (having been frozen), hence, minimizing capillary forces that may otherwise result via evaporation. In some embodiments, the sublimation of the frozen pore fluid is performed under vacuum, or partial vacuum conditions, e.g., lyophilization. In some embodiments, the liquid in the pores of the gel/foam material combination is removed by freeze drying under vacuum. In some embodiments, the transfer solvent in the pores of the gel/foam material combination is removed by freeze drying under vacuum. In some embodiments, the sublimation of the frozen pore fluid is performed at atmospheric pressure. In some embodiments, the liquid in the pores of the gel/foam material combination is removed by freeze drying at or above atmospheric pressure. In some embodiments, the transfer solvent in the pores of the gel/foam material combination is removed by freeze drying at or above atmospheric pressure. In some embodiments, the method includes providing a gel/foam material combination having a solvent located within pores of the gel/foam material combination, freezing the solvent within the pores of the gel/foam material combination, and sublimating the solvent (e.g., at ambient conditions) to remove the solvent from the pores of the gel/foam material combination to produce an aerogel/foam material combination. In some embodiments, the sublimation of the solvent is performed in air, nitrogen, and/or another inert gas. In some such embodiments, the gas is substantially water free (e.g., it contains water in an amount of 0 wt % to 1 wt %, 0 wt % to 0.1 wt %, 0 wt % to 0.01 wt %, 0 wt % to 0.001 wt %, 0 wt % to 0.0001 wt %, 0 wt % to 0.00001 wt %, 0 wt % to 0.000001 wt %, 0 wt % to 0.0000001 wt %, or at 0 wt %). In some embodiments, it can be particularly advantageous if the pore fluid selected for this process is tert-butanol. Examples of techniques that can be used to dry aerogels that involve sublimation are described, for example, in International Patent Application Publication No. WO 2016/127084, published Aug. 11, 2016, and entitled “Systems and Methods for Producing Acrogel Material,” which is incorporated herein by reference in its entirety for all purposes.

In some embodiments, the liquid in the pores of the gel/foam material combination is removed in a continuous manner. In some embodiments, the transfer solvent in the pores of the gel/foam material combination is removed in a continuous manner. In some embodiments, the gel/foam material combination is moved on a moving object (e.g., a conveyor belt) through a chamber (e.g., a chamber controlled to a specific temperature and pressure) where the liquid in the pores of the gel/foam material combination is removed.

In some embodiments, the temperature of the environment in which the liquid is removed from the gel (e.g., in the chamber) is controlled to less than or equal to 25° C. less than or equal to 20° C., less than or equal to 15° C., less than or equal to 10° C., less than or equal to 5° C., less than or equal to 0° C., less than or equal to −5° C., less than or equal to −10° C., less than or equal to −15° C., less than or equal to −20° C., less than or equal to −25° C., or less than or equal to −30° C. In some embodiments (e.g., in certain embodiments in which freeze drying is used to remove the solvent), the temperature of the environment in which the fluid is removed (e.g., in the chamber) can be below the freezing point of the fluid within the gel. In some embodiments (e.g., in certain embodiments in which supercritical drying is used to remove the solvent), the temperature of the environment in which the liquid is removed (e.g., in the chamber) can be above the critical point of the liquid within the gel. In some embodiments (e.g., in certain embodiments in which ambient atmosphere drying is used to remove the solvent), the temperature of the environment in which the liquid is removed can be the temperature of the ambient environment (e.g., between 15° C. and 30° C., or between 20° C. and 25° C.).

In some embodiments, the pressure of the environment in which the liquid is removed from the gel is ambient pressure. For example, in some embodiments, the pressure of the environment in which the liquid is removed from the gel is 0.9 atmospheres to 1.1 atmospheres (absolute). In some embodiments, the pressure of the environment in which the liquid is removed from the gel (e.g., in the chamber) is higher than ambient pressure. In some embodiments, the pressure of the environment in which the liquid is removed from the gel (e.g., in the chamber) is lower than ambient pressure.

In some embodiments, the period of time over which liquid is removed from the gel/foam material combination to form the aerogel (e.g., the period of time in the chamber) is greater than or equal to 1 second, greater than or equal to 10 seconds, greater than or equal to 30 seconds, greater than or equal to 1 minute, greater than or equal to 2 minutes, greater than or equal to 3 minutes, greater than or equal to 5 minutes, greater than or equal to 10 minutes, greater than or equal to 20 minutes, greater than or equal to 30 minutes, greater than or equal to 1 hour, greater than or equal to 2 hours, greater than or equal to 3 hours, greater than or equal to 4 hours, greater than or equal to 5 hours, greater than or equal to 6 hours, greater than or equal to 7 hours, greater than or equal to 8 hours, greater than or equal to 9 hours, or greater than or equal to 10 hours (and/or, in some embodiments, as much as 24 hours, as much as 48 hours, as much as 7 days, as much as 21 days, or longer).

In some embodiments, evaporation of the liquid to form the aerogel may occur at atmospheric or ambient conditions (e.g., with or without a stream of gas flowing along the surface of the gel), thus, not requiring the use of a pressure vessel to remove the liquid. Ambient conditions may include ambient pressure conditions and ambient temperature conditions including temperatures near room temperature, e.g., about 0-50° C. Those of ordinary skill in the art would understand that ambient pressure corresponds to the pressure of the ambient environment, within the normal variations caused by elevation and/or barometric pressure fluctuations in normal operations under various weather conditions and locations of installation. Ambient pressure conditions may be distinguished from gage pressure conditions, in which the pressure (e.g., in a vacuum chamber, pressure vessel, or other enclosure in which pressure can be controlled) is described in terms of pressure relative to the ambient pressure (e.g., from a pressure measurement from a gauge or sensor). Because such manufacturing processes in accordance with certain embodiments of the present disclosure do not require a pressure vessel, the size of the resulting aerogel is not limited by the size of a pressure vessel chamber. In some embodiments, evaporation of liquid from the gel may result in an aerogel material in a matter of hours or minutes. Because such manufacturing processes in accordance with certain embodiments of the present disclosure are relatively fast, aerogel materials such as boards, panels, blankets, and thin films may be manufactured in a continuous fashion as opposed to a batch fashion as typically imposed when supercritical drying or freeze drying. Depending on the type of liquid that is evaporated from the gel, such aerogel manufacture may also occur without risk of flammability or combustion.

In some embodiments, liquid is removed from the gel by simply exposing the gel to ambient atmosphere (with or without a flow of gas). In some embodiments, the liquid is removed under a flow of gas. In some embodiments, it can be particularly advantageous if the gas is substantially dry. In some embodiments, the gas comprises dry air. In some embodiments, the gas comprises nitrogen. In some embodiments, the gas comprises carbon dioxide. In some embodiments, the flow rate of the gas is at least 10, at least 100, at least 1000, or at least 10,000 (and/or, up to 100,000, up to 1,000,000, or more) standard liters per minute (SLM) per square meter of exposed gel envelope surface area. In some embodiments, the liquid is removed at a rate of at least 10, at least 50, at least 100, at least 150, at least 200, at least 500, or at least 1000 grams per hour per square meter of exposed gel envelope surface area.

Examples of techniques that can be used to evaporatively dry aerogels are described, for example, in International Patent Application Publication No. WO 2016/161123, published Oct. 6, 2016, and entitled “Acrogel Materials and Methods for Their Production,” which is incorporated herein by reference in its entirety for all purposes.

In some embodiments, a solvent is used. The solvents can be used in the original gel formulation or as a transfer solvent (i.e., a solvent that replaces a solvent already present in the gel). Any of a variety of suitable solvents can be used. In some embodiments the solvent comprises dimethylsulfoxide; diethylsulfoxide; N,N-dimethylformamide; N,N-diethylformamide; N,N-dimethylacetamide; N,N-diethylacetamide; N-methyl-2-pyrrolidone; 1-methyl-2-pyrrolidinone; N-cyclohexyl-2-imidazolidinone; diethylene glycol dimethoxyether; o-dichlorobenzene; phenols; cresols; xylenol; catechol; butyrolactones; acetone; methyl ethyl ketone; ethyl ethyl ketone; methyl propyl ketone; acetonitrile; ethyl acetate; and/or hexamethylphosphoramides. In some embodiments, it can be particularly advantageous if the solvent comprises N-methyl-2-pyrrolidone.

In some embodiments in which drying of the gel to form the aerogel involves evaporative drying, it can be particularly advantageous to use a low surface tension solvent as a transfer solvent. In certain embodiments in which supercritical drying of the gel is used to produce the aerogel, it can be particularly advantageous to use CO₂, ethanol, methanol, acetone, or acetonitrile as a transfer solvent. In some embodiments in which drying of the gel to form the aerogel involves atmospheric pressure freeze drying, it can be particularly advantageous to use tert-butanol, water, or other freeze drying solvents as a transfer solvent (with tert-butanol being particularly advantageous, in certain cases).

In some embodiments, multiple solvent exchange processes are used to form the aerogel from the gel.

As noted above, the gel within the gel/foam material combination can be formed via gelation. The gelation can comprise, in certain embodiments, polymerization and/or cross-linking (and, typically, both) of aerogel precursor material. The selection of pre-polymer material and cross-linking agent generally depends on the type of aerogel material being formed. Examples for different aerogel materials are provided below.

In some embodiments, the melamine-formaldehyde foam makes up a substantial portion of the aerogel/foam material combination. For example, in some embodiments, greater than or equal to 1 wt %, greater than or equal to 2 wt %, greater than or equal to 3 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of the aerogel/foam material combination is made of foam (e.g., melamine-formaldehyde foam). In some embodiments, less than or equal to 95 wt %, less than or equal to 90 wt %, less than or equal to 85 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, or less than or equal to 10 wt % of the aerogel/foam material combination is made of foam (e.g., melamine-formaldehyde foam). Combinations of the above-referenced ranges are also possible (e.g., greater than or equal to 1 wt % and less than or equal to 95 wt %). Other ranges are also possible.

In some embodiments, a substantial percentage of the aerogel/foam material combination is made of polymer aerogel (e.g., polyimide aerogel). For example, in some embodiments, greater than or equal to 1 wt %, greater than or equal to 2 wt %, greater than or equal to 3 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of the aerogel/foam material combination is made of polymer aerogel (e.g., a polyimide aerogel). In some embodiments, less than or equal to 95 wt %, less than or equal to 90 wt %, less than or equal to 85 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 3 wt %, less than or equal to 2 wt %, or less than or equal to 1 wt % of the aerogel/foam material combination is made of polymer aerogel (e.g., polyimide aerogel). Combinations of the above-referenced ranges are also possible (e.g., greater than or equal to 1 wt % and less than or equal to 95 wt %). Other ranges are also possible.

The polymer aerogel and melamine-formaldehyde foam of the aerogel/foam material combination may be present in any of a variety of suitable ratios. In some embodiments, the mass ratio of polymer aerogel to melamine-formaldehyde foam in the aerogel/foam material combination is at least 0.1:1, at least 0.2:1, at least 0.3:1, at least 0.5:1, at least 0.7:1, at least 1:1, at least 1:2, at least 1:3, at least 1:4, at least, 1:5, at least 1:10, at least 1:15, at least 1:20, at least, 1:100, at least 1:1000, or at least 1:10,000. In some embodiments, a mass ratio of polymer aerogel to melamine-formaldehyde foam in the aerogel/foam material combination is less than or equal to 1:10,000, less than or equal to 1:1000, less than or equal to 1:100, less than or equal to 1:20, less than or equal to 1:15, less than or equal to 1:10, less than or equal to 1:5, less than or equal to 1:4, less than or equal to 1:3, less than or equal to 1:2, less than or equal to 1:1, less than or equal to 0.7:1, less than or equal to 0.5:1, less than or equal to 0.3:1, less than or equal to 0.2:1, less than or equal to 0.1:1, or less. Combinations of the above-referenced ranges are also possible (e.g., at least 0.1:1 and less than or equal to 1:10,000). Other ranges are also possible.

In some embodiments, a relatively high percentage of the aerogel within the aerogel/foam material combination falls within the outer boundary of the foam within the aerogel/foam material combination. In some embodiments, a relatively high percentage of the foam within the aerogel/foam material combination falls within the outer boundary of the aerogel within the aerogel/foam material combination. In some embodiments, at least 15 vol %, at least 25 vol %, at least 50 vol %, at least 75 vol %, at least 85 vol %, at least 90 vol %, at least 95 vol %, at least 99 vol %, or all of the volume within the outer boundary of the foam of the aerogel/foam material combination lies within the outer boundary of the aerogel of the aerogel/foam material combination. In certain embodiments, at least 15 vol %, at least 25 vol %, at least 50 vol %, at least 75 vol %, at least 85 vol %, at least 90 vol %, at least 95 vol %, at least 99 vol %, or all of the volume within the outer boundary of the aerogel of the aerogel/foam material combination lies within the outer boundary of the foam of the aerogel/foam material combination.

In some embodiments, a relatively high percentage of the three-dimensional convex hull of the aerogel within the aerogel/foam material combination falls within the three-dimensional convex hull of the foam within the aerogel/foam material combination. In some embodiments, a relatively high percentage of the three-dimensional convex hull of the foam within the aerogel/foam material combination falls within the three-dimensional convex hull of the aerogel within the aerogel/foam material combination. The phrase “three-dimensional convex hull” is given its ordinary meaning in geometry and refers to the smallest three-dimensional convex set that contains all of the points within a given collection of points. The three-dimensional convex hull is also sometimes referred to in the field of geometry as the three-dimensional convex envelope or the three-dimensional convex closure, and it can be visualized (with respect to a collection of points) as the shape enclosed by a deformable sheet that is arranged such that it completely surrounds a three-dimensional depiction of the points. In some embodiments, at least 15 vol %, at least 25 vol %, at least 50 vol %, at least 75 vol %, at least 85 vol %, at least 90 vol %, at least 95 vol %, at least 99 vol %, or all of the three-dimensional convex hull of the foam of the aerogel/foam material combination lies within the three-dimensional convex hull of the aerogel of the aerogel/foam material combination. In certain embodiments, at least 15 vol %, at least 25 vol %, at least 50 vol %, at least 75 vol %, at least 85 vol %, at least 90 vol %, at least 95 vol %, at least 99 vol %, or all of the three-dimensional convex hull of the aerogel of the aerogel/foam material combination lies within the three-dimensional convex hull of the foam of the aerogel/foam material combination.

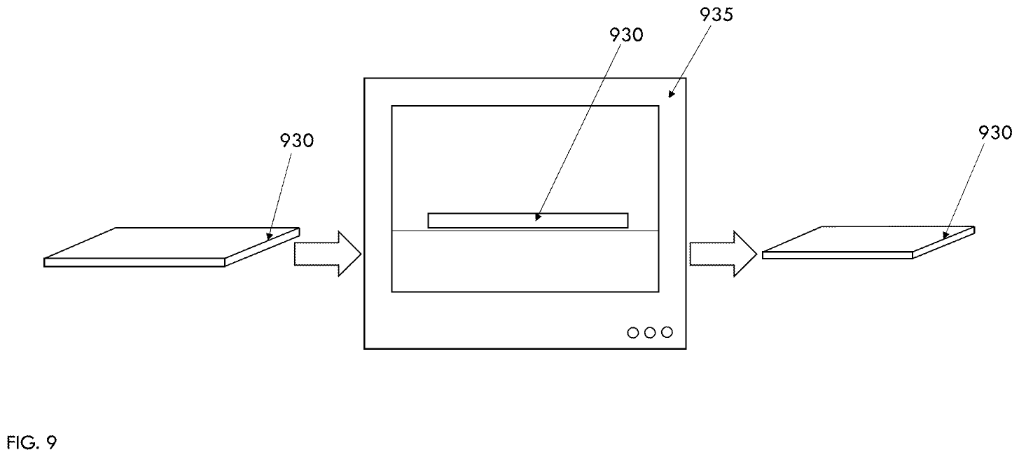

In some embodiments, the aerogel/foam material combinations described herein are capable of performing in high-temperature applications. Testing of the performance of aerogel/foam material combinations at high temperatures can be conducted by analyzing the thermal performance of the aerogel/foam material combination when it is subjected to what is referred to herein as a “standard heating cycle.” As used herein, a “standard heating cycle” involves transfer of an object from (1) a steel plate at 25° C. in an air environment at 25° C. and 1 atm pressure, where the object is at a uniform temperature of 25° C. (also referred to herein as “starting low-temperature conditions”), to (2) for 60 minutes, an air environment over a steel plate, the steel plate and the air being at a specified elevated temperature, and the air environment being sufficiently large that its size does not impact heat transfer rates, then back to (3) starting low-temperature conditions until the object is cooled to a uniform temperature of 25° C. FIG. 9 shows, schematically, this process for an aerogel/foam material combination. In FIG. 9, aerogel/foam material combination 930 is transferred from a steel plate at 25° C. in an air environment at 25° C. and 1 atm pressure (left), to an air environment over a steel plate within oven 935 for 60 minutes (middle), and then back to starting low-temperature conditions until aerogel/foam material combination 935 is cooled to a uniform temperature of 25° C. (right).

In some embodiments, the aerogel/foam material combinations described herein are capable of withstanding dimensional change at 200° C., which is a temperature that is indicative of the upper end of the operating temperature range for many high-temperature applications, such as engine cover applications, and is also a point at which native polymer aerogels, such as polyimide aerogels, often begin to show obvious dimensional change due to temperature. For example, in some embodiments, the aerogel/foam material combinations described herein can be subjected to a standard heating cycle in which the elevated temperature is 200° C. (or 250° C., 300° C., or 350° C.) and no dimension of the aerogel/foam material combination changes by more than 10% (or, in some embodiments, more than 5%, more than 2%, more than 1%, or more than 0.1%).

In some embodiments, the aerogel/foam material combination has desirable materials properties for engineering applications. In some embodiments, the aerogel/foam material combination is capable of operating at temperatures of at least 100° C., at least 200° C., at least 250° C., at least 300° C., at least 325° C., and/or at least 350° C. In some embodiments, the aerogel/foam material combination does not ignite in air at any temperature below 100° C., at any temperature below 200° C., at any temperature below 250° C., at any temperature below 300° C., at any temperature below 325° C., or at any temperature below 350° C. In some embodiments, for at least one dimension of the aerogel/foam material combination, the dimension does not change by more than 20%, by more than 10%, by more than 5%, or by more than 2% at any temperature below 100° C., at any temperature below 200° C., at any temperature below 250° C., at any temperature below 300° C., at any temperature below 325° C., or at any temperature below 350° C.

In some embodiments, when the aerogel/foam material combination is subjected to a standard heating cycle in which the elevated temperature is 200° C. (or to a temperature of 250° C. 300° C., or 350° C.) at least one (or at least two, or all three) dimensions of the aerogel/foam material combination fall within 50%, within 30%, within 20%, within 10%, within 5%, or within 3% (and/or, in some embodiments, down to within 1%, within 0.1%, within 0.01%, or less) of the dimensions of the aerogel/foam material combination prior to the standard heating cycle.

In some embodiments, the aerogel/foam material combination undergoes irreversible one-time linear shrinkage of less than or equal to 20%, less than or equal to 15%, less than or equal to 10%, or less than or equal to 5% (and/or, as little as 0%) when exposed to flame for two cycles.

In some embodiments, when the aerogel/foam material combination is exposed to its maximum operating temperature for the first time, the aerogel/foam material combination undergoes irreversible one-time linear shrinkage of less than or equal to 20%, less than or equal to 15%, less than or equal to 10%, or less than or equal to 5% (and/or, as little as 0%). In some embodiments, when the aerogel/foam material combination is subjected to a standard heating cycle having an elevated temperature of 200° C. (or an elevated temperature of 250° C., 300° C., 325° C., 350° C., or its maximum operating temperature), the aerogel/foam material combination undergoes irreversible one-time linear shrinkage of at least one dimension (or of at least two dimensions, or of all three dimensions) of less than or equal to 20%, less than or equal to 15%, less than or equal to 10%, or less than or equal to 5% (and/or, as little as 0%) relative to the dimension prior to the standard heating cycle. In some embodiments, when the aerogel/foam material combination is subjected to two standard heating cycles having an elevated temperature of 200° C. (or an elevated temperature of 250° C., 300° C., 325° C., 350° C., or its maximum operating temperature), the aerogel/foam material combination undergoes irreversible one-time linear shrinkage of at least one dimension (or of at least two dimensions, or of all three dimensions) of less than or equal to 20%, less than or equal to 15%, less than or equal to 10%, or less than or equal to 5% (and/or, as little as 0%) relative to the dimension prior to the standard heating cycle. As is well known, objects in three-dimensional space exhibit three orthogonal dimensions length, width, and height. Linear shrinkage generally corresponds to the percent change in one of the three orthogonal dimensions following a treatment of the object under given conditions comparing the same dimensional axis before and after treatment.

In some embodiments, when the aerogel/foam material combination is subjected to a standard heating cycle having an elevated temperature of 200° C. (or a temperature of 250° C. 300° C. 325° C. 350° C., or its maximum operating temperature), the BET surface area of the aerogel/foam material combination is greater than or equal to 10 m²/g, greater than or equal to 20 m²/g, greater than or equal to 40 m²/g, greater than or equal to 60 m²/g greater than or equal to 80 m²/g, greater than or equal to 100 m²/g, greater than or equal to 150 m²/g, greater than or equal to 200 m²/g, greater than or equal to 250 m²/g, greater than or equal to 300 m²/g, greater than or equal to 350 m²/g, greater than or equal to 400 m²/g, greater than or equal to 600 m²/g, or greater than or equal to 800 m²/g (and/or, in some embodiments, as much as 2,000 m²/g; as much as 4,000 m²/g, as much as 8,000 m²/g, or more).

In some embodiments, when the aerogel/foam material combination is subjected to a standard heating cycle having an elevated temperature of 200° C. (or a temperature of 250° C., 300° C., 325° C., 350° C., or its maximum operating temperature), the flatness of the aerogel/foam material combination changes by less than or equal to 10%, less than or equal to 9%, less than or equal to 8%, less than or equal to 7%, less than or equal to 6%, less than or equal to 5%, less than or equal to 4%, less than or equal to 3% less than or equal to 2%, or less than or equal to 1% (and/or, in some embodiments, as little as 0%) relative to its initial flatness.

In some embodiments, when the aerogel/foam material combination is subjected to a standard heating cycle having an elevated temperature of 200° C. (or a temperature of 250° C., 300° C. 325° C., 350° C., or its maximum operating temperature), the thickness of the aerogel/foam material combination changes by less than or equal to 10%, less than or equal to 9%, less than or equal to 8%, less than or equal to 7%, less than or equal to 6%, less than or equal to 5%, less than or equal to 4%, less than or equal to 3% less than or equal to 2%, or less than or equal to 1% (and/or, in some embodiments, as little as 0%) relative to its initial thickness.

As used herein, the phrase “maximum operating temperature” refers to the highest temperature at which an article is designed to operate for extended periods of time with acceptable stability in its mechanical and thermal properties. The maximum operating temperature is usually a temperature above which the article undergoes substantial chemical and/or mechanical degradation. Examples of chemical degradation include denaturing, decomposition, phase change, and ignition. Examples of mechanical degradation include mechanical warping, falling apart, and the like. In some embodiments, the maximum operating temperature is set by a loss of surface area of greater than or equal to 90%, greater than or equal to 80%, greater than or equal to 70%, greater than or equal to 60%, greater than or equal to 50%, greater than or equal to 40%, greater than or equal to 30%, greater than or equal to 20%, greater than or equal to 10%, greater than or equal to 5%, or greater than or equal to 1%. In some embodiments, it can be particularly advantageous if the maximum operating temperature is set by a loss of surface area of greater than or equal to 40%.

In some embodiments, the mechanical degradation temperature refers to the temperature above which the article falls apart. In some embodiments, the ignition temperature refers to the temperature above which the article ignites (i.e., catches on fire) in air. In some embodiments, the chemical degradation temperature refers to the temperature above which the article continues to lose mass even once reaching thermal equilibrium.

In some embodiments, the aerogel/foam material combination undergoes irreversible one-time linear shrinkage of less than or equal to 20%, less than or equal to 15%, less than or equal to 10%, or less than or equal to 5% when contacted with a 1.5″ Bunsen burner flame. Irreversible one-time linear shrinkage according to this test can be determined by taking a aerogel/foam material combination initially at a temperature of 25° C., contacting the aerogel/foam material combination with a 1.5″ Bunsen burner flame, transferring the aerogel/foam material combination back into an environment at 25° C. and 1 atm pressure of air and allowing it to cool until the aerogel/foam material combination reaches a temperature of 25° C., measuring the dimensions of the aerogel/foam material combination, contacting the aerogel/foam material combination to the same flame in the same manner again, transferring the aerogel/foam material combination back into an environment at 25° C. and 1 atm pressure of air and allowing it to cool until the aerogel/foam material combination reaches a temperature of 25° C. measuring the dimensions of the aerogel/foam material combination, and comparing the dimensions of the aerogel/foam material combination after the second contact with the flame to the dimensions measured after the initial contact with the flame. In some embodiments, the dimensions of the aerogel/foam material combination after the second contact with the flame are within 5%, within 4%, within 3%, within 2%, or within 1% of the dimensions of the aerogel/foam material combination after the first contact with the flame.

In some embodiments, the aerogel/foam material combination is nonflammable. Non-flammability generally refers to the ability of the aerogel/foam material combination to meet the criteria of a burn certification. In some embodiments, the aerogel/foam material combination meets the criteria for flame time, drip flame time, and/or burn length set forth in Part 25.853a of the United States Federal Aviation Regulations. In some embodiments, the aerogel/foam material combination meets the criteria for Class A1. Class A2, and/or Class B fire behavior of the European classification standard EN 13501-1.

In some embodiments, the aerogel/foam material combination exhibits low flammability upon contact with flame. In some embodiments, when subjected to a vertical burn test above a Bunsen burner burning propane, the aerogel/foam material combination is nonflammable.

In certain embodiments, the aerogel/foam material combination is capable of passing a vertical burn test based on the procedures described in section 25.853 of the United States Federal Aviation Regulations (FAR) burn requirements for aviation interiors, modified as follows: The sample to be used for the test is 2.5 inches in width by 3.5 inches in height by 0.25 inches in thickness; the sample is prepared by conditioning at 50% relative humidity and 70° F. (21.1° C.); the flame source is a Bunsen burner using propane fuel, adjusted to a 1.5 inch flame height; the sample is hung with the shorter 2.5 inch edge 0.75 inches from the top of the Bunsen burner flame such that the 3.5 inch edge is vertical (i.e., parallel to the force of gravity); the flame is applied to the sample for a period of 1 minute and then removed. In some embodiments, the sample, when tested in this manner, will self-extinguish in less than or equal to 1 second after removal of the flame. In some embodiments, the material combination samples will not substantially burn or sustain flame at any point, but rather, will char in the presence of the flame.

In certain embodiments, the aerogel/foam material combination can have water-resistant properties.

In some embodiments, the aerogel/foam material combination may exhibit hydrophobicity. The term hydrophobicity refers to the absence and/or partial absence of attractive force between a material and a mass of water. The hydrophobicity of a bulk material generally refers to this behavior as it applies to an external surface of the bulk material. The apparent hydrophobicity of an external surface (e.g., a textured external surface) can be, in some cases, higher than the hydrophobicity of the bulk material.

Hydrophobicity of an aerogel/foam material combination can be expressed in terms of the liquid water uptake. The term liquid water uptake refers to the ability of a material or composition to absorb, adsorb, or otherwise retain water due to contact with water in the liquid state. Liquid water uptake can be expressed one of several ways, for example, as a fraction or percent of the open pore volume or envelope volume of the aerogel, or as a fraction or percent relative to the mass of the unwetted aerogel. The liquid water uptake reported is understood to be a measurement undertaken under specific conditions. A material that has superior or improved liquid water uptake relative to a different material is understood to have a lower uptake of liquid water.

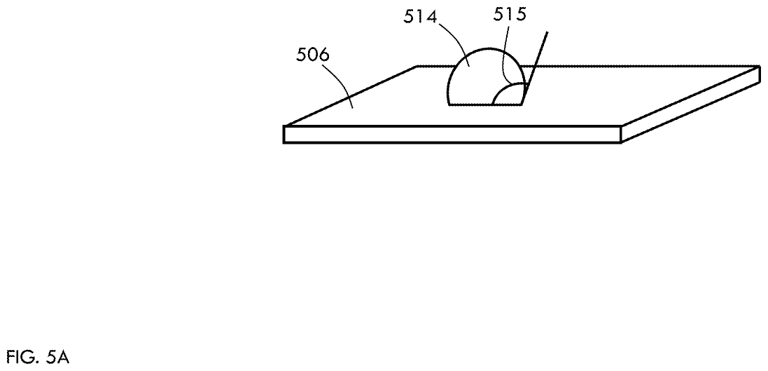

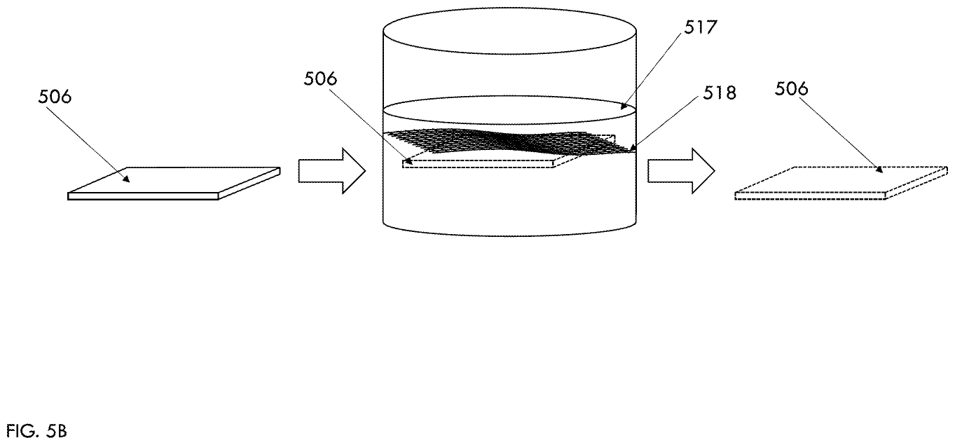

It may be beneficial to measure the uptake of water of an aerogel/foam material combination. This may be achieved by submerging the aerogel/foam material combination in water. By way of illustration, FIG. 5B schematically shows aerogel/foam material combination 506 submerged in water 517. A submerged aerogel/foam material combination 506 may then uptake (or not uptake) water over a period of time (e.g., 24 hours). A mesh 518 can be used to keep the aerogel/foam material combination submerged in water during the duration of time. After submerging, the aerogel/foam material combination can be recovered, as shown in FIG. 5B as a recovered aerogel/foam material combination 506. The recovered aerogel/foam material combination can then be compared (e.g., a weight comparison) to aerogel/foam material combination 506 prior to submersion. In some embodiments, when the aerogel/foam material combination is submerged under water at 25° C. for 24 hours, the aerogel/foam material combination uptakes a mass of water within its outer boundaries of less than or equal to 200 wt %, less than or equal to 150 wt %, less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the dry mass of the aerogel/foam material combination prior to submerging the aerogel/foam material combination in the water. In some embodiments, the aerogel/foam material combination exhibits any of these properties after being subjected to a standard heating cycle in which the elevated temperature is 200° C. (or 250° C., 300° C., or 350° C.).

In some embodiments, the liquid water uptake of the aerogel/foam material combination may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel/foam material combination before contact with liquid water when measured according to standard ASTM C1511. In some embodiments, the aerogel/foam material combination exhibits any of these properties after being subjected to a standard heating cycle in which the elevated temperature is 200° C. (or 250° C., 300° C., or 350° C.).

In some embodiments, the liquid water uptake of the aerogel/foam material combination may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel/foam material combination before contact with liquid water when measured according to standard ASTM C1763. In some embodiments, the aerogel/foam material combination exhibits any of these properties after being subjected to a standard heating cycle in which the elevated temperature is 200° C. (or 250° C., 300° C., or 350° C.).

In some embodiments, the liquid water uptake of the aerogel/foam material combination may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel/foam material combination before contact with liquid water when measured according to standard EN 1609. In some embodiments, the aerogel/foam material combination exhibits any of these properties after being subjected to a standard heating cycle in which the elevated temperature is 200° C. (or 250° C., 300° C., or 350° C.).

Hydrophobicity of a material combination can also be expressed in terms of the water vapor uptake. The term water vapor uptake refers to the ability for a material or composition to absorb, adsorb, or otherwise retain water due to contact with water in the vapor state. Water vapor uptake can be expressed as a fraction or percent of water retained relative to the mass of the article before exposure to water vapor. The water vapor uptake reported is understood to be a measurement undertaken under specific conditions. An article which has superior or improved water vapor uptake relative to a different material is understood to have a lower sorption or retention of water vapor. In some embodiments, the water vapor uptake of the aerogel/foam material combination may be less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel/foam material combination before exposure to water vapor, when measured according to standard ASTM C1104. In some embodiments, the aerogel/foam material combination exhibits any of these properties after being subjected to a standard heating cycle in which the elevated temperature is 200° C. (or 250° C., 300° C., or 350° C.).

Hydrophobicity of a material combination can also be expressed in terms of the water contact angle. The term water contact angle refers to the equilibrium contact angle of a drop of water in contact with an external surface of the material. A material that has superior or improved hydrophobicity relative to a different material generally has a higher water contact angle. For example, in FIG. 5A, foam/aerogel material combination 506 has a water droplet 514 on its surface, and contact angle 515 is shown. In some embodiments, the water contact angle of the aerogel/foam material combination may be greater than 90°, greater than 100°, greater than 110°, greater than 120°, greater than 130°, greater than 140°, greater than 150°, greater than 160°, greater than 170° (and/or, in some embodiments, up to 175°, up to 178°, up to 179°, up to 179.9°, or greater) when measured according to standard ASTM D7490. In some embodiments, particularly advantageous aerogel/foam material combinations exhibit a contact angle with water, in an ambient air environment at 1 atm and 25° C., of greater than 90°, greater than 100°, greater than 110°, greater than 120°, greater than 130°, greater than 140°, greater than 150°, greater than 160°, greater than 170° (and/or, in some embodiments, up to 175°, up to 178°, up to 179°, up to 179.9°, or greater) when measured according to standard ASTM D7490. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination is surfactant resistant. In some embodiments, the aerogel/foam material combination is launderable. In some embodiments, the aerogel/foam material combination has a relatively low detergent uptake. Detergent uptake can be determined according to the following test. 0.97 g of sodium dodecyl sulfate is added to 1 liter of analytical reagent grade deionized (DI) water and dissolved to make a detergent solution. 50 mL of the detergent solution is added to a 1.5-inch tall by 3-inch wide cylindrical vial. A sample of the aerogel/foam material combination that is 1 cm×1 cm×2 mm is prepared and added to the vial. Wire mesh is press fit into the vial such that the sample remains totally submerged for 24 hours at 20° C. The sample is then removed from the detergent solution, and the surface liquid is mechanically removed. The sample is then weighed. The difference in mass between the sample after the test and before the test is the detergent uptake, and it is generally expressed as a percentage increase in mass relative to the original mass of the sample. In some embodiments, the aerogel/foam material combination exhibits a detergent uptake, according to this test, of less than or equal to 300%, less than or equal to 200%, less than or equal to 100%, less than or equal to 50%, less than or equal to 10%, less than or equal to 5%, less than or equal to 1% (and/or, as little as 0.1%, at little as 0.01%, as little as 0.001%, or less).

In certain embodiments, the aerogel/foam material combination can have a desirable bulk density. The bulk density of an aerogel/foam material combination may be determined by dimensional analysis. For example, bulk density may be measured by first carefully machining a specimen into a regular shape, e.g., a block or a rod. The length, width, and thickness (or length and diameter) may be measured using calipers (accuracy ±0.001″). These measurements may then be used to calculate the specimen volume by, in the case of a block, multiplying length*width*height, or in the case of a disc, multiplying the height*the radius squared*pi. Mass may be measured using a digital analytical balance with a precision of 0.001 g. Bulk density may then be calculated as density=mass/volume. In some embodiments, the bulk density of the aerogel/foam material combination may be greater than or equal to 0.01 g/cc, greater than or equal to 0.05 g/cc, greater than or equal to 0.1 g/cc, greater than or equal to 0.2 g/cc, greater than or equal to 0.3 g/cc, greater than or equal to 0.4 g/cc, greater than or equal to 0.5 g/cc, greater than or equal to 0.6 g/cc, greater than or equal to 0.7 g/cc, or less than or equal to 0.8 g/cc (and/or, in some embodiments, as little as 0.1 g/cc, as little as 0.01 g/cc, or less). In certain embodiments, the bulk density of the material combination may be between 0.01 g/cc and 0.8 g/cc (endpoints inclusive). In some embodiments, it can be particularly advantageous if the material combination exhibits a bulk density of greater than or equal to 0.01 g/cc and less than or equal to 0.5 g/cc. In some embodiments, the aerogel/foam material combination exhibits any of these properties after being subjected to a standard heating cycle in which the elevated temperature is 200° C. (or 250° C., 300° C., or 350° C.).

The aerogel/foam material combination may exhibit any of a variety of suitable skeletal densities. One of ordinary skill in the art would appreciate that skeletal density refers to density of the solid component of the aerogel/foam material combination as opposed to the bulk density of the aerogel/foam material combination, which includes the volume of its pores. Skeletal density may be measured by measuring the skeletal volume of specimen using a pycnometer, for example, a Micromeritics AccuPyc II 1340 Gas Pycnometer, employing helium as the working gas. Specimens may be dried under a flow of nitrogen or helium prior to measurement to remove moisture or other solvent from the pores of the aerogel/foam material combination. Skeletal volume measurements may be taken by averaging 100 measurements. Mass may be measured using a digital analytical balance with a precision of 0.001 g. Skeletal density may be calculated as skeletal density=mass/skeletal volume. In some embodiments, the skeletal density of the aerogel/foam material combination is greater than or equal to 1 g/cc, greater than or equal to 1.2 g/cc, greater than or equal to 1.3 g/cc, greater than or equal to 1.4 g/cc, greater than or equal to 1.5 g/cc, greater than or equal to 1.6 g/cc, greater than or equal to 1.7 g/cc, greater than or equal to 1.8 g/cc, greater than or equal to 1.9 g/cc, greater than or equal to 2.0 g/cc, greater than or equal to 2.1 g/cc, greater than or equal to 2.2 g/cc, greater than or equal to 2.3 g/cc, greater than or equal to 2.4 g/cc, greater than or equal to 2.5 g/cc, greater than or equal to 3 g/cc, greater than or equal to 4 g/cc (and/or, in some embodiments, less than or equal to 5 g/cc, less than or equal to 4.5 g/cc, less than or equal to 4 g/cc, less than or equal to 3.5 g/cc, less than or equal to 3 g/cc, less than or equal to 2.5 g/cc, less than or equal to 2 g/cc, less than or equal to 1.5 g/cc, less than or equal to 1.4 g/cc, less than or equal to 1.3 g/cc). In some embodiments, the aerogel/foam material combination exhibits any of these properties after being subjected to a standard heating cycle in which the elevated temperature is 200° C. (or 250° C. 300° C., or 350° C.).

The aerogel/foam material combination may exhibit any of a variety of suitable pore structures. Pore width distribution, pore area distribution, and mean pore size may be calculated from the nitrogen desorption isotherm using the Barrett-Joyner-Halenda (BJH) method over ranges typically reemployed in measuring pore width and pore area distribution. In some embodiments, the aerogel/foam material combination comprises pores of less than or equal to 100 microns, less than or equal to 10 microns, less than or equal to 1 micron, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm. In some embodiments the aerogel/foam material combination comprises pores of greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and or greater than or equal to 100 microns.

Average pore width, e.g., mean pore size, (assuming cylindrical pores) may be calculated using pore width=4*(total specific volume)/(specific surface area) where total specific volume and specific surface area may also be calculated using BJH analysis of the desorption isotherm. In some embodiments, the average pore width of the aerogel/foam material combination is less than or equal 1 mm, less than or equal to 100 μm, less than or equal to 10 μm, less than or equal to 1 μm, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm (and/or, in some embodiments, greater than or equal to 5 nm, greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and/or greater than or equal to 100 microns). In some embodiments, the aerogel/foam material combination exhibits a BJH mean pore diameter greater than or equal to 2 nm and less than or equal to 50 nm when measured using nitrogen sorptimetry. In some embodiments, the aerogel/foam material combination exhibits a BJH mean pore diameter of greater than or equal to 10 nm and less than or equal to 25 nm when measured using nitrogen sorptimetry. In certain embodiments, it can be particularly advantageous if the average pore width of the aerogel/foam material combination is less than or equal to 50 nm. In some embodiments, it can be particularly advantageous if the average pore width of the aerogel/foam material combination is less than or equal to 20 nm. In some embodiments, the aerogel/foam material combination exhibits any of these properties after being subjected to a standard heating cycle in which the elevated temperature is 200° C. (or 250° C., 300° C., or 350° C.).

In some embodiments, the pore width distribution of the aerogel/foam material combination may be unimodal (i.e., exhibiting a single maximum). In some embodiments, the pore width distribution maximum is found at less than or equal 1 mm, less than or equal to 100 μm, less than or equal to 10 μm, less than or equal to 1 μm, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm (and/or, in some embodiments, greater than or equal to 5 nm, greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and/or greater than or equal to 100 microns). In some embodiments, the aerogel/foam material combination comprises a unimodal pore size distribution. In some embodiments, the aerogel/foam material combination exhibits any of these properties after being subjected to a standard heating cycle in which the elevated temperature is 200° C. (or 250° C., 300° C., or 350° C.).

In some embodiments, the pore width distribution of the aerogel/foam material combination may be bimodal, or at least bimodal. In some embodiments, the aerogel/foam material combination can have two distinct populations of pores, one with an average pore size less than or equal to a certain critical pore width, and one with an average pore size greater than some critical pore width. In some embodiments, the critical pore width is less than or equal 1 mm, less than or equal to 100 μm, less than or equal to 10 μm, less than or equal to 1 μm, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm (and/or, in some embodiments, greater than or equal to 5 nm, greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and/or greater than or equal to 100 microns). In some embodiments, the aerogel/foam material combination comprises a bimodal pore size distribution. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination exhibits a BJH pore volume of greater than or equal to 0.05 cm³/g and less than or equal to 5 cm³/g. In some embodiments, the aerogel/foam material combination exhibits a BJH pore volume of greater than or equal to 0.05 g/cm³, greater than or equal to 1 g/cm³, greater than or equal to 2 g/cm³, greater than or equal to 3 g/cm³, greater than or equal to 4 g/cm³, and/or less than or equal to 5 g/cm³. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination may exhibit an internal specific surface area. As used herein, the internal surface area and specific surface area have the same meaning and describe the same phenomenon. These values may also be referred to as the BET surface area. The internal specific surface area of a aerogel/foam material combination may be determined using nitrogen adsorption porosimetry and deriving the surface area value using the Brunauer-Emmett-Teller (BET) model. For example, nitrogen sorption porosimetry may be performed using a Micromeritics Tristar II 3020 surface area and porosity analyzer. Before porosimetry analysis, specimens may be subjected to vacuum of ˜100 torr for 24 hours to remove adsorbed water or other solvents from the pores of the specimens. The porosimeter may provide an adsorption isotherm and desorption isotherm, which comprise the amount of analyte gas adsorbed or desorbed as a function of partial pressure. Specific surface area may be calculated from the adsorption isotherm using the BET method over ranges typically employed in measuring surface area. In some embodiments, the BET surface area of the aerogel/foam material combination is greater than or equal to 5 m²/g, greater than or equal to 50 m²/g, greater than or equal to 100 m²/g, greater than or equal to 200 m²/g, greater than or equal to 300 m²/g, greater than or equal to 400 m²/g, greater than or equal to 500 m²/g, greater than or equal to 600 m²/g, greater than or equal to 700 m²/g, greater than or equal to 800 m²/g, greater than or equal to 1000 m²/g, greater than or equal to 2000 m²/g, greater than or equal to 3000 m²/g, and/or less than or equal to 1500 m²/g, or less than or equal to 4000 m²/g. In some embodiments, the BET surface area of the aerogel/foam material combination is greater than or equal to 5 m²/g and less than or equal to 4000 m²/g. In some embodiments, it can be particularly advantageous if the aerogel/foam material combination exhibits a BET surface area of greater than or equal to 100 m²/g and less than or equal to 800 m²/g. Values of the BET surface area of the aerogel/foam material combination outside of these ranges may be possible. In certain embodiments, it can be particularly advantageous if the aerogel/foam material combination exhibits a BET surface area of greater than or equal to 200 m²/g and less than or equal to 400 m²/g. In some embodiments, the aerogel/foam material combination exhibits any of these properties after being subjected to a standard heating cycle in which the elevated temperature is 200° C. (or 250° C., 300° C., or 350° C.).

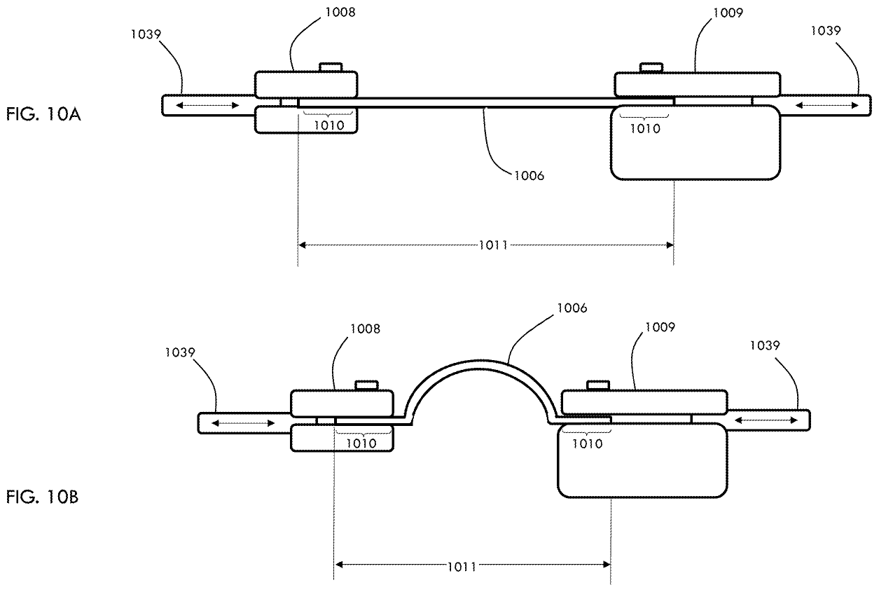

Dusting of an aerogel/foam material combination may be unfavorable in a number of applications. Without wishing to be bound by any particular theory, it is believed that dusting of aerogel/foam material combinations is caused by low fracture toughness of the material combination and that the dust is made of small pieces of the material combination that break off due to shear, tensile, and/or flexural stress. In some embodiments, dusting of aerogel from an aerogel/foam material combination maybe caused by low fracture toughness of the aerogel. The degree of dusting of an aerogel/foam material combination can be determined using an apparatus like the one illustrated in FIGS. 10A-10B, as follows. The apparatus comprises a rail on which two parallel clamps (1008 and 1009 in FIGS. 10A-10B) are installed. The clamps are attached to linear actuators (1039 in FIGS. 10A-10B) that are able to slide the clamps along the rail. The clamps each include an indentation of 1 cm into which the aerogel/foam material combination sample can be placed. To test a particular aerogel/foam material combination, a representative sample that is 2.5 inches×3.5 inches×2 mm thick is cut. The sample mass is measured and recorded. The sample is clamped between the two clamps of the rail such that 1 cm of the length of the sample (see dimensions 1010 in FIGS. 10A-10B) is positioned between each clamp. The clamps are positioned such that the sample initially is not under tension or compression along the length of the rail (see FIG. 10A). This position is referred to as the unflexed position. The clamps are then moved by the linear actuators toward each other by a distance of 0.5 inches each, such that the ends of the aerogel/foam material combination sample are now 2.5 inches apart (scc dimension 1011 in FIG. 10B, compared to dimension 1011 in FIG. 10A). This is considered the flexed position. The linear actuators then move the clamps back to the unflexed position. This is considered one flex cycle. During testing, each flex cycle is performed in 1 second, and for a dusting test, the sample is flexed 1000 times. The sample mass is measured again after the dusting test. The difference in sample mass from before the dusting test and after the dusting test is the amount of mass lost due to dusting. In some embodiments, after the dusting test, the change in the mass of the aerogel/foam material combination sample is less than or equal to 50%, less than or equal to 25%, less than or equal to 10%, less than or equal to 5%, less than or equal to 2% (and/or, in some embodiments, as little as 0.1%, or as little as 0%). In some embodiments, the aerogel/foam material combination exhibits any of these properties after being subjected to a standard heating cycle in which the elevated temperature is 200° C. (or 250° C., 300° C., or 350° C.).

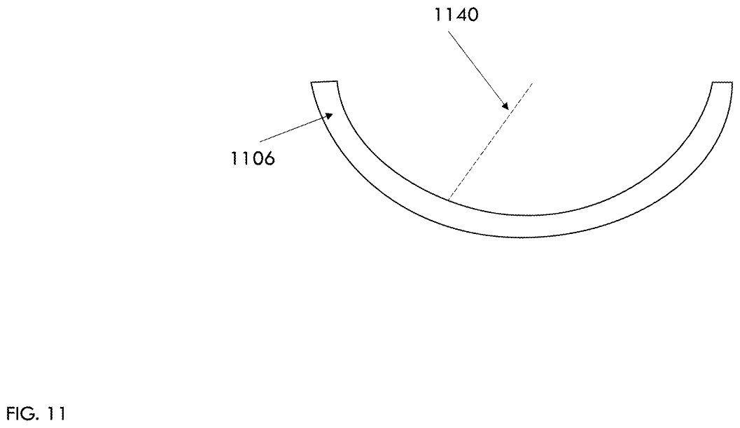

In some embodiments, a sample of the aerogel/foam material combination having dimensions of 4 inches×6 inches×2 mm and a longitudinal axis is capable of being deformed, without creasing, such that the longitudinal axis forms a radius of curvature of less than or equal to 1 inch, less than or equal to ½ inch, less than or equal to ¼ inch, less than or equal to ⅛ inch, less than or equal to 1/16 inch, less than or equal to 1/32 inch, less than or equal to 1/64 inch, or less than or equal to 1/256 inch (and/or, as little as 1/512 inch, or less). On example of this is shown in FIG. 11, where aerogel/foam material combination 1106 has been deformed, without creasing, to have a radius of curvature 1140. In some embodiments, it can be particularly advantageous if a sample of the aerogel/foam material combination having dimensions of 4 inches×6 inches×2 mm and a facial area defined by the 4 inch and 6 inch dimensions is capable of forming a radius of curvature of less than or equal to ¼ inch when flexed perpendicular to the 4 inch dimension. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination has a compressive modulus (also known as Young's modulus, in some embodiments approximately equal to bulk modulus) and yield strength which may be determined using standard uniaxial compression testing. Compressive modulus and yield strength may be measured using the method outlined in standard ASTM D1621-10 “Standard Test Method for Compressive Properties of Rigid Cellular Plastics” followed as written with the exception that specimens are compressed with a crosshead displacement rate of 1.3 mm/s (as prescribed in standard ASTM D695) rather than 2.5 mm/s. In certain embodiments, the compressive modulus of the aerogel/foam material combination is greater than or equal to 100 kPa, greater than or equal to 500 kPa, greater than or equal to 1 MPa, greater than or equal to 10 MPa, greater than or equal to 50 MPa, greater than or equal to 100 MPa, and/or less than or equal to 100 MPa, less than or equal to 50 MPa, less than or equal to 10 MPa, less than or equal to 1 MPa, less than or equal to 500 kPa, less than or equal to 100 kPa, or less than or equal to 50 kPa. Combinations of the above noted ranges, or values outside of these ranges, are possible for the compressive modulus of the aerogel/foam material combination. In some embodiments, it can be particularly advantageous if the aerogel/foam material combination exhibits a compressive modulus greater than or equal to 1 MPa. In some embodiments, the aerogel/foam material combination exhibits any of these properties after being subjected to a standard heating cycle in which the elevated temperature is 200° C. (or 250° C., 300° C., or 350° C.).

The aerogel/foam material combination may exhibit any of a variety of suitable compressive yield strengths. In certain embodiments, the compressive yield strength of the aerogel/foam material combination is greater than or equal to 40 kPa, greater than or equal to 100 kPa, greater than or equal to 500 kPa, greater than or equal to 1 MPa, greater than or equal to 5 MPa, greater than or equal to 10 MPa, greater than or equal to 50 MPa, greater than or equal to 100 MPa, greater than or equal to 500 MPa, and/or or less than or equal to 500 MPa, less than or equal to 100 MPa, less than or equal to 50 MPa, less than or equal to 10 MPa, less than or equal to 5 MPa, less than or equal to 1 MPa, less than or equal to 500 kPa, less than or equal to 100 kPa, or less than or equal to 50 kPa. Combinations of the above noted ranges, or values outside of these ranges, are possible for the compressive yield strength of the aerogel/foam material combination. In some embodiments, it can be particularly advantageous if the aerogel/foam material combination exhibits a compressive yield strength greater than or equal to 300 kPa. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination has a flexural modulus and flexural yield strength which may be determined using a standard mechanical testing method. Flexural modulus and yield strength may be measured using the method outlined in standard ASTM D790-10 “Flexural Properties of Unreinforced and Reinforced Plastics and Electrical Insulating Materials” followed as written, with the exception that specimen span is equal to a fixed value of 45 mm rather than varied as a ratio of the thickness of the specimen. Specimen length is at least 10 mm greater than the span. Specimen depth is in the range of 5 mm to 7 mm. Specimen width is in the range of 15 mm to 20 mm. In certain embodiments, the flexural modulus of the aerogel/foam material combination, as measured by the described method, may be at least 0.00689 MPa, at least 0.01 MPa, at least 0.02 MPa, at least 0.03 MPa, at least 0.04 MPa, at least 0.05 MPa, at least 0.06 MPa, at least 0.07 MPa, at least 0.08 MPa, at least 0.09 MPa, at least 0.1 MPa, at least 0.2 MPa, at least 0.3 MPa, at least 0.4 MPa, at least 0.5 MPa, at least 0.6 MPa, at least 0.7 MPa, at least 0.8 MPa, at least 0.9 MPa, at least 1 MPa, at least 2 MPa, at least 5 MPa, at least 10 MPa, at least 20 MPa, at least 50 MPa, at least 100 MPa, at least 200 MPa, at least 300 MPa, and/or less than or equal to 1 GPa, less than or equal to 500 MPa, less than or equal to 300 MPa, less than or equal to 200 MPa, less than or equal to 100 MPa, less than or equal to 50 MPa, and/or less than or equal to 20 MPa. In some embodiments, it can be particularly advantageous if the aerogel/foam material combination exhibits a flexural modulus greater than or equal to 1 MPa. The flexural modulus of the aerogel/foam material combination can be measured according to ASTM D790-10, with the exception that specimen span is equal to a fixed value of 45 mm. In some embodiments, the aerogel/foam material combination exhibits any of these properties after being subjected to a standard heating cycle in which the elevated temperature is 200° C. (or 250° C., 300° C., or 350° C.).

In some embodiments, the flexural strength of the aerogel/foam material combination is greater than or equal to 0.00689 MPa, at least 0.01 MPa, at least 0.02 MPa, at least 0.03 MPa, at least 0.04 MPa, at least 0.05 MPa, at least 0.06 MPa, at least 0.07 MPa, at least 0.08 MPa, at least 0.09 MPa, at least. 1 MPa, at least 0.2 MPa, greater than or equal to 0.5 MPa, greater than or equal to 1 MPa, greater than or equal to 1.5 MPa, greater than or equal to 2 MPa, greater than or equal to 2.5 MPa, greater than or equal to 3 MPa, greater than or equal to 3.5 MPa, or greater than or equal to 4 MPa, at least 5 MPa, at least 10 MPa, at least 20 MPa, at least 50 MPa, at least 100 MPa, at least 200 MPa, at least 300 MPa, and/or less than or equal to 1 GPa. In some embodiments, it can be particularly advantageous if the material combination exhibits a flexural strength greater than or equal to 0.5 MPa. The flexural strength of the aerogel/foam material combination can be measured according to ASTM D790-10, with the exception that specimen span is equal to a fixed value of 45 mm. In some embodiments, the aerogel/foam material combination exhibits any of these properties after being subjected to a standard heating cycle in which the elevated temperature is 200° C. (or 250° C., 300° C., or 350° C.).

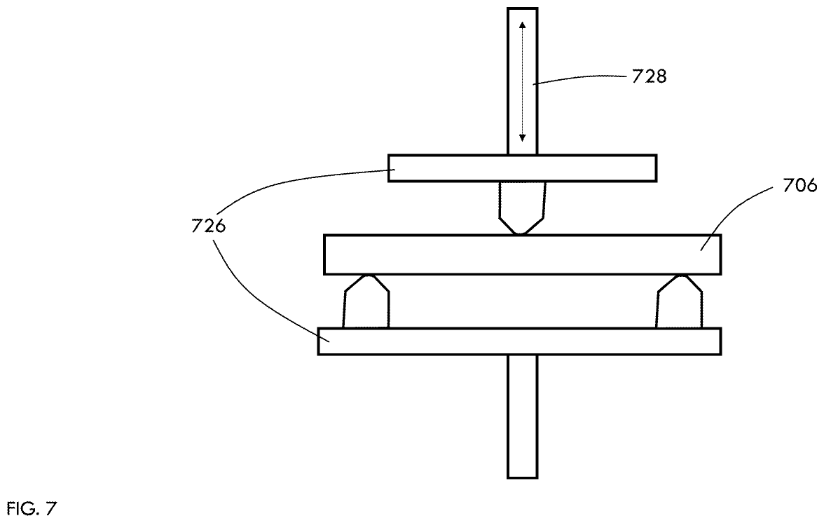

FIG. 7 depicts an apparatus used to measure flexural strength and modulus of an aerogel/foam material combination. An aerogel/foam material combination 706 is placed between plates 726, and stage 728 can be moved down to apply a force onto aerogel/foam material combination 706, which can be used to quantify flexural strength and/or modulus of the material.

In some embodiments, the aerogel/foam material combination can undergo flexural strain of greater than or equal to 1%, greater than or equal to 5%, greater than or equal to 10%, greater than or equal to 20%, greater than or equal to 30%, greater than or equal to 40%, greater than or equal to 50%, greater than or equal to 60%, greater than or equal to 70%, or greater than or equal to 80% (and/or, in some embodiments, up to 99.5%, or higher) without fracture. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination has a dielectric constant and loss tangent which may be determined using a standard testing method. Dielectric constant and loss tangent may be measured using the method outlined in standard ASTM D2520-13 “Complex Permittivity (Dielectric Constant) of Solid Electrical Insulating Materials at Microwave Frequencies and Temperatures up to 1650° C.” In certain embodiments, the aerogel/foam material combination exhibits an average dielectric constant over the range of 0-50 GHz of less than or equal to 100, less than or equal to 10, less than or equal to 5, less than or equal to 2, less than or equal to 1.75, less than or equal to 1.5, less than or equal to 1.4, or less than or equal to 1.25 (and/or, in some embodiments, as little as 1.0). In certain embodiments, it can be particularly advantageous if the aerogel/foam material combination exhibits an average dielectric constant over the range of 0-50 GHz of less than or equal to 1.4. In certain embodiments, the material combination exhibits an average loss tangent over the range of 0-50 GHz of less than or equal to 1, less than or equal to 0.1, less than or equal to 0.01, less than or equal to 0.001, or less than or equal to 0.0001. In certain embodiments, it can be particularly advantageous if the aerogel/foam material combination exhibits an average loss tangent over the range of 0-50 GHz of less than or equal to 0.01. In some embodiments, the aerogel/foam material combination exhibits any of these properties after being subjected to a standard heating cycle in which the elevated temperature is 200° C. (or 250° C., 300° C., or 350° C.).

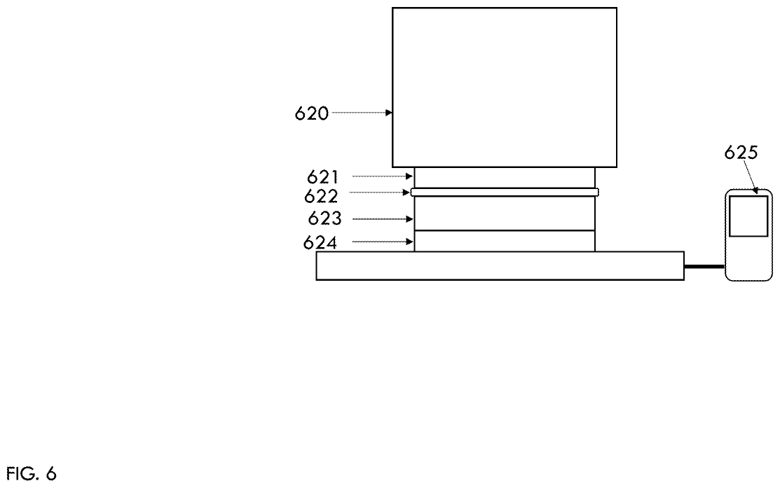

In some embodiments, the aerogel/foam material combination has a relatively low thermal conductivity. Thermal conductivity of an aerogel/foam material combination may be measured using a calibrated hot plate (CHP) device. FIG. 6 schematically illustrates a CHP device. In the figure, an aerogel/foam material combination 622 is placed between a hot surface 621 and cold surface 624. A reference material 623 is adjacent to the aerogel/foam material combination 622, and a heating element 620 can provide heat to the device. A processor 625 can collect heat and/or temperature data from the device in order to determine the thermal conductivity of the aerogel/foam material combination. More details regarding this measurement technique are described below.

The CHP method is based on the principle underlying standard ASTM E1225 “Standard Test Method for Thermal Conductivity of Solids by Means of the Guarded-Comparative-Longitudinal Heat Flow Technique.” An apparatus in which an aerogel/foam material combination and/or other sample material (the mass, thickness, length, and width of which have been measured as explained in the procedure for measuring bulk density) is placed in series with a standard reference material (e.g., NIST SRM 1453 EPS board) of precisely known thermal conductivity, density, and thickness, between a hot surface and a cold surface. The hot side of the system comprises an aluminum block (4″×4″×1″) with three cartridge heaters embedded in it. The cartridge heaters are controlled by a temperature controller operating in on/off mode. The set-point feedback temperature for the controller is measured at the center of the top surface of the aluminum block (at the interface between the block and the sample material) by a type-K thermocouple (referred to as TC_H). A second identical thermocouple is placed directly beside this thermocouple (referred to as TC_1). The sample material is placed on top of the aluminum block, such that the thermocouples are near its center. A third identical thermocouple (TC_2) is placed directly above the others at the interface between the sample material and the reference material. The reference material is then placed on top of the sample material covering the thermocouple. A fourth identical thermocouple (TC_3) is placed on top of the reference material, in line with the other three thermocouples. Atop this stack of materials, a 6″ diameter stainless steel cup filled with ice water is placed, providing an isothermal cold surface. Power is supplied to the heaters and regulated by the temperature controller such that the hot side of the system is kept at a constant temperature of approximately 37.5° C. After ensuring all components are properly in place, the system is turned on and allowed to reach a state of equilibrium. At that time, temperatures at TC_1, TC_2, and TC_3 are recorded. This recording is repeated every 15 minutes for at least one hour. From each set of temperature measurements (one set being the three temperatures measured at the same time), the unknown thermal conductivity can be calculated as follows. By assuming one-dimensional conduction (i.e., neglecting edge losses and conduction perpendicular to the line on which TC_1. TC_2, and TC_3 sit) one can state that the heat flux through each material is defined by the difference in temperature across that material divided by the thermal resistance per unit area of the material (where thermal resistance per unit area is defined by R″=t/k, where t is thickness in meters and k is thermal conductivity in W/m·K). The thickness, t, is measured while subjecting the sample material to a pressure equal to that which is experienced by the sample material during the CHP thermal conductivity test. For example, thickness of a sample material may be measured by sandwiching the sample material between a fixed rigid surface and a moveable rigid plate, parallel to the rigid surface, and applying a known pressure to the material sample by applying a known force to the rigid plate. Using any suitable means, for example a dial indicator or depth gauge, the thickness of this stack of materials, t_1, may be measured. The material sample is then removed from this stack of materials and the thickness, t_2, of the rigid plate is measured under the same force as previously prescribed. The thickness of the material sample under the prescribed pressure can thus be calculated by subtracting t_2 from t_1. The preferred range of material sample thickness for use in this thermal conductivity measurement is between 2 and 10 mm. Using material sample thicknesses outside of this range may introduce a level of uncertainty and/or error into the thermal conductivity calculation such that the measured values are no longer accurate and/or reliable. By setting the heat flux through the sample material equal to the heat flux through the reference material, the thermal conductivity of the sample material can be solved for (the only unknown in the equation). This calculation is performed for each temperature set, and the mean value is reported as the sample thermal conductivity. The thermocouples used can be individually calibrated against a platinum RTD, and assigned unique corrections for zero-offset and slope, such that the measurement uncertainty is ±0.25° C. rather than ±2.2° C.

In certain embodiments, the thermal conductivity at 25° C. of the aerogel/foam material combination, as measured by the CHP method (described above), may be less than or equal to 100 mW/m·K, less than or equal to 75 mW/m·K, less than or equal to 50 mW/m·K, less than or equal to 35 mW/m·K, less than or equal to 25 mW/m·K, less than or equal to 23 mW/m·K, less than or equal to 20 mW/m·K, less than or equal to 15 mW/m·K or less than or equal to 12 mW/m·K. and/or greater than or equal to 0.1 mW/m·K, greater than or equal to 1 mW/m·K, greater than or equal to 2 mW/m·K, greater than or equal to 5 mW/m·K, or greater than or equal to 15 mW/m·K. In some embodiments, it can be particularly advantageous if the aerogel/foam material combination exhibits a thermal conductivity of less than or equal to 30 mW/m·K, or less than or equal to 25 mW/m·K at 25° C. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination exhibits a lower thermal conductivity than the polymer aerogel (e.g., polyimide aerogel) when measured separately from the melamine-formaldehyde foam. In certain embodiments, the aerogel/foam material combination exhibits a lower thermal conductivity than the melamine-formaldehyde foam when measured separately from the polymer aerogel (e.g., polyimide aerogel). In some embodiments, the aerogel/foam material combination exhibits a thermal conductivity that is at least 1%, at least 2%, at least 5%, at least 10%, at least 15%, at least 20%, at least 25%, at least 30%, at least 35%, at least 40%, at least 45%, at least 50%, at least 55%, or at least 60% lower than the thermal conductivity of the polymer aerogel when measured separately from the melamine-formaldehyde foam; and the aerogel/foam material combination exhibits a thermal conductivity that is at least 1%, at least 2%, at least 5%, at least 10%, at least 15%, at least 20%, at least 25%, at least 30%, at least 35%, at least 40%, at least 45%, at least 50%, at least 55%, or at least 60% lower (and/or, in some embodiments, as much as 80% lower, 90% lower, or lower) than the thermal conductivity of the melamine-formaldehyde foam when measured separately from the polymer aerogel. In some embodiments, it can be particularly advantageous if the aerogel/foam material combination exhibits a thermal conductivity that is at least 10% lower than the thermal conductivity of the polymer aerogel when measured separately from the melamine-formaldehyde foam; and the aerogel/foam material combination exhibits a thermal conductivity that is at least 10% lower than the thermal conductivity of the melamine-formaldehyde foam when measured separately from the polymer aerogel. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination exhibits a reduction in thermal conductivity of greater than or equal to 1%, greater than or equal to 2%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, or greater than or equal to 60% (and/or, in some embodiments, as much as 80%, 90%, or more) relative to the lower of the thermal conductivity of the melamine-formaldehyde foam when measured separately from the polymer aerogel and the thermal conductivity of the polymer aerogel when measured separately from the melamine-formaldehyde foam. In some embodiments, it can be particularly advantageous if the aerogel/foam material combination exhibits a reduction in thermal conductivity of greater than or equal to 10% relative to the lower of the thermal conductivity of the melamine-formaldehyde foam when measured separately from the polymer aerogel and the thermal conductivity of the polymer aerogel when measured separately from the melamine-formaldehyde foam. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination can exhibit a relatively high acoustic attenuation. Acoustic attenuation of the aerogel/foam material combination can be expressed in terms sound transmission loss. The term sound transmission loss is defined in standard ASTM C634. In certain embodiments, the aerogel/foam material combination exhibits a sound transmission loss of greater than or equal to 1 dB/cm, greater than or equal to 5 dB/cm, greater than or equal to 10 dB/cm, greater than or equal to 11 dB/cm, greater than or equal to 12 dB/cm, greater than or equal to 13 dB/cm, greater than or equal to 14 dB/cm, greater than or equal to 15 dB/cm, greater than or equal to 16 dB/cm, greater than or equal to 17 dB/cm, greater than or equal to dB/cm, greater than or equal to 18 dB/cm, greater than or equal to 19 dB/cm, greater than or equal to 20 dB/cm, greater than or equal to 30 dB/cm, greater than or equal to 40 dB/cm, and/or greater than or equal to 50 dB/cm (and/or, as much as 80 dB/cm, as much as 100 dB/cm, or more) when measured according to standard ASTM E2611. In certain embodiments, the aerogel/foam material combination exhibits sound transmission loss of greater than or equal to 1 dB/cm, greater than or equal to 5 dB/cm, greater than or equal to 10 dB/cm, greater than or equal to 11 dB/cm, greater than or equal to 12 dB/cm, greater than or equal to 13 dB/cm, greater than or equal to 14 dB/cm, greater than or equal to 15 dB/cm, greater than or equal to 16 dB/cm, greater than or equal to 17 dB/cm, greater than or equal to dB/cm, greater than or equal to 18 dB/cm, greater than or equal to 19 dB/cm, greater than or equal to 20 dB/cm, greater than or equal to 30 dB/cm, greater than or equal to 40 dB/cm, and/or greater than or equal to 50 dB/cm (and/or, as much as 80 dB/cm, as much as 100 dB/cm, or more) when measured according to standard ASTM E90. In some embodiments, it can be particularly advantageous if the aerogel/foam material combination exhibits an average sound transmission loss over the frequency range of 300 Hz-2000 Hz greater than or equal to 5 dB/cm. In some embodiments, the aerogel/foam material combination exhibits any of these properties after being subjected to a standard heating cycle in which the elevated temperature is 200° C. (or 250° C., 300° C., or 350° C.).

In some embodiments, the aerogel/foam material combination has at least one dimension that is greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 10 cm, greater than or equal to 30 cm, greater than or equal to 50 cm, and/or greater than or equal to 100 cm (and/or, in some embodiments, as much as 1 meter, as much as 25 meters, as much as 100 meters, as much as 1000 meters, or more). In some embodiments, it can be particularly advantageous if the aerogel/foam material combination has at least one dimension greater than or equal to 30 cm. In some embodiments, this dimension is a first dimension.

In some embodiments, the aerogel/foam material combination has a second dimension (different from and perpendicular to the first dimension) that is greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 10 cm, greater than or equal to 30 cm, greater than or equal to 50 cm, and/or greater than or equal to 100 cm (and/or, in some embodiments, as much as 1 meter, as much as 25 meters, as much as 50 meters, or more). In some embodiments, it can be particularly advantageous if the second dimension of the aerogel/foam material combination is greater than or equal to 1 foot.

In some embodiments, the aerogel/foam material combination has a third dimension (different from and perpendicular to the first dimension and to the second dimension) that is greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 10 cm, greater than or equal to 30 cm, greater than or equal to 50 cm, and/or greater than or equal to 100 cm (and/or, in some embodiments, as much as 1 meter, as much as 25 meters, as much as 50 meters, or more). In some embodiments, it can be particularly advantageous if the third dimension of the aerogel/foam material combination is greater than or equal to 1 foot.

As would be understood by those of ordinary skill in the art, the length of a particular dimension of an article (e.g., an aerogel/foam material combination) corresponds to the distance between the exterior boundaries of that article along that dimension. As also would be understood by those of ordinary skill in the art, when measuring three dimensions of an article, each dimension would be perpendicular to the other two (such that the second dimension would be perpendicular to the first dimension, and the third dimension would be perpendicular to the first and second dimensions).

In some embodiments, the aerogel/foam material combination comprises an infrared (IR) opacifier. The IR opacifier can be added, for example, before, during, or after the gelation of the gel/foam material combination and/or before, during, or after the formation of the aerogel/foam material combination.

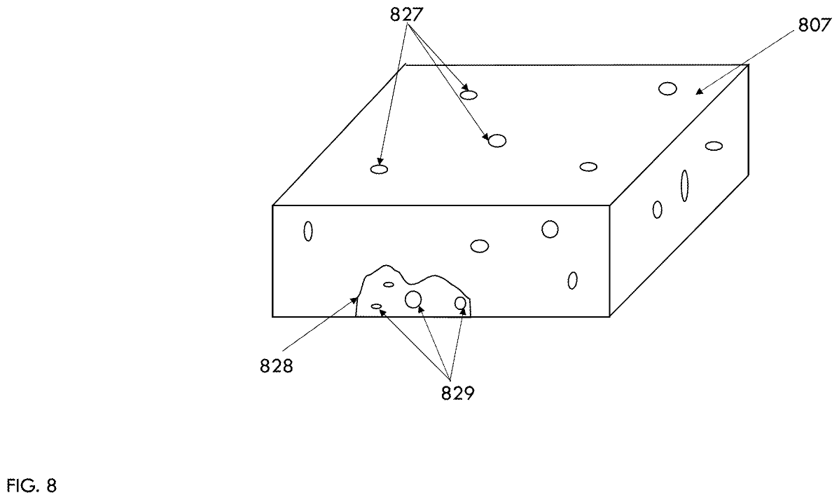

Any of a variety of materials can be used in the IR opacifier. In some embodiments, the IR opacifier comprises a metal (e.g., magnesium, zinc, antimony, and/or combinations of these or other metals such as a magnesium-zinc blends and/or a magnesium-zinc-antimony blends), a metal carbide (e.g., titanium carbide), a metalloid carbide (e.g., silicon carbide), a metal oxide (e.g., an iron oxide, a titanium oxide, a zinc oxide, an aluminum oxide, and/or an antimony oxide), a metalloid oxide (e.g., a silicon oxide), graphitic carbon (e.g., graphite, graphene, carbon nanotubes, and/or fullerenes), elemental carbon (e.g., carbon black), amorphous carbon (e.g., carbon made from a polymer aerogel), a phosphate, a borate, a metal silicate, a metalloid silicate, a metallocene, a molybdate, a stannate, a hydroxide, and/or a carbonate. In some embodiments, the IR opacifier is a particulate material with a measurable maximum cross-sectional dimension. For example, FIG. 8 schematically illustrates a foam/aerogel material combination comprising a particulate material. In the figure, a foam/aerogel material combination 807 includes a particulate material 827. The particulate material can be at the surface of the aerogel/foam material combination and/or within the bulk of the aerogel/foam material combination. For example, in FIG. 8, 828 shows the border of a volume of aerogel/foam material combination that has been cut out, and particulate material 829 is present within the bulk of the aerogel/foam material combination.

The average maximum cross-sectional dimension is taken as a number average and can be measured using microscopy. In some embodiments, the average maximum cross-sectional dimension of the IR opacifier can be determined by placing a representative sample of the IR opacifier on a slide or other suitable analysis substrate, imaging the particles (e.g., using image capture hardware and software to capture an image of the IR opacifier sample under proper magnification), and then determining the largest cross-sectional dimension of each particle (e.g., using an image processing software to find the maximum cross-sectional dimensions of each discrete particle present in the sample). Suitable magnification devices include an optical microscope or a scanning electron microscope (SEM). The maximum cross-sectional dimensions of all discrete particles are then averaged to determine the average maximum cross-sectional dimension of the sample. In some embodiments, the average maximum cross-sectional dimension of the IR opacifier is greater than or equal to 50 nanometers and less than or equal to 1 centimeter. In some embodiments, the average maximum cross-sectional dimension of IR opacifier is greater than or equal to 50 nm, greater than or equal to 100 nm, greater than or equal to 250 nm, greater than or equal to 500 nm, greater than or equal to 1 micrometer, greater than or equal to 10 micrometers, greater than or equal to 25 micrometers, greater than or equal to 50 micrometers, greater than or equal to 100 micrometers, greater than or equal to 250 micrometers, greater than or equal to 500 micrometers, greater than or equal to 1 millimeter, and/or less than or equal to 1 centimeter, less than or equal to 5 millimeters, less than or equal to 1 millimeter, less than or equal to 100 micrometers, less than or equal to 50 micrometers, or less than or equal to 5 micrometers. In certain embodiments, it can be particularly advantageous if the maximum cross-sectional dimension of the IR opacifier is greater than or equal to 1 micrometer less than or equal to 5 micrometers.

In some embodiments, the aerogel/foam material combination may be carbonizable. In some embodiments, a carbonized derivative of the aerogel/foam material combination may be produced. In some embodiments, the carbonized derivative of the aerogel/foam material combination may by produced via pyrolysis. In some embodiments, the carbonized derivative is fibrillar.

In some embodiments, the aerogel/foam material combination further comprises silica aerogel. In some embodiments, the aerogel/foam material combination further comprises trimethylsilyl-functionalized silica aerogel. In some embodiments, the aerogel/foam material combination further comprises trimethylsilyl-functionalized silica aerogel comprising sodium ions. In some embodiments, the aerogel/foam material combination comprises discrete particles of silica aerogel. In some embodiments, the aerogel/foam material combination comprises discrete particles of trimethylsilyl functionalized silica aerogel. In some embodiments, the aerogel/foam material combination comprises silica in an amount of at least 0.001 wt %, at least 0.01 wt %, at least 0.1 wt %, and/or less than or equal to 25 wt %, less than or equal to 20 wt %, less than or equal to 15 wt %, less than or equal to 10 wt %, or less than or equal to 5 wt % relative to the mass of the aerogel/foam material combination. In some embodiments, the addition of silica aerogel particles increases the hydrophobicity of the aerogel/foam material combination. Without wishing to be bound to any particular theory, it is believed that the addition of trimethylsilyl functionalized silica aerogel comprising sodium ions to the polymer aerogel may increase the resistance of the polymer aerogel to absorbing liquid comprising a surfactant. In some embodiments, increased resistance of the polymer aerogel to absorbing liquid comprising a surfactant may result in a polymer aerogel that can undergo laundering without significant increase in density, reduction in pore size, and/or change in internal surface area following laundering.

The aerogel material within the aerogel/foam material combination can have any of a variety of suitable properties. Polyimide aerogels may, in certain instances, be particularly useful, as they often exhibit one or more materials properties of particular value to engineering applications.

Generally speaking, aerogels are dry, highly porous, solid-phase materials that may exhibit a diverse array of extreme and valuable materials properties, e.g., low density, low thermal conductivity, high density-normalized strength and stiffness, and/or high specific internal surface area. In some embodiments, the pores within an aerogel material are less than or equal to 100 nm in diameter, while in some embodiments, the diameter of the pores within an aerogel material fall between 2-50 nm in diameter, i.e., the aerogel is mesoporous. In some embodiments, aerogels may contain pores with diameters greater than 100 nm, and in some embodiments, aerogels may even contain pores with diameters of several microns. In some embodiments, at least 50%, at least 60%, at least 70%, at least 80%, at least 90%, at least 95%, at least 99%, or more of the pore volume is made up of pores having diameters of less than or equal to 100 nm. In some embodiments, at least 50%, at least 60%, at least 70%, at least 80%, at least 90%, at least 95%, at least 99%, or more of the pore volume is made up of pores having diameters of less than or equal to 50 nm. In some embodiments, it can be particularly advantageous if at least 50%, at least 60%, at least 70%, at least 80%, at least 90%, at least 95%, at least 99%, or more of the pore volume is made up of pores having diameters of less than or equal to 25 nm. In some embodiments, an aerogel may contain a monomodal distribution of pores, a bimodal distribution of pores, or a polymodal distribution of pores.

In some embodiments, the polymer aerogel is hydrophobic.

In some embodiments, the liquid water uptake of the aerogel may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel before contact with liquid water when measured according to standard ASTM C1511. In some embodiments, the aerogel exhibits any of these properties after being subjected to a standard heating cycle in which the elevated temperature is 200° C. (or 250° C. 300° C., or 350° C.).

In some embodiments, the liquid water uptake of the aerogel may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel before contact with liquid water when measured according to standard ASTM C1763. In some embodiments, the aerogel exhibits any of these properties after being subjected to a standard heating cycle in which the elevated temperature is 200° C. (or 250° C. 300° C., or 350° C.).

In some embodiments, the liquid water uptake of the aerogel may be less than or equal to 200 wt %, less than or equal to 150 wt %, less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel before contact with liquid water when measured according to standard EN 1609. In some embodiments, the aerogel exhibits any of these properties after being subjected to a standard heating cycle in which the elevated temperature is 200° C. (or 250° C. 300° C., or 350° C.).

In some embodiments, the water vapor uptake of the aerogel may be less than or equal to 100 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 4 wt %, less than or equal to 3 wt %, less than or equal to 2 wt %, less than or equal to 1 wt %, or less than or equal to 0.1 wt % (and/or, in some embodiments, as little as 0.01 wt %, as little as 0.001 wt %, as little as 0.0001 wt %, or less) relative to the weight of the aerogel before exposure to water vapor, when measured according to standard ASTM C1104. In some embodiments, the aerogel exhibits any of these properties after being subjected to a standard heating cycle in which the elevated temperature is 200° C. (or 250° C., 300° C., or 350° C.).

In some embodiments, the water contact angle of the aerogel may be greater than 90°, greater than 100°, greater than 110°, greater than 120°, greater than 130°, greater than 140°, greater than 150°, greater than 160°, greater than 170° (and/or, in some embodiments, up to 175°, up to 178°, up to 179°, up to 179.9°, or greater) when measured according to standard ASTM D7490. In some embodiments, particularly advantageous aerogels exhibit a contact angle with water, in an ambient air environment at 1 atm and 25° C., of greater than 90°, greater than 100°, greater than 110°, greater than 120°, greater than 130°, greater than 140°, greater than 150°, greater than 160°, greater than 170° (and/or, in some embodiments, up to 175°, up to 178°, up to 179°, up to 179.9°, or greater) when measured according to standard ASTM D7490. In some embodiments, the aerogel exhibits any of these properties after being subjected to a standard heating cycle in which the elevated temperature is 200° C. (or 250° C., 300° C., or 350° C.).

In accordance with certain embodiments, the hydrophobic aerogel does not contain any fluorine or contains only a limited amount of fluorine (e.g., the amount of fluorine in the aerogel is 0-0.1 wt %, 0-0.01 wt %, or 0-0.001 wt %).

In some embodiments, the polymer aerogel is surfactant resistant. In some embodiments, the polymer aerogel is launderable. In some embodiments, the polymer aerogel has a relatively low detergent uptake. Detergent uptake can be determined according to the following test. 0.97 g of sodium dodecyl sulfate is added to 1 liter of analytical reagent grade deionized (DI) water and dissolved to make a detergent solution. 50 mL of the detergent solution is added to a 1.5-inch tall by 3-inch wide cylindrical vial. A sample of the aerogel that is 1 cm×1 cm×2 mm is prepared and added to the vial. Wire mesh is press fit into the vial such that the sample remains totally submerged for 24 hours at 20° C. The sample is then removed from the detergent solution, and the surface liquid is mechanically removed. The sample is then weighed. The difference in mass between the sample after the test and before the test is the detergent uptake, and it is generally expressed as a percentage increase in mass relative to the original mass of the sample. In some embodiments, the polymer aerogel exhibits a detergent uptake, according to this test, of less than or equal to 300%, less than or equal to 200%, less than or equal to 100%, less than or equal to 50%, less than or equal to 10%, less than or equal to 5%, less than or equal to 1% (and/or, as little as 0.1%, at little as 0.01%, as little as 0.001%, or less).

In some embodiments, the bulk density of the polymer aerogel (e.g., the polyimide aerogel) may be greater than or equal to 0.01 g/cc, greater than or equal to 0.05 g/cc, greater than or equal to 0.1 g/cc, greater than or equal to 0.2 g/cc, greater than or equal to 0.3 g/cc, greater than or equal to 0.4 g/cc, greater than or equal to 0.5 g/cc, greater than or equal to 0.6 g/cc, greater than or equal to 0.7 g/cc, or less than or equal to 0.8 g/cc. In certain embodiments, the bulk density of the polyimide aerogel may be between 0.01 g/cc and 0.8 g/cc. In some embodiments, it can be particularly advantageous if the polyimide aerogel exhibits a bulk density of greater than or equal to 0.01 g/cc and less than or equal to 0.5 g/cc when isolated from the melamine-formaldehyde foam.

The aerogel may exhibit any of a variety of suitable skeletal densities. In some embodiments, the skeletal density of the aerogel is greater than or equal to 1 g/cc, greater than or equal to 1.2 g/cc, greater than or equal to 1.3 g/cc, greater than or equal to 1.4 g/cc, greater than or equal to 1.5 g/cc, greater than or equal to 1.6 g/cc, greater than or equal to 1.7 g/cc, greater than or equal to 1.8 g/cc, greater than or equal to 1.9 g/cc, greater than or equal to 2.0 g/cc, greater than or equal to 2.1 g/cc, greater than or equal to 2.2 g/cc, greater than or equal to 2.3 g/cc, greater than or equal to 2.4 g/cc, greater than or equal to 2.5 g/cc, greater than or equal to 3 g/cc, greater than or equal to 4 g/cc (and/or, in some embodiments, less than or equal to 5 g/cc, less than or equal to 4.5 g/cc, less than or equal to 4 g/cc, less than or equal to 3.5 g/cc, less than or equal to 3 g/cc, less than or equal to 2.5 g/cc, less than or equal to 2 g/cc, less than or equal to 1.5 g/cc, less than or equal to 1.4 g/cc, less than or equal to 1.3 g/cc). In some embodiments, the aerogel exhibits any of these properties after being subjected to a standard heating cycle in which the elevated temperature is 200° C. (or 250° C., 300° C., or 350° C.).

In certain embodiments, the thermal conductivity at 25° C. of the aerogel, as measured by the CHP method (described above), may be less than or equal to 100 mW/m·K, less than or equal to 75 mW/m·K, less than or equal to 50 mW/m·K, less than or equal to 35 mW/m·K, less than or equal to 25 mW/m·K, less than or equal to 23 mW/m·K, less than or equal to 20 mW/m·K, less than or equal to 15 mW/m·K or less than or equal to 12 mW/m·K, and/or greater than or equal to 0.1 mW/m·K, greater than or equal to 1 mW/m·K, greater than or equal to 2 mW/m·K, greater than or equal to 5 mW/m·K, or greater than or equal to 15 mW/m·K. In some embodiments, it can be particularly advantageous if the aerogel exhibits a thermal conductivity of less than or equal to 30 mW/m·K. or less than or equal to 25 mW/m·K at 25° C. In some embodiments, the aerogel exhibits any of these properties after being subjected to a standard heating cycle in which the elevated temperature is 200° C. (or 250° C., 300° C., or 350° C.).

In some embodiments, the BET surface area of the aerogel is greater than or equal to 5 m²/g, greater than or equal to 50 m²/g, greater than or equal to 100 m²/g, greater than or equal to 200 m²/g, greater than or equal to 300 m²/g, greater than or equal to 400 m²/g, greater than or equal to 500 m²/g, greater than or equal to 600 m²/g, greater than or equal to 700 m²/g, greater than or equal to 800 m²/g, greater than or equal to 1000 m²/g, greater than or equal to 2000 m²/g, greater than or equal to 3000 m²/g, and/or less than or equal to 1500 m²/g, or less than or equal to 4000 m²/g. In some embodiments, the BET surface area of the aerogel is greater than or equal to 5 m²/g and less than or equal to 4000 m²/g. In some embodiments, the aerogel exhibits any of these properties after being subjected to a standard heating cycle in which the elevated temperature is 200° C. (or 250° C., 300° C., or 350° C.).

The aerogel may exhibit any of a variety of suitable pore structures. In some embodiments, the aerogel comprises pores of less than or equal to 100 microns, less than or equal to 10 microns, less than or equal to 1 micron, less than or equal to 500 nm, less than or equal to 250 nm, less than or equal to 100 nm, less than or equal to 50 nm, less than or equal to 25 nm, less than or equal to 20 nm, less than or equal to 15 nm, and/or less than or equal to 10 nm. In some embodiments the aerogel comprises pores of greater than or equal to 10 nm, greater than or equal to 15 nm, greater than or equal to 20 nm, greater than or equal to 25 nm, greater than or equal to 50 nm, greater than or equal to 100 nm, greater than or equal to 250 nm, greater than or equal to 500 nm, greater than or equal to 1 micron, greater than or equal to 10 microns, and or greater than or equal to 100 microns. In some embodiments, the average pore width of the aerogel is less than or equal to 10 nm, less than or equal to 20 nm, less than or equal to 30 nm, less than or equal to 40 nm, less than or equal to 50 nm, less than or equal to 60 nm, less than or equal to 70 nm, less than or equal to 80 nm, less than or equal to 90 nm, less than or equal to 100 nm, less than or equal to 500 nm, less than or equal to 1 μm, less than or equal to 10 μm, less than or equal to 100 μm, or less than or equal to 1 mm. In some embodiments, the aerogel exhibits a BJH mean pore diameter greater than or equal to 2 nm and less than or equal to 50 nm when measured using nitrogen sorptimetry. In some embodiments, the aerogel exhibits a BJH mean pore diameter of greater than or equal to 10 nm and less than or equal to 25 nm when measured using nitrogen sorptimetry. In some embodiments, the aerogel exhibits any of these properties after being subjected to a standard heating cycle in which the elevated temperature is 200° C. (or 250° C., 300° C., or 350° C.).

In some embodiments, the pore width distribution of the aerogel may be unimodal (i.e., exhibiting a single maximum). In some embodiments, the pore width distribution maximum is found at less than or equal to 10 nm, less than or equal to 20 nm, less than or equal to 30 nm, less than or equal to 40 nm, less than or equal to 50 nm, less than or equal to 60 nm, less than or equal to 70 nm, less than or equal to 80 nm, less than or equal to 90 nm, less than or equal to 100 nm, less than or equal to 500 nm, less than or equal to 1 μm, less than or equal to 10 μm, less than or equal to 100 μm, or less than or equal to 1 mm. In some embodiments, the aerogel comprises a unimodal pore size distribution. In some embodiments, the aerogel exhibits any of these properties after being subjected to a standard heating cycle in which the elevated temperature is 200° C. (or 250° C. 300° C., or 350° C.).

In some embodiments, the pore width distribution of the aerogel may be bimodal, or at least bimodal. In some embodiments, the aerogel can have two distinct populations of pores, one with an average pore size less than or equal to a certain critical pore width, and one with an average pore size greater than some critical pore width. In some embodiments, the critical pore width is less than or equal to 10 nm, less than or equal to 20 nm, less than or equal to 30 nm, less than or equal to 40 nm, less than or equal to 50 nm, less than or equal to 60 nm, less than or equal to 70 nm, less than or equal to 80 nm, less than or equal to 90 nm, less than or equal to 100 nm, less than or equal to 500 nm, less than or equal to 1 μm, less than or equal to 10 μm, less than or equal to 100 μm, or less than or equal to 1 mm. In some embodiments, the aerogel comprises a bimodal pore size distribution. In some embodiments, the aerogel exhibits any of these properties after being subjected to a standard heating cycle in which the elevated temperature is 200° C. (or 250° C., 300° C., or 350° C.).

In some embodiments, the aerogel exhibits a BJH pore volume of greater than or equal to 0.05 cm³/g and less than or equal to 5 cm³/g. In some embodiments, the aerogel exhibits a BJH pore volume of greater than or equal to 0.05 g/cm³, greater than or equal to 1 g/cm³, greater than or equal to 2 g/cm³, greater than or equal to 3 g/cm³, greater than or equal to 4 g/cm³, and/or less than or equal to 5 g/cm³. In some embodiments, the aerogel exhibits any of these properties after being subjected to a standard heating cycle in which the elevated temperature is 200° C. (or 250° C., 300° C., or 350° C.).

In some embodiments, the aerogel may exhibit an internal specific surface area. In some embodiments, the BET surface area of the aerogel is greater than or equal to 5 m²/g, greater than or equal to 50 m²/g, greater than or equal to 100 m²/g, greater than or equal to 200 m²/g, greater than or equal to 300 m²/g, greater than or equal to 400 m²/g, greater than or equal to 500 m²/g, greater than or equal to 600 m²/g, greater than or equal to 700 m²/g, greater than or equal to 800 m²/g, greater than or equal to 1000 m²/g, greater than or equal to 2000 m²/g, greater than or equal to 3000 m²/g, and/or less than or equal to 1500 m²/g, or less than or equal to 4000 m²/g. In some embodiments, the BET surface area of the aerogel is greater than or equal to 5 m²/g and less than or equal to 4000 m²/g. In some embodiments, it can be particularly advantageous if the aerogel exhibits a BET surface area of greater than or equal to 100 m²/g and less than or equal to 800 m²/g. Values of the BET surface area of the aerogel outside of these ranges may be possible. In certain embodiments, it can be particularly advantageous if the aerogel exhibits a BET surface area of greater than or equal to 200 m²/g and less than or equal to 400 m²/g. In some embodiments, the aerogel exhibits any of these properties after being subjected to a standard heating cycle in which the elevated temperature is 200° C. (or 250° C., 300° C., or 350° C.).

In certain embodiments, the compressive modulus of the aerogel is greater than or equal to 100 kPa, greater than or equal to 500 kPa, greater than or equal to 1 MPa, greater than or equal to 10 MPa, greater than or equal to 50 MPa, greater than or equal to 100 MPa, and/or less than or equal to 100 MPa, less than or equal to 50 MPa, less than or equal to 10 MPa, less than or equal to 1 MPa, less than or equal to 500 kPa, less than or equal to 100 kPa, or less than or equal to 50 kPa. Combinations of the above noted ranges, or values outside of these ranges, are possible for the compressive modulus of the aerogel. In some embodiments, it can be particularly advantageous if the aerogel exhibits a compressive modulus greater than or equal to 1 MPa. In some embodiments, the aerogel exhibits any of these properties after being subjected to a standard heating cycle in which the elevated temperature is 200° C. (or 250° C., 300° C., or 350° C.).

The aerogel may exhibit any of a variety of suitable compressive yield strengths. In certain embodiments, the compressive yield strength of the aerogel is greater than or equal to 40 kPa, greater than or equal to 100 kPa, greater than or equal to 500 kPa, greater than or equal to 1 MPa, greater than or equal to 5 MPa, greater than or equal to 10 MPa, greater than or equal to 50 MPa, greater than or equal to 100 MPa, greater than or equal to 500 MPa, and/or or less than or equal to 500 MPa, less than or equal to 100 MPa, less than or equal to 50 MPa, less than or equal to 10 MPa, less than or equal to 5 MPa, less than or equal to 1 MPa, less than or equal to 500 kPa, less than or equal to 100 kPa, or less than or equal to 50 kPa. Combinations of the above noted ranges, or values outside of these ranges, are possible for the compressive yield strength of the aerogel. In some embodiments, it can be particularly advantageous if the aerogel exhibits a compressive yield strength greater than or equal to 300 kPa. In some embodiments, the aerogel exhibits any of these properties after being subjected to a standard heating cycle in which the elevated temperature is 200° C. (or 250° C., 300° C., or 350° C.).

In certain embodiments, the flexural modulus of the aerogel, as measured by the methods described herein, may be at least 0.00689 MPa, at least 0.01 MPa, at least 0.02 MPa, at least 0.03 MPa, at least 0.04 MPa, at least 0.05 MPa, at least 0.06 MPa, at least 0.07 MPa, at least 0.08 MPa, at least 0.09 MPa, at least 0.1 MPa, at least 0.2 MPa, at least 0.3 MPa, at least 0.4 MPa, at least 0.5 MPa, at least 0.6 MPa, at least 0.7 MPa, at least 0.8 MPa, at least. 9 MPa, at least 1 MPa, at least 2 MPa, at least 5 MPa, at least 10 MPa, at least 20 MPa, at least 50 MPa, at least 100 MPa, at least 200 MPa, at least 300 MPa, and/or less than or equal to 1 GPa, less than or equal to 500 MPa, less than or equal to 300 MPa, less than or equal to 200 MPa, less than or equal to 100 MPa, less than or equal to 50 MPa, and/or less than or equal to 20 MPa. In some embodiments, it can be particularly advantageous if the aerogel exhibits a flexural modulus greater than or equal to 1 MPa. In some embodiments, the aerogel exhibits any of these properties after being subjected to a standard heating cycle in which the elevated temperature is 200° C. (or 250° C., 300° C., or 350° C.).

In some embodiments, the flexural strength of the aerogel is greater than or equal to 0.00689 MPa, at least 0.01 MPa, at least 0.02 MPa, at least 0.03 MPa, at least 0.04 MPa, at least 0.05 MPa, at least 0.06 MPa, at least 0.07 MPa, at least 0.08 MPa, at least 0.09 MPa, at least 0.1 MPa, at least 0.2 MPa, greater than or equal to 0.5 MPa, greater than or equal to 1 MPa, greater than or equal to 1.5 MPa, greater than or equal to 2 MPa, greater than or equal to 2.5 MPa, greater than or equal to 3 MPa, greater than or equal to 3.5 MPa, or greater than or equal to 4 MPa, at least 5 MPa, at least 10 MPa, at least 20 MPa, at least 50 MPa, at least 100 MPa, at least 200 MPa, at least 300 MPa, and/or less than or equal to 1 GPa. In some embodiments, it can be particularly advantageous if the aerogel exhibits a flexural strength greater than or equal to 0.5 MPa. In some embodiments, the aerogel exhibits any of these properties after being subjected to a standard heating cycle in which the elevated temperature is 200° C. (or 250° C., 300° C., or 350° C.).

In some embodiments, the aerogel of the aerogel/foam material combination comprises polymer aerogel. A polymer aerogel is an aerogel that is at least partially made out of polymeric material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of polymeric material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of organic polymer, i.e., a polymer having carbon atoms in its backbone.

In some embodiments, the aerogel of the aerogel/foam material combination comprises a polyimide aerogel. A polyimide aerogel is an aerogel that is at least partially made out of a polyimide material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of polyimide.

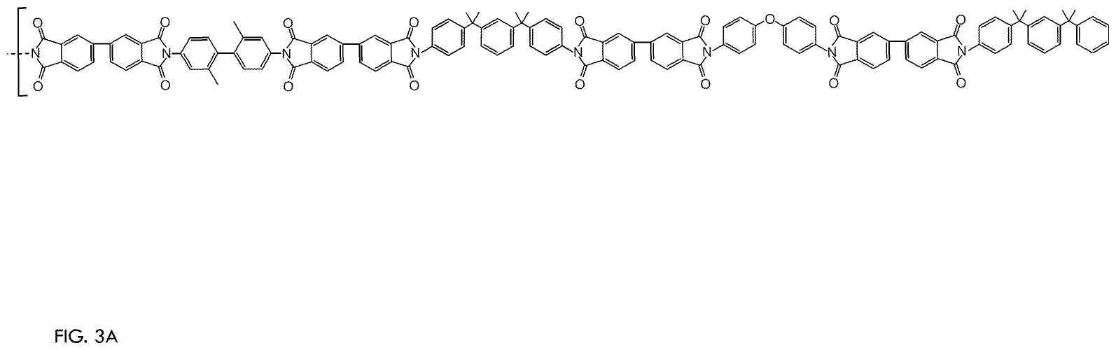

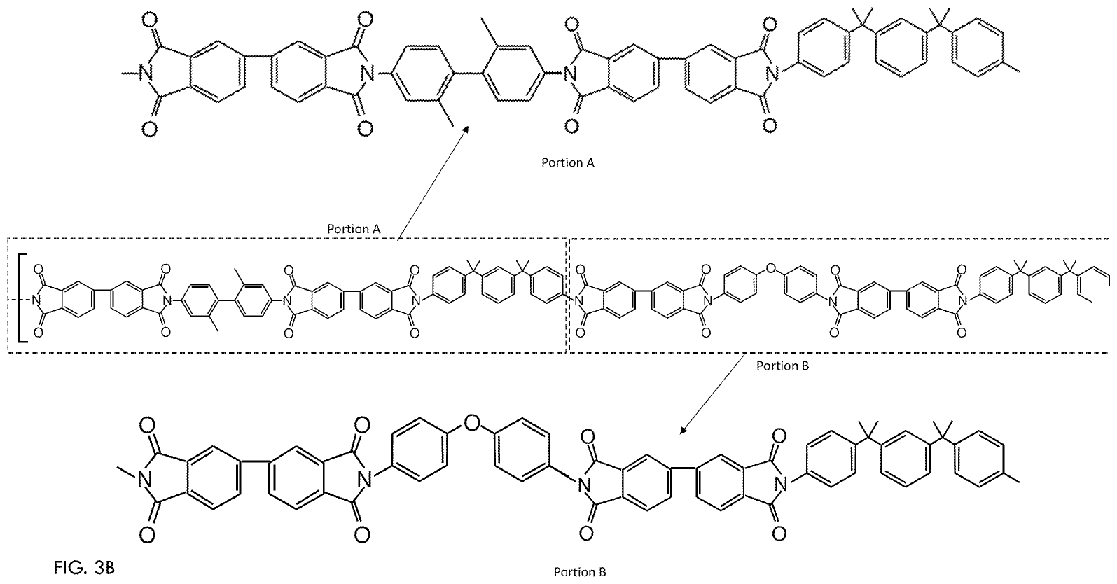

Aerogels comprising polyimides can potentially combine numerous valuable material properties into a single material envelope, including but not limited to high mass-normalized strength and stiffness properties, low density, low and constant dielectric constant and loss tangent over wide frequency range, low speed of sound, high sound transmission loss, low flammability or nonflammability, machinability, and low thermal conductivity. Potential applications of aerogels comprising polyimides include aircraft interior parts, e.g., wall panels, floorboards, cockpit doors, and galley furnishings; engine covers for automobiles; shockwave-reflecting and/or energy-absorbing materials in ballistics shields; insulative components for shoes, boots, and insoles; vibration and acoustic insulation for rocket fairings; low-k substrates for electronics and antennas; and other applications. Most commercial polyimide materials, e.g., thin films and bulk plastics, traditionally comprise hydrophilic polymers, i.e., they absorb and retain moisture and/or liquid water. Accordingly, most aerogels comprising polyimides are likewise hydrophilic. Many potential engineering applications for polyimide aerogels, however, require materials that can resist contact with liquid-phase and/or vapor-phase water without degrading, gaining significant weight, or losing performance. Thus, aerogels that comprise polyimides that simultaneously exhibit water-resistant properties are highly desirable for many applications. Thus, in some embodiments, the aerogel comprises a hydrophobic polyimide moiety. FIGS. 3A-3B schematically illustrate a hydrophobic polyimide moiety of an aerogel, which can be used in accordance with certain embodiments. The hydrophobic moiety may impart at least some hydrophobicity to the aerogel (or material combination comprising the aerogel).

In some embodiments, the polyimide aerogel comprises the following moiety

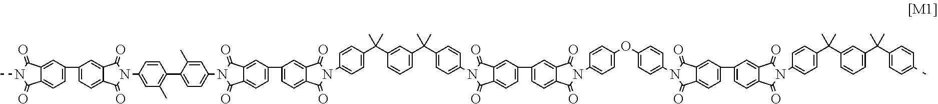

Moiety [M1] is also shown in FIGS. 3A-3B. The dashed lines represent points of attachment to other moieties. In some embodiments, the polyimide aerogel comprises repeating units of the moiety [M1]. In some embodiments the polyimide aerogel comprises at least 2, at least 3, at least 4, at least 5, at least 10, at least 15, at least 20, at least 30, at least 40, and/or at least 50 repeating units of moiety [M1]. In some embodiments, the aerogel comprises from 2 to 20 repeating units of the moiety [M1]. Moiety [M1] can make up, in some cases, at least 50 wt %, at least 60 wt %, at least 70 wt %, at least 80 wt %, at least 90 wt %, at least 95 wt %, and/or at least 99 wt % of the polymer in the aerogel. In some embodiments, at least 50 wt %, at least 60 wt %, at least 70 wt %, at least 80 wt %, at least 90 wt %, at least 95 wt %, and/or at least 99 wt % of the aerogel is made up of moiety [M1]. In some embodiments, it can be particularly advantageous if at least 90 wt % of the aerogel is made up of moiety [M1].

In some preferred embodiments, the moiety comprises a specific repeating octamer of the reaction product of four monomers, with the following sequence, appreciating that an imide group replaces amine and anhydrides from the monomers accordingly: biphenyl-3,3′,4,4′-tetracarboxylic dianhydride (BPDA), then 2,2′-dimethylbenzidine (DMBZ), then BPDA, then 4,4′-[1,3-phenylenebis(1-methyl-ethylidene)]bisaniline (bisaniline-m), then BPDA, then 4,4′-oxydianiline (ODA), then BPDA, then bisaniline-m. In some preferred embodiments, polyimide aerogels comprising this moiety exhibit excellent strength, stiffness, flexibility, machinability, low thermal conductivity, low flammability, and/or high water-resistance properties.

In some preferred embodiments, polyimide chains comprising moiety [M1] are connected to each other by a crosslinker. In some embodiments, the pattern of specifically alternating constituent monomers from which moiety [M1] is derived gives rise to hydrophobic and/or water-resistant properties of the polyimide aerogel. Without wishing to be bound to any particular theory, moiety [M1] may impart enhanced water-resistance properties to polyimide aerogels because of its high density of aryl, isopropylidene, and methyl groups, which are all hydrophobic groups, to counteract hydrophilicity inherent to the imide group. Without wishing to be bound by any particular theory, the inclusion of one unit of ODA, which comprises a flexible oxygen bridge, may impart flexibility into the moiety that provides for a polyimide aerogel with reduced fragility compared to a moiety that does not comprise a flexible oxygen bridge.

In some embodiments, the polyimide aerogel comprises one or more of the following moieties:

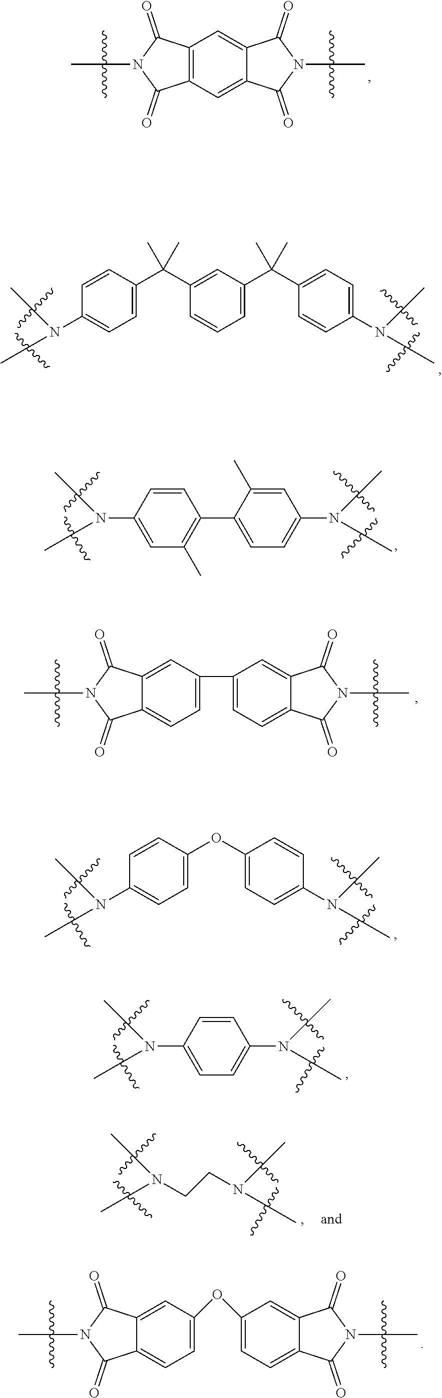

Polyimide aerogels can be made using any of a variety of methods.

In some embodiments, a polyimide gel suitable for production of a polyimide aerogel is prepared from the reaction of one or more amines with one or more anhydrides. In some embodiments, an amine may be a monoamine, a diamine, or a polyamine. In some embodiments, an anhydride may be a monoanhydride, a dianhydride, or a polyanhydride. In some embodiments, the amine and anhydride react to form a poly(amic acid) that is then imidized to form a polyimide. In certain embodiments, the poly(amic acid) is chemically imidized. In some embodiments, the poly(amic acid) is thermally imidized.

In some embodiments in which polyimide aerogel is formed, biphenyl-3,3′,4,4′-tetracarboxylic dianhydride (BPDA), 2,2′-dimethylbenzidine (DMBZ), and 4,4′-oxydianiline (4,4-ODA or ODA), are combined to form anhydride end-capped poly(amic acid) oligomers wherein the oligomer comprises a repeating unit of the reaction product of BPDA, ODA, and DMBZ, for example, a unit comprising the reaction product of BPDA-ODA-BPDA-DMBZ, and comprises terminal anhydride and/or amine groups, the oligomers having an average degree of polymerization (number of repeat units) of 10 to 50. In some embodiments, the oligomers are crosslinked via a crosslinking agent (also referred to as a crosslinker). In some embodiments, the crosslinking agent comprises three or more amine groups. In some embodiments, the crosslinking agent comprises a functional group that reacts with a terminal group on the oligomers to produce a crosslinking-agent-terminated oligomer. In some embodiments, the crosslinking agent comprises functional groups that react with another crosslinking agent molecule to connect crosslinking-agent-terminated oligomers together. In some embodiments, the crosslinking agent is introduced at a balanced stoichiometry of a functional group on the crosslinking agent that is reactive towards a terminal group on the polyimide oligomer to the complementary terminal groups on the polyimide oligomers. In some embodiments, chemical imidization is performed (e.g., via the additional of acetic anhydride (AA) to yield a porous, highly-crosslinked polyimide network. In some embodiments, two or more oligomers are attached to the same crosslinking agent. In some embodiments, the resulting network is chemically imidized to yield a porous crosslinked polyimide network. In some embodiments, the oligomers are imidized prior to crosslinking. In some embodiments, the oligomers are imidized concurrently with crosslinking.

In some embodiments in which polyimide aerogel is formed, the method comprises combining an amount of biphenyl-3,3′,4,4′-tetracarboxylic dianhydride (BPDA), a first diamine, and a solvent. The combination can be performed in any of a variety of ways. Some embodiments comprise first combining the BPDA and the solvent and subsequently adding the first diamine. Other embodiments comprise first combining the first diamine and the solvent and subsequently adding the BPDA. Still other embodiments comprise simultaneously combining the BPDA, the first diamine, and the solvent

In some embodiments in which polyimide aerogel is formed, combining the amount of BPDA, the first diamine, and the solvent is performed such that a first intermediate medium comprising anhydride-capped poly(amic acid) trimer is formed.

In some embodiments in which polyimide aerogel is formed, the method comprises combining the first intermediate medium and a second diamine. In some embodiments, combining the first intermediate medium and the second diamine is performed such that a second intermediate medium comprising pentamer is formed.

In some embodiments in which polyimide aerogel is formed, the method comprises combining the second intermediate medium and an additional amount of BPDA. In certain embodiments, combining the second intermediate and the additional amount of BPDA is performed such that a third intermediate comprising heptamer is formed.

In some embodiments in which polyimide aerogel is formed, the method comprises combining the third intermediate medium and a third diamine such that a fourth intermediate medium is formed. In certain embodiments, combining the third intermediate and third diamine is performed such that a fourth intermediate medium comprising oligomer chains is formed.

In some embodiments in which polyimide aerogel is formed, the method comprises combining the fourth intermediate medium and a crosslinking reagent. In some embodiments, combining the fourth intermediate medium and the crosslinking reagent is performed such that a gel is formed. In some embodiments, the crosslinking agent comprises three or more amine groups. In some embodiments, the crosslinking agent comprises a functional group that reacts with a terminal group on the oligomers to produce a crosslinking-agent-terminated oligomer. In some embodiments, the crosslinking agent comprises functional groups that react with another crosslinking agent molecule and/or another crosslinking-agent-terminated oligomer to connect crosslinking-agent-terminated oligomers together. In some embodiments, the crosslinking agent is introduced at a balanced stoichiometry of a functional group on the crosslinking agent that is reactive towards a terminal group on the polyimide oligomer to the complementary terminal groups on the polyimide oligomers. In some embodiments, two or more oligomers are attached to the same crosslinking agent. In some embodiments, the resulting network is chemically imidized to yield a porous crosslinked polyimide network. In some embodiments, the oligomers are imidized prior to crosslinking. In some embodiments, the oligomers are imidized concurrently with crosslinking.

In some embodiments in which polyimide aerogel is formed, the crosslinking agent comprises a triamine; an aliphatic triamine; an aromatic amine comprising three or more amine groups; an aromatic triamine; 1,3,5-tris(aminophenoxy)benzene (TAB); tris(4-aminophenyl) methane (TAPM); tris(4-aminophenyl)benzene (TAPB); tris(4-aminophenyl)amine (TAPA); 2,4,6-tris(4-aminophenyl)pyridine (TAPP); 4,4′,4″-methanetriyltrianiline; N,N,N′,N′-tetrakis(4-aminophenyl)-1,4-phenylenediamine; a polyoxypropylenetriamine; N′,N′-bis(4-aminophenyl)benzene-1,4-diamine; a triisocyanate; an aliphatic triisocyanate; an aromatic isocyanate comprising three or more isocyanate groups; an aromatic triisocyanate; a triisocyanate based on hexamethylene diisocyanate; the trimer of hexamethylenediisocyanate; hexamethylenediisocyanate; a polyisocyanate; a polyisocyanate comprising isocyanurate; Desmodur® N3200; Desmodur N3300; Desmodur N100; Desmodur N3400; Desmodur N3390; Desmodur N3390 BA/SN; Desmodur N3300 BA; Desmodur N3600; Desmodur N3790 BA; Desmodur N3800; Desmodur N3900; Desmodur XP 2675; Desmodur blulogiq 3190; Desmodur XP 2860; Desmodur N3400; Desmodur XP 2840; Desmodur N3580 BA; Desmodur N3500; Desmodur RE; tris(isocyanatophenyl) methane; Desmodur RC; Mondur® MR; Mondur MRS; a methylene diphenyl diisocyanate; diphenylmethane 2,2′-, 2,4′- and/or 4,4′-diisocyanate (MDI); naphthylene 1,5-diisocyanate (NDI); a toluene diisocyanate; toluene 2,4- and/or 2,6-diisocyanate (TDI); 3,3′-dimethylbiphenyl diisocyanate; 1,2-diphenylethane diisocyanate and/or p-phenylenediisocyanate (PPDI); trimethylene-, tetramethylene-, pentamethylene-, hexamethylene-, heptamethylene-, and/or octamethylenediisocyanate; 2-methylpentamethylene 1,5-diisocyanate; 2-ethylbutylene 1,4-diisocyanate; pentamethylene 1,5-diisocyanate; butylene 1,4-diisocyanate; 1-isocyanato-3,3,5-trimethyl-5-isocyanatomethylcyclohexane (isophoronediisocyanate, IPDI); 1,4- and/or 1,3-bis(isocyanatomethyl)cyclohexane (HXDI); cyclohexane 1,4-diisocyanate; 1-methylcyclohexane 2,4- and/or 2,6-diisocyanate; dicyclohexylmethane 4,4′-, 2,4′- and/or 2,2′-diisocyanate; octa (aminophenoxy) silsesquioxane (OAPS); 4,4-oxydianiline (ODA); (3-aminopropyl)triethoxysilane (APTES); modified graphene oxides (m-GO); 1,3,5-benzenetricarbonyl trichloride (BTC); poly(maleic anhydride) (PMA); an imidazole or a substituted imidazole; a triazole or substituted triazole; a purine or substituted purine; a pyrazole or substituted pyrazole; and/or melamine.

In some embodiments in which polyimide aerogel is formed, the crosslinker comprises an isocyanurate group, a silicon-oxygen bridge, a trisubstituted benzene ring, a silsesquioxane group, a phenoxy group, a tris(phenyl)methyl group, an imidazole group, and/or an alkyl group.

In some embodiments in which polyimide aerogel is formed, the first diamine is different from the second diamine and the third diamine. In certain embodiments, the second diamine is different from the third diamine.

In some embodiments in which polyimide aerogel is formed, the first diamine, the second diamine, and the third diamine are selected from the group consisting of 3,4′-oxydianiline (3,4-ODA); 4,4′-oxydianiline (4,4-ODA or ODA); p-phenylene diamine (pPDA); m-phenylene diamine (mPDA); p-phenylene diamine (mPDA); 2,2′-dimethylbenzidine (DMBZ); 4,4′-bis(4-aminophenoxy) biphenyl; 2,2′-bis[4-(4-aminophenoxyl)phenyl]propane; bisaniline-p-xylidene (BAX); 4,4′-methylene dianiline (MDA); 4,4′-[1,3-phenylenebis(1-methyl-ethylidene)]bisaniline (bisaniline-m); 4,4′-[1,4-phenylenebis(1-methyl-ethylidene)]bisaniline (bisaniline-p); 3,3′-dimethyl-4,4′-diaminobiphenyl (o-tolidine); 2,2-bis[4-(4-aminophenoxy)phenyl]propane (BAPP); 3,3′-dihydroxy-4,4′-diamino-biphenyl (HAB); 3,3′-diaminodiphenyl sulfone (3,3′-DDS); 4,4′-diaminodiphenyl sulfone (4,4′-DDS); 4,4′-diaminodiphenyl sulfide (ASD); 2,2-bis[4-(4-aminophenoxy)phenyl]sulfone (BAPS); 2,2-bis[4-(3-aminophenoxy)benzene] (m-BAPS); 1,4-bis(4-aminophenoxy)benzene (TPE-Q); 1,3-bis(4-aminophenoxy)benzene (TPE-R); 1,3′-bis(3-aminophenoxy)benzene (APB-133); 4,4′-bis(4-aminophenoxy) biphenyl (BAPB); 4,4′-diaminobenzanilide (DABA); 9,9′-bis(4-aminophenyl) fluorene (FDA); o-tolidine sulfone (TSN); methylene bis(anthranilic acid) (MBAA); 1,3′-bis(4-aminophenoxy)-2,2-dimethylpropane (DANPG); 2,3,5,6-tetramethyl-1,4-phenylenediamine (TMPD); 3,3′,5,5′-tetramethylbenzidine (3355TMB); 1,5-bis(4-aminophenoxy) pentane (DA5MG); 2,5-diaminobenzotrifluoride (25DBTF); 3,5-diaminobenzotrifluoride (35DBTF); 1,3-diamino-2,4,5,6-tetrafluorobenzene (DTFB); 2,2′-bis(trifluoromethyl)benzidine (22TFMB); 3,3′-bis(trifluoromethyl)benzidine (33TFMB); 2,2-bis[4-(4-aminophenoxy phenyl)]hexafluoropropane (HFBAPP); 2,2-bis(4-aminophenyl) hexafluoropropane (Bis-A-AF); 2,2-bis(3-amino-4-hydroxyphenyl) hexafluoropropane (Bis-AP-AF); 2,2-bis(3-amino-4-methylphenyl) hexafluoropropane (Bis-AT-AF); o-phenylene diamine; diaminobenzanilide; 3,5-diaminobenzoic acid; 3,3′diaminodiphenylsulfone; 4,4′-diaminodiphenylsulfone; 1,3-bis(4-aminophenoxy)benzene; 1,3-bis(3-aminophenoxy)benzene; 1,4-bis(4-aminophenoxy)benzene; 1,4-bis(3-aminophenoxy)benzene; 2,2-bis[4-(4-aminophenoxy)phenyl]hexafluoropropane; 2,2-bis(3-aminophenyl) hexafluoropropane; 4,4′-isopropylidenedianiline; 1-(4-aminophenoxy)-3-(3-aminophenoxy)benzene; 1-(4-aminophenoxy)-4-(3-aminophenoxy)benzene; bis[4-(4-aminophenoxy)phenyl]sulfone; bis[4-(3-aminophenoxy)phenyl]sulfone; bis(4-[4-aminophenoxy]phenyl) ether; 2,2′-bis(4-aminophenyl) hexafluoropropene; 2,2′-bis(4-phenoxyaniline) isopropylidene; 1,2-diaminobenzene; 4,4′-diaminodiphenylmethane; 2,2-bis(4-aminophenyl) propane; 4,4′-diaminodiphenylpropane; 4,4′-diaminodiphenylsulfide; 4,4-diaminodiphenylsulfone; 3,4′-diaminodiphenylether; 4,4′-diaminodiphenylether; 2,6-diaminopyridine; bis(3-aminophenyl) diethylsilane; 4,4′-diaminodiphenyldiethylsilane; benzidine-3′-dichlorobenzidine; 3,3′-dimethoxybenzidine; 4,4′-diaminobenzophenone; N,N-bis(4-aminophenyl)butylamine; N,N-bis(4-aminophenyl)methylamine; 1,5-diaminonaphthalene; 3,3′-dimethyl-4,4′-diaminobiphenyl; 4-aminophenyl-3-aminobenzoate; N,N-bis(4-aminophenyl) aniline; bis(p-beta-amino tert-butyl phenyl) ether; p-bis-2-(2-methyl-4-aminopentyl)benzene; p-bis(1,1-dimethyl-5-aminopentyl)benzene; 1,3-bis(4-aminophenoxy)benzene; m-xylene diamine; p-xylene diamine; 4,4′-diamino diphenylether phosphine oxide; 4,4′-diamino diphenyl N-methylamine; 4,4′-diamino diphenyl N-phenylamine; amino-terminal polydimethylsiloxanes; amino-terminal polypropylene oxides; amino-terminal polybutylene oxides; 4,4′-methylene bis(2-methyl cyclohexylamine); 1,2-diaminocthane; 1,3-diaminopropane; 1,4-diaminobutane; 1,5-diaminopentane; 1,6-diaminohexane; 1,7-diaminoheptane; 1,8-diaminooctane; 1,9-diaminononane; 1,10-diaminodecane; 4,4′-methylene bis(benzeneamine); 2,2′-dimethyl benzidine; bisaniline-p-xylidene; 4,4′-bis(4-aminophenoxy) biphenyl; 3,3′-bis(4-aminophenoxy) biphenyl; 4,4′-(1,4-phenylene diisopropylidene)bisaniline; and/or 4,4′-(1,3-phenylene diisopropylidene)bisaniline.

In some embodiments in which polyimide aerogel is formed, the first diamine, the second diamine, and the third diamine are selected from the group consisting of 2,2′-dimethylbenzidine (DMBZ), 4,4′-oxydianiline (4,4-ODA), and 4,4′-[1,3-phenylenebis(1-methyl-ethylidene)]bisaniline (bisaniline-m). In some embodiments, it can be particularly advantageous if the first, second, or third diamine is bisaniline-m.

In some embodiments in which polyimide aerogel is formed, the first diamine is DMBZ, the second diamine is 4,4-ODA, and the third diamine is bisaniline-m. In certain embodiments, the first diamine is bisaniline-m, the second diamine is DMBZ, and the third diamine is 4,4-ODA. In certain embodiments the first diamine is bisaniline-m, the second diamine is 4,4-ODA, and the third diamine is DMBZ. In certain embodiments the first diamine is 4,4-ODA, the second diamine is DMBZ, and the third diamine is bisaniline-m. In certain embodiments the first diamine is 4,4-ODA, the second diamine is bisaniline-m, and the third diamine is DMBZ. In some embodiments, it can be particularly advantageous if the first diamine is DMBZ, the second diamine is bisaniline-m, and the third diamine is 4,4-ODA.

In some embodiments in which polyimide aerogel is formed, combining the amount of BPDA, the first diamine, and the solvent comprises combining the first diamine and the amount of BPDA in a relative amount, based on a ratio of the amount of BPDA to the first diamine, of between 0.9:1 and 1.1:1, between 1.4:1 and 1.6:1, between 1.6:1 and 1.8:1, between 1.9:1 and 2.1:1, and/or between 2.9:1 and 3.1:1. In some embodiments, it can be particularly advantageous if combining the amount of BPDA, the first diamine, and the solvent comprises combining the first diamine and the amount of BPDA in a relative amount, based on a ratio of the amount of BPDA to the first diamine, of between 1.9:1 and 2.1:1. In some embodiments, combining the first intermediate medium and a second diamine comprises combining the anhydride capped poly(amic acid) trimer and the second diamine in a relative amount, based on a molar ratio of the second diamine to the anhydride-capped poly(amic acid) trimer of between 0.9:1 and 1.1:1, between 1.4:1 and 1.6:1, between 1.6:1 and 1.8:1, between 1.9:1 and 2.1:1, and/or between 2.9:1 and 3.1:1. In some embodiments, it can be particularly advantageous if combining the first intermediate medium and a second diamine comprises combining the anhydride capped poly(amic acid) trimer and the second diamine in a relative amount, based on a molar ratio of the second diamine to the anhydride-capped poly(amic acid) trimer of between 1.9:1 and 2.1:1. In some embodiments, combining the second intermediate medium and the additional amount of BPDA comprises combining the pentamer and the additional amount of BPDA in a relative amount, based on a molar ratio of the additional amount of BPDA to the pentamer, of between 0.9:1 and 1.1:1, between 1.4:1 and 1.6:1, between 1.6:1 and 1.8:1, between 1.9:1 and 2.1:1, and/or between 2.9:1 and 3.1:1. In some embodiments, it can be particularly advantageous if combining the second intermediate medium and the additional amount of BPDA comprises combining the pentamer and the additional amount of BPDA in a relative amount, based on a molar ratio of the additional amount of BPDA to the pentamer, of between 1.9:1 and 2.1:1. In some embodiments, combining the third intermediate medium and the third diamine comprises combining the heptamer and the third diamine in a relative amount, based on the molar ratio of the third diamine to the heptamer, of between 0.4:1 and 0.6:1, between 0.8:1 and 1.1:1, between 0.8:1 and 1.1:1, between 1.8:1 and 2.2:1. In some embodiments, it can be particularly advantageous if combining the third intermediate medium and the third diamine comprises combining the heptamer and the third diamine in a relative amount, based on the molar ratio of the third diamine to the heptamer, of between 0.8:1 and 1.1:1. In some embodiments, combining the fourth intermediate medium and the crosslinking reagent comprises combining the oligomer chains and the crosslinking reagent in a relative amount, based on the molar ratio of the crosslinker to the oligomer chain, of between 0.5:1 and 0.75:1, 0.8:1 and 1.1:1, an/or between 1.4:1 and 1.6:1. In some embodiments the ratio is between 0.9:1 and 1.1:1, between 1.4:1 and 1.6:1, between 1.6:1 and 1.8:1, between 1.9:1 and 2.1:1, and/or between 2.9:1 and 3.1:1. In some embodiments, it can be particularly advantageous if combining the fourth intermediate medium and the crosslinking reagent comprises combining the oligomer chains and the crosslinking reagent in a relative amount, based on the molar ratio of the crosslinker to the oligomer chain, of between 1.9:1 and 2.1:1.

In some embodiments in which polyimide aerogel is formed, combining the fourth intermediate medium and the crosslinking reagent comprises combining the oligomer chains and the crosslinking reagent in a relative amount, based on the molar ratio of the crosslinker to the oligomer chain, of between 0.5:1 and 0.75:1.

In some embodiments in which polyimide aerogel is formed, combining the fourth intermediate medium and the crosslinking agent also comprises combining a catalyst with the fourth intermediate medium and the crosslinking agent. In some embodiments the catalyst comprises pyridine; a methylpyridine; quinoline; isoquinoline; 1,8-diazabicyclo[5.4.0]undec-7-ene (DBU); DBU phenol salts; carboxylic acid salts of DBU; tricthylenediamine; a carboxylic acid salt of triethylenediamine; lutidine; n-methylmorpholine; triethylamine; tripropylamine; tributylamine; N,N-dimethylbenzylamine; N,N′-dimethylpiperazine; N,N-dimethylcyclohexylamine; N,N′,N″-tris(dialkylaminoalkyl)-s-hexahydrotriazines, for example N,N′,N″-tris(dimethylaminopropyl)-s-hexahydrotriazine; tris(dimethylaminomethyl) phenol; bis(2-dimethylaminoethyl) ether; N,N,N,N,N-pentamethyldiethylenetriamine; methylimidazole; dimethylimidazole; dimethylbenzylamine; 1,6-diazabicyclo[5.4.0]undec-7-ene (IUPAC: 1,4-diazabicyclo[2.2.2]octane); tricthylenediamine; dimethylaminoethanolamine; dimethylaminopropylamine; N,N-dimethylaminoethoxyethanol; N,N,N-trimethylaminoethylethanolamine; triethanolamine; diethanolamine; triisopropanolamine; diisopropanolamine; and/or any suitable trialkylamine. In some embodiments, it can be particularly advantageous if the catalyst comprises triethylamine and/or tripropylamine.

In some embodiments in which polyimide aerogel is formed, combining the fourth intermediate medium and the crosslinking reagent also comprises combing a water scavenger with the fourth intermediate medium and the crosslinking agent. In some embodiments, combining the fourth intermediate medium and the crosslinking reagent comprises combining the oligomer chains and the water scavenger in a relative amount, based on the molar ratio of the water scavenger to BPDA, of between 2:1 and 4:1, between 4:1 and 6:1, between 6:1 and 8:1, and or between 8:1 and 10:1. In some embodiments, it can be particularly advantageous if the ratio is between 7:1 and 9:1. In some embodiments the water scavenger comprises acetic anhydride, propionic anhydride, n-butyric anhydride, benzoic anhydride, trifluoroacetic anhydride, phosphorous trichloride, and/or dicyclohexylcarbodiimide. In some embodiments, it can be particularly advantageous if the water scavenger comprises acetic anhydride.

In some embodiments in which polyimide aerogel is formed, a solvent is used. In some embodiments the solvent comprises dimethylsulfoxide; diethylsulfoxide; N,N-dimethylformamide; N,N-diethylformamide; N,N-dimethylacetamide; N,N-diethylacetamide; N-methyl-2-pyrrolidone; 1-methyl-2-pyrrolidinone; N-cyclohexyl-2-imidazolidinone; diethylene glycol dimethoxyether; o-dichlorobenzene; phenols; cresols; xylenol; catechol; butyrolactones; acetone; methyl ethyl ketone; ethyl ethyl ketone; methyl propyl ketone; acetonitrile; ethyl acetate; and/or hexamethylphosphoramides. In some embodiments, it can be particularly advantageous if the solvent comprises N-methyl-2-pyrrolidone.

In some embodiments in which polyimide aerogel is formed, the total amount of monomer is determined relative to the amount of solvent used. In certain embodiments, the total mass of all monomers is greater than 5% of the total mass of the solvent.

In some embodiments in which polyimide aerogel is formed, a polyimide gel is derived from the reaction of one or more anhydrides with one or more isocyanates. In some embodiments, the anhydride comprises a dianhydride. In some embodiments, the isocyanate comprises a diisocyanate, a triisocyanate, tris(isocyanatophenyl) methane, a toluene diisocyanate trimer, and/or methylenediphenyl diisocyanate trimer. In some embodiments, the anhydride and isocyanate are contacted in a suitable solvent.

In some embodiments in which polyimide aerogel is formed, the isocyanate comprises a triisocyanate; an aliphatic triisocyanate; an aromatic isocyanate comprising three or more isocyanate groups; an aromatic triisocyanate; a triisocyanate based on hexamethylene diisocyanate; the trimer of hexamethylenediisocyanate; hexamethylenediisocyanate; a triisocyanate comprising isocyanurate; a diisocyanate comprising isocyanurate; Desmodur® N3200; Desmodur N3300; Desmodur N100; Desmodur N3400; Desmodur N3390; Desmodur N3390 BA/SN; Desmodur N3300 BA; Desmodur N3600; Desmodur N3790 BA; Desmodur N3800; Desmodur N3900; Desmodur XP 2675; Desmodurblulogiq 3190; Desmodur XP 2860; Desmodur N3400; Desmodur XP 2840; Desmodur N3580 BA; Desmodur N3500; Desmodur RE; tris(isocyanatophenyl) methane; Desmodur RC; Mondur® MR; Mondur MRS; a methylene diphenyl diisocyanate; diphenylmethane 2,2′-, 2,4′- and/or 4,4′-diisocyanate (MDI); naphthylene 1,5-diisocyanate (NDI); a toluene diisocyanate; toluene 2,4- and/or 2,6-diisocyanate (TDI); 3,3′-dimethylbiphenyl diisocyanate; 1,2-diphenylethane diisocyanate and/or p-phenylenediisocyanate (PPDI); trimethylene, tetramethylene, pentamethylene, hexamethylene, heptamethylene and/or octamethylenediisocyanate; 2-methylpentamethylene 1,5-diisocyanate; 2-ethylbutylene 1,4-diisocyanate; pentamethylene 1,5-diisocyanate; butylene 1,4-diisocyanate; 1-isocyanato-3,3,5-trimethyl-5-isocyanatomethylcyclohexane (isophoronediisocyanate, IPDI); 1,4- and/or 1,3-bis(isocyanatomethyl)cyclohexane (HXDI); cyclohexane 1,4-diisocyanate; 1-methylcyclohexane 2,4-diisocyanate; 1-methylcyclohexane 2,6-diisocyanate; dicyclohexylmethane 4,4′-diisocyanate; dicyclohexylmethane 2,4′-diisocyanate; and/or dicyclohexylmethane 2,2′-diisocyanatc.

In some embodiments in which polyimide aerogel is formed, the anhydride comprises an aromatic dianhydride; an aromatic trianhydride; an aromatic tetraanhydride; an aromatic anhydride having from 6 to 24 carbon atoms and from 1 to 4 aromatic rings which may be fused, coupled by biaryl bonds, or linked by one or more linking groups selected from C1-6 alkylene, oxygen, sulfur, keto, sulfoxide, sulfone and the like; biphenyl-3,3′,4,4′-tetracarboxylic dianhydride (BPDA); 3,3′,4,4′-biphenyl tetracarboxylicdianhydride; 2,3,3′,4′-biphenyl tetracarboxylic acid dianhydride (a-BPDA); 2,2′,3,3′-biphenyl tetracarboxylicdianhydride; 3,3′,4,4′-benzophenone-tetracarboxylic dianhydride; benzophenone-3,3′,4,4′-tetracarboxylic dianhydride (BTDA); pyromelliticdianhydride; 4,4′-hexafluoro isopropylidenebisphthalicdianhydride (6FDA); 4,4′-(4,4′-isopropylidene diphenoxy)-bis(phthalic anhydride); 4,4′-oxydiphthalic anhydride (ODPA); 4,4′-oxydiphthalic dianhydride; 3,3′,4,4′-diphenylsulfonetetracarboxylicdianhydride (DSDA); hydroquinone dianhydride; hydroquinone diphthalic anhydride (HQDEA); 4,4′-bisphenol A dianhydride (BPADA); ethylene glycol bis(trimellitic anhydride) (TMEG); 2,2-bis(3,4-dicarboxyphenyl) propanedianhydride; bis(3,4-dicarboxyphenyl) sulfoxide dianhydride; poly(siloxane-containing dianhydride); 2,3,2′,3′-benzophenone tetracarboxylicdianhydride; 3,3′,4,4′-benzophenone tetracarboxylic dianhydride; naphthalene-2,3,6,7-tetracarboxylic dianhydride; naphthalene-1,4,5,8-tetracarboxylic dianhydride; 3,3′,4,4′-biphenylsulfone tetracarboxylicdianhydride; 3,4,9,10-perylene tetracarboxylicdianhydride; bis(3,4-dicarboxyphenyl) sulfide dianhydride; bis(3,4-dicarboxyphenyl) methane dianhydride; 2,2-bis(3,4-dicarboxyphenyl) propane dianhydride; 2,2-bis(3,4-dicarboxyphenyl) hexafluoropropene; 2,6-dichloro naphthalene 1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; phenanthrene-8,9,10-tetracarboxylic dianhydride; pyrazine-2,3,5,6-tetracarboxylic dianhydride; benzene-1,2,3,4-tetracarboxylic dianhydride; and/or thiophene-2,3,4,5-tetracarboxylic dianhydride. In some embodiments, it can be particularly advantageous if the dianhydride comprises biphenyl-3,3′,4,4′-tetracarboxylic dianhydride (BPDA).

In some embodiments in which polyimide aerogel is formed, a polyimide gel is derived from the reaction of an amine with an anhydride. In some embodiments, the reaction of amine and anhydride forms poly(amic acid) oligomers. In some embodiments the poly(amic acid) oligomers are chemically imidized to yield polyimide oligomers. In some embodiments chemical imidization is achieved by contacting the poly(amic acid) oligomer with a dehydrating agent. In some embodiments the dehydrating agent comprises acetic anhydride, propionic anhydride, n-butyric anhydride, benzoic anhydride, trifluoroacetic anhydride, phosphorous trichloride, and/or dicyclohexylcarbodiimide. In some embodiments chemical imidization is catalyzed by contacting the solution comprised of poly(amic acid) oligomers and dehydrating agent(s) with an imidization catalyst.

In some embodiments in which polyimide aerogel is formed, a polyimide gel is derived from the reaction of an amine with an anhydride. In some embodiments, the reaction of amine and anhydride forms poly(amic acid) oligomers. In some embodiments the poly(amic acid) oligomers are thermally imidized to yield polyimide oligomers. In some embodiments, the poly(amic acid) oligomers are heated to a temperature of greater than or equal to 80° C., greater than or equal to 90° C., greater than or equal to 100° C., greater than or equal to 150° C., greater than or equal to 180° C., greater than or equal to 190° C., or any suitable temperature.

In some embodiments in which polyimide aerogel is formed, the diamine and/or dianhydride may be selected based on commercial availability and/or price. In some embodiments, the diamine and/or dianhydride may be selected based on desired material properties. In some embodiments, a specific diamine and/or dianhydride may impart specific properties to the polymer. For example, in some embodiments, diamines and/or dianhydrides with flexible linking groups between phenyl groups can be used to make polyimide aerogels with increased flexibility. In some embodiments, diamines and/or dianhydrides comprising pendant methyl groups can be used to make polyimide aerogels with increased hydrophobicity. In other embodiments, diamines and/or dianhydrides comprising fluorinated moieties such as trifluoromethyl can be used to make polyimide aerogels with increased hydrophobicity.

In some embodiments in which polyimide aerogel is formed, two or more diamines and/or two or more dianhydrides are used. In an illustrative embodiment, two diamines are used. The mole percent of the first diamine relative to the total of the two diamines can be varied from 0% to 100%. The mole percent of the first diamine relative to the total of the two diamines comprises, in some embodiments, less than or equal to 99.9%, less than or equal to 90%, less than or equal to 80%, less than or equal to 70%, less than or equal to 60%, less than or equal to 50%, less than or equal to 40%, less than or equal to 30%, less than or equal to 20%, less than or equal to 10%, less than or equal to 0.1%, or less. In further embodiments, wherein more than two diamines are used, the mole percent of each diamine relative to the total diamines can be varied from 0.1% to 99.9%. In a further illustrative example, two dianhydrides are used. The mole percent of the first dianhydride relative to the total of the two dianhydride can be varied from 0.1% to 99.9%. In some embodiments, the mole percent of the first dianhydride relative to the total of the two dianhydrides comprises less than or equal to 99.9%, less than or equal to 90%, less than or equal to 80%, less than or equal to 70%, less than or equal to 60%, less than or equal to 50%, less than or equal to 40%, less than or equal to 30%, less than or equal to 20%, less than or equal to 10%, less than or equal to 0.1%, or less. In further embodiments, wherein more than two dianhydrides are used, the mole percent of each dianhydride relative to the total dianhydride can be varied from 0.1% to 99.9%.

In some embodiments in which polyimide aerogel is formed, multiple diamines are used. In some embodiments, the first diamine is added to the solvent, after which the dianhydride is then added. In some embodiments, each amino site on the diamine reacts with an anhydride site on different dianhydrides, such that anhydride-terminated oligomers are formed. In some embodiments, a second diamine is then added to the solution. These diamines react with terminal anhydrides on the oligomers in solution, forming longer amino-terminated oligomers. Oligomers of varying lengths result from such a process, and that an alternating motif of first diamine, then dianhydride, then second diamine, results. Without wishing to be bound by any particular theory, it is believed that this approach encourages spatial homogeneity of properties throughout the gel network, where simply mixing all monomers together simultaneously and allowing dianhydrides and diamines to react with other simultaneously at random may lead to phase segregation of domains rich in one particular diamine and/or spatial heterogeneity.

In some embodiments in which polyimide aerogel is formed, the weight, i.e., mass, percent polymer in solution is controlled during polyimide gel synthesis. The term weight percent polymer in solution refers to the weight of monomers in solution minus the weight of byproducts resulting from condensation reactions among the monomers, relative to the weight of the solution. The weight percent polymer in solution can be less than or equal to 1%, less than or equal to 2%, less than or equal to 3%, less than or equal to 4%, less than or equal to 5%, less than or equal to 6%, less than or equal to 7%, less than or equal to 8%, less than or equal to 9%, less than or equal to 10%, less than or equal to 12%, less than or equal to 14%, less than or equal to 16%, less than or equal to 18%, less than or equal to 20%, and/or between 20% and 30%. In some embodiments, it can be particularly advantageous if the weight percent polymer is between 5% and 15%.

In some embodiments in which polyimide aerogel is formed, the reaction of diamine and dianhydride produces an oligomer comprising a repeating unit of at least a diamine and a dianhydride. In some embodiments, the oligomer comprises 1 repeat unit, 2 repeat units, less than or equal to 5 repeat units, less than or equal to 10 repeat units, less than or equal to 20 repeat units, less than or equal to 30 repeat units, less than or equal to 40 repeat units, less than or equal to 50 repeat units, less than or equal to 60 repeat units, less than or equal to 80 repeat units, less than or equal to 100 repeat units, or less than or equal to 200 repeat units. In some embodiments, the oligomer has an average degree of polymerization of less than or equal to 10, less than or equal to 20, less than or equal to 30, less than or equal to 40, less than or equal to 60, less than or equal to 80, or less than or equal to 100. In some embodiments, the oligomer comprises terminal anhydride groups, i.e., both ends of the oligomer comprise a terminal anhydride group. In some embodiments, the oligomer comprises terminal amine groups, i.e., both ends of the oligomer comprise a terminal amine group.

In some embodiments in which polyimide aerogel is formed, a method for making an aerogel comprises providing a solvent (e.g., any of the solvents described elsewhere herein), adding a first diamine (e.g., any of the diamines described elsewhere herein) to the solvent, adding a first amount of a dianhydride (e.g., any of the dianhydrides described elsewhere herein) to the solvent after adding the first diamine, adding a second diamine (e.g., any of the diamines described elsewhere herein) to the solvent after adding the first amount of dianhydride, adding a second amount of a dianhydride (e.g., any of the dianhydrides described elsewhere herein) to the solvent after adding the second diamine, adding a third diamine to the solvent after adding the second amount of dianhydride, adding a crosslinker (e.g., any of the crosslinkers and/or crosslinking agents described herein) to the solvent, adding a catalyst (e.g., any of the catalysts described herein) to the solvent, and adding a water scavenger (e.g., any of the water scavengers described herein) to the solvent to form a gel comprising poly(amic acid) and/or polyimide, optionally replacing at least a portion of the liquid in the resulting gel with a second liquid (e.g., and of the solvents and/or pore fluids described herein), and then removing at least a portion of the liquid from the gel (e.g., using any of the suitable drying methods described herein) to form an aerogel.

While various embodiments above and elsewhere herein describe polyimide aerogels, the aerogel may include a variety of other suitable materials. In some embodiments, the aerogel component of the aerogel/foam material combination comprises polyurea, a polyurethane, a polyisocyanate, a polyisocyanurate, a polyimide, a polyamide, a poly(imide-amide), a polyacrylonitrile, a polycyclopentadiene, a polybenzoxazine, a polybenzazazine, a polyacrylamide, a polynorbornene, a poly(ethylene terephthalate), a poly(ether ether ketone), a poly(ether ketone ketone), a phenolic polymer, a resorcinol-formaldehyde polymer, a melamine-formaldehyde polymer, a resorcinol-melamine-formaldehyde polymer, a furfural-formaldehyde polymer, a resole, a novolac, an acetic-acid-based polymer, a polymer-crosslinked oxide, a silica-polysaccharide polymer, a silica-pectin polymer, a polysaccharide, a glycoprotein, a proteoglycan, collagen, a protein, a polypeptide, a nucleic acid, amorphous carbon, graphitic carbon, graphene, diamond, a carbon nanotube, boron nitride, a boron nitride nanotube, two-dimensional boron nitride, an alginate, a chitin, a chitosan, a pectin, a gelatin, a gelan, a gum, an agarose, an agar, a cellulose, a virus, a biopolymer, an ormosil, an organic-inorganic hybrid material, a rubber, a polybutadiene, a poly(methyl pentene), a polyester, a polyether ether ketone, a polyether ketone ketone, a polypentene, a polybutene, a polytetrafluoroethylene, a polyethylene, a polypropylene, a polyolefin, a metal nanoparticle, a metalloid nanoparticle, a metal chalcogenide, a metalloid chalcogenide, a metal, a metalloid, a metal carbide, a metalloid carbide, a metal nitride, a metalloid nitride, a metal silicide, a metalloid silicide, a metal phosphide, a metalloid phosphide, a phosphorous-containing organic polymer, and/or a carbonizable polymer. Additional non-limiting examples of suitable materials include, for example, silica, metal and/or metalloid oxides, metal chalcogenides, metals and/or metalloids, metal and/or metalloid carbides, metal and/or metalloid nitrides, organic polymers, biopolymers, amorphous carbon, graphitic carbon, diamond, and discrete nanoscale objects such as carbon nanotubes, boron nitride nanotubes, viruses, semiconducting quantum dots, graphene, 2D boron nitride, or combinations thereof. Other materials are possible.

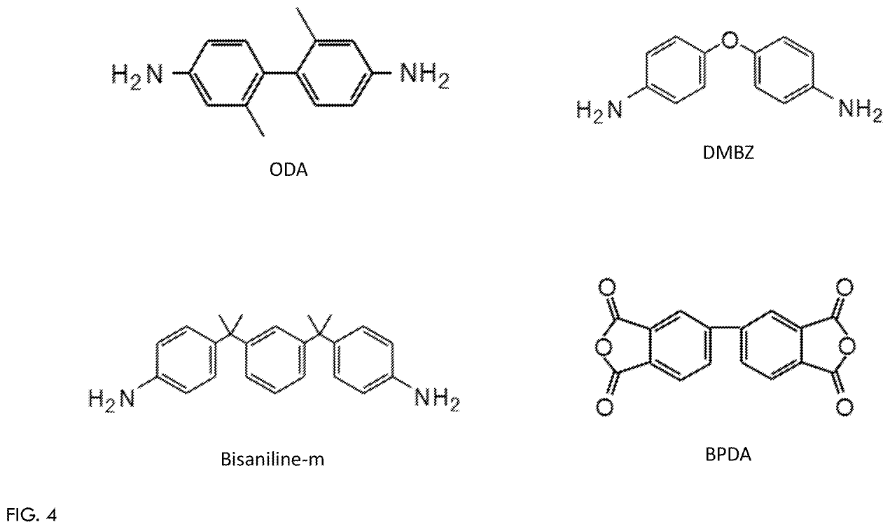

In some embodiments, it can be particularly advantageous if a polymer aerogel comprises a three-dimensional network of organic polymer comprising monomers and/or crosslinks of functionality three or greater, e.g., it comprises the reaction product of a crosslinking agent and three or more oligomers and/or the reaction product of a monomer with three or more other monomers. For example, FIG. 4 shows non-limiting examples of molecular structures of monomers that can be used to make the aerogel, including ODA (4,4′-oxydianiline), DMBZ (2,2′-dimethylbenzidine), bisaniline-m, and BPDA (biphenyl-tetracarboxylic acid dianhydride). In some embodiments, it can be particularly advantageous if a polymer network comprising trifunctional or higher functionality monomers and/or crosslinking agents provides for an aerogel with suitable strength, stiffness, and toughness properties for use as a structural material. In some embodiments, the strength, stiffness, and toughness properties of the aerogel are suitable for production of aerogel parts with large, e.g., greater than or equal to 30 cm, dimensions.

In some embodiments, the aerogel of the aerogel/foam material combination comprises a polyurea aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel in the aerogel/foam material combination is made of polyurea. The polyurea can be derived, in some embodiments, from the reaction of an isocyanate with water, in which amines are formed in situ. In some embodiments, the polyurea is derived from the reaction of an isocyanate with an amine. Fabrication of polyurea aerogels is described, for example, in U.S. Pat. No. 10,301,445, issued on May 28, 2019, and entitled “Three-Dimensional Porous Polyurea Networks and Methods of Manufacture,” which is incorporated herein by reference in its entirety for all purposes.

In some embodiments, the aerogel of the aerogel/foam material combination comprises a polyurethane aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel in the aerogel/foam material combination is made of polyurethane. The polyurethane can be derived, in some embodiments, from the reaction of an isocyanate and polyol. Fabrication of polyurethane aerogels is described, for example, in U.S. Pat. No. 8,927,079, issued on Jan. 6, 2015, and entitled “Porous Polyurethane Networks and Methods of Preparation,” which is incorporated herein by reference in its entirety for all purposes.

In some embodiments, the aerogel of the aerogel/foam material combination comprises a polyimide aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel in the aerogel/foam material combination is made of polyimide. The polyimide can be derived, in some embodiments, from the reaction of a dianhydride with a diisocyanate. Fabrication of polyimide aerogels is described, for example, in U.S. Pat. No. 9,745,198, issued on Aug. 29, 2017, and entitled “Porous Nanostructured Polyimide Networks and Methods of Manufacture,” which is incorporated herein by reference in its entirety for all purposes.

In some embodiments, the aerogel of the aerogel/foam material combination comprises a polyamide aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel in the aerogel/foam material combination is made of polyamide. The polyamide can be derived, in some embodiments, from the reaction of an amine and a carboxyl group. Polyamide can be derived, in some embodiments, from the reaction of an amine and an acyl chloride.

In some embodiments, the aerogel of the aerogel/foam material combination comprises a polyisocyanurate aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel in the aerogel/foam material combination is made of polyisocyanurate. Polyisocyanurate can be derived from the reaction of methylene diphenyl diisocyanate and polyol.

In some embodiments, the aerogel of the aerogel/foam material combination comprises a polyester aerogel. For example, in some embodiments, at least 25 wt %, at least 50 wt %, at least 75 wt %, at least 90 wt %, at least 95 wt %, at least 98 wt %, at least 99 wt %, at least 99.9 wt %, or all of the aerogel in the aerogel/foam material combination is made of polyester. Polyester can be derived, in some embodiments, from the reaction of acids and alcohols. In certain embodiments, polyester is derived from the alcoholysis and/or acidolysis of low-molecular weight esters. In some embodiments, polyester is derived from alcoholysis of acyl chlorides.

Any of a variety of foams can be used as the foam component of the aerogel/foam material combination.

As described herein a foam is distinguished from a batting. A batting comprises independent fibers that are intertwined mechanically, whereas a foam comprises ligaments that are connected to each other in a contiguous percolating network. In some embodiments, the ligaments of the foam are connected via intermolecular forces. In some embodiments, the ligaments of the foam are connected via covalent bonding.

In some embodiments, the foam can be a melamine-formaldehyde foam. In some embodiments, greater than or equal to 1 wt %, greater than or equal to 2 wt %, greater than or equal to 3 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of all solid components of the melamine-formaldehyde foam is made from a melamine-formaldehyde resin. Melamine-formaldehyde foams can be open celled or close celled. In some embodiments, the use of an open-celled foam is particularly advantageous.

Melamine-formaldehyde foams are generally made from a melamine-formaldehyde resin. Melamine-formaldehyde resins are thermosetting resins obtained by reacting melamine and formaldehyde and are a kind of amino resin, and those having a high molecular weight are in use as tableware or as surface sheets of tables, etc. Melamine-formaldehyde foams generally show excellent flame retardancy as compared with other organic resin foams. An example of a melamine-formaldehyde foam is the material sold under the trade name BASOTECT® from BASF. A melamine-formaldehyde foam in some embodiments comprises connected ligaments of melamine-formaldehyde polymer. In some embodiments the volume fraction of air in the melamine-formaldehyde foam can be at least 70%, at least 75%, at least 80%, at least 85%, at least 90%, at least 95%, at least 99% and/or less than or equal to 99.999%, less than or equal to 99%, less than or equal to 95%, less than or equal to 90%, less than or equal to 85%, less than or equal to 80%, or less than or equal to 75%. Combinations of these ranges are also possible (e.g., between 99% and 99.999%, between 95% and 99%, between 90% and 95%, between 85% and 90%, between 80% and 85%, between 75% and 80%, or between 70% and 75%).

In some embodiments, the melamine-formaldehyde foam is hydrophobic. In some embodiments, a bulk region of a solid from which the melamine-formaldehyde foam is made is hydrophobic. In some embodiments, hydrophobic material is positioned over (e.g., coated over) a solid from which the melamine-formaldehyde foam is made. In some embodiments, the melamine-formaldehyde foam is made hydrophobic by reacting the melamine-formaldehyde foam with a hydrophobe. In some embodiments, the melamine-formaldehyde foam is made hydrophobic by submerging the melamine-formaldehyde foam in a bath containing a hydrophobe.

In some embodiments, the bulk density of a melamine-formaldehyde foam (when isolated from the polymer aerogel) may be greater than or equal to 0.005 g/cc, greater than or equal to 0.01 g/cc, greater than or equal to 0.02 g/cc, greater than or equal to 0.03 g/cc, greater than or equal to 0.04 g/cc, greater than or equal to 0.05 g/cc, greater than or equal to 0.06 g/cc, greater than or equal to 0.07 g/cc, greater than or equal to 0.08 g/cc, greater than or equal to 0.09 g/cc, greater than or equal to 0.1 g/cc, greater than or equal to 0.11 g/cc, greater than or equal to 0.12 g/cc, greater than or equal to 0.13 g/cc, greater than or equal to 0.14 g/cc, greater than or equal to 0.15 g/cc, or greater than or equal to 0.16 g/cc (and/or, in some embodiments, as much as 1.0 g/cc, as much as 1.1 g/cc, as much as 1.2 g/cc, or more). In some embodiments, it can be particularly advantageous if the melamine-formaldehyde foam has a bulk density of greater than or equal to 0.005 g/cc and less than or equal to 0.15 g/cc when isolated from the polymer aerogel.

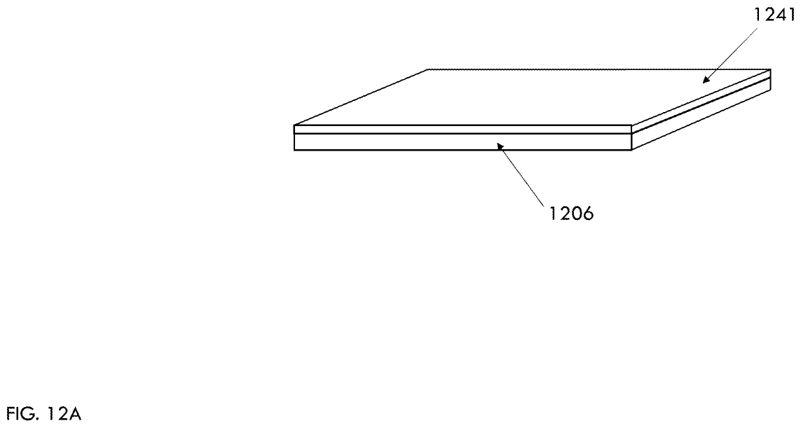

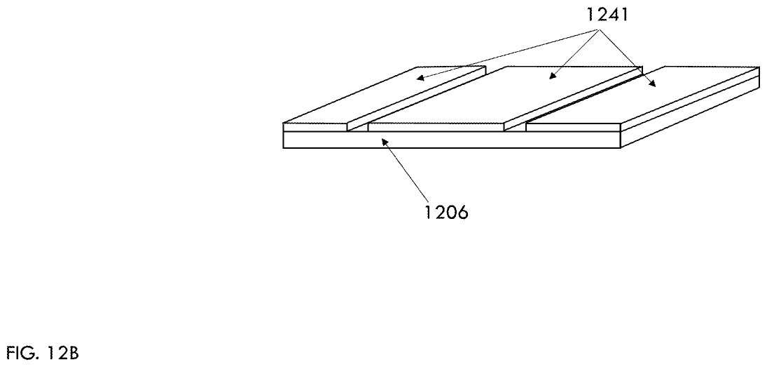

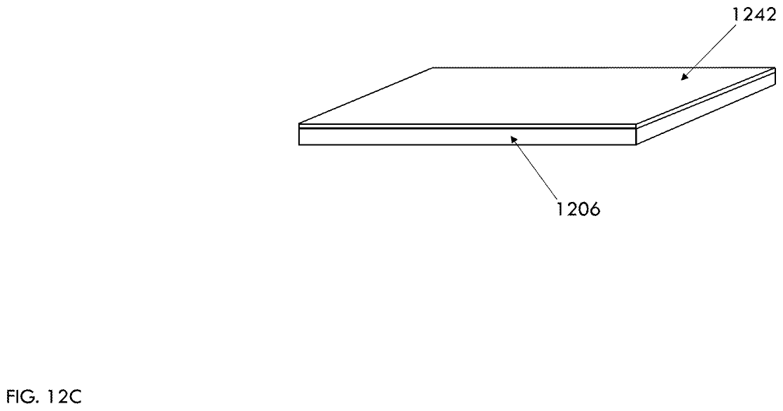

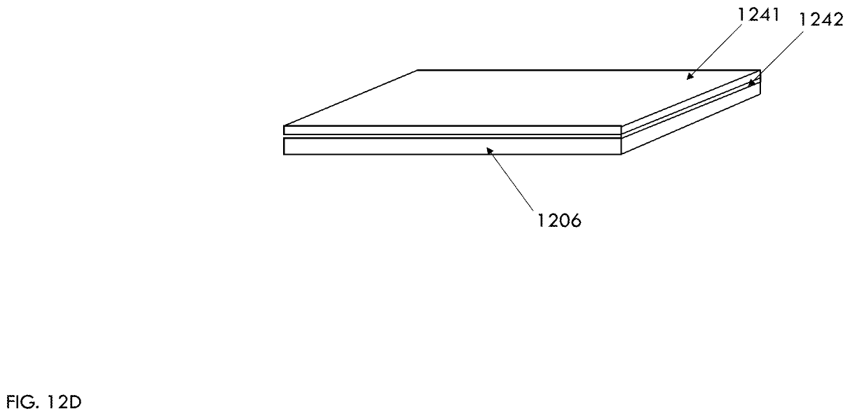

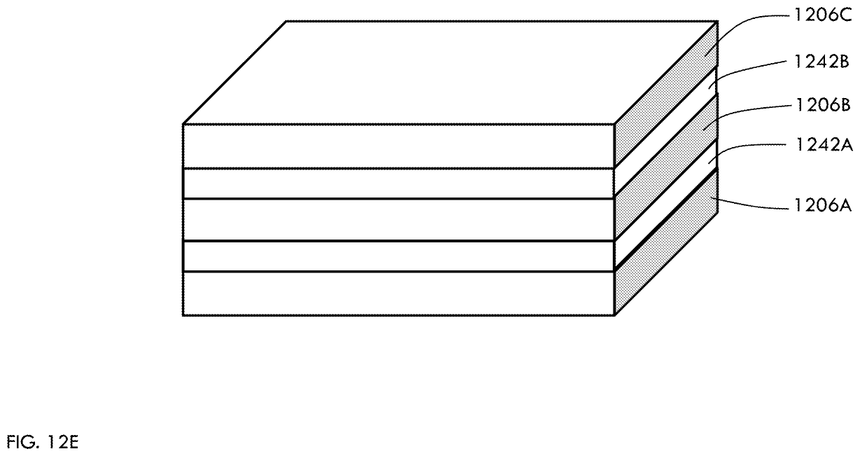

In some embodiments, an article comprising an aerogel/foam material combination comprises an adhesive applied to at least a portion of an external surface of the aerogel/foam material combination. For example, FIGS. 12C-12D schematically illustrate an adhesive 1242 over an exterior surface of the aerogel/foam material combination 1206. In some embodiments, the adhesive is applied in the form of a transfer tape. In some embodiments, the adhesive is sprayed on to the aerogel/foam material combination. In some embodiments, the adhesive is poured on to the aerogel/foam material combination. In further embodiments, the adhesive is spread on the aerogel/foam material combination. In some embodiments, the adhesive is applied in a uniform layer over an exterior face of the aerogel/foam material combination. In further embodiments, the adhesive is applied in a non-uniform layer over an exterior face of the aerogel/foam material combination. In some embodiments, the adhesive comprises an epoxy, an acrylic, an acrylonitrile, a polyamide, a polyester, a polysulfide, a polyvinyl acetate, a polyethylene, a polypropylene, a polyvinylpyrrolidone, a polyvinyl alcohol, a cyanoacrylate, a biopolymer, a polyurethane, a polyurca, an isocyanate, a silicone, and/or a gelatin. In some embodiments the adhesive covalently bonds with the aerogel/foam material combination. In some embodiments, the adhesive wicks in to one or more of the pores of the aerogel/foam material combination. In some embodiments, the adhesive is non-flammable. In some embodiments, the adhesive is heat activated.

In some embodiments, an article comprises an aerogel/foam material combination and a layer of facing material. For example, FIG. 12A schematically depicts an aerogel/foam material combination 1206 with a facing material 1241 on an exterior surface of aerogel/foam material combination 1206. The facing material may be arranged in any of a variety of ways on the aerogel/foam material combination. For example, FIG. 12A schematically depicts the facing material over the entirety of the exterior surface of aerogel/foam material combination 1206. In other embodiments, the facing material covers portions, but not necessarily the entirety of, an exterior surface of the aerogel/foam material combination. In FIG. 12B, for example, facing material 1241 covers only portions of the exterior surface of the aerogel/foam material combination 1206, relative to the embodiment illustrated in FIG. 12A.

In some embodiments, the facing material comprises a polymer, a metal, a ceramic, a fibrous sheet, and/or a carbon. In some embodiments, the facing material is chemically adhered to the aerogel/foam material combination. In some embodiments, the facing material is mechanically adhered to the aerogel/foam material combination. In some embodiments, the facing material is adhered to the aerogel/foam material combination using an adhesive. In FIG. 12D, for example, facing material 1241 is adhered to aerogel/foam material combination 1206 via adhesive 1242.

In some embodiments, the article comprising the aerogel/foam material combination also comprises more than one layer of facing material. In some embodiments, the article comprising the aerogel/foam material combination comprises a continuous layer of facing material. In other embodiments, the article comprising the aerogel/foam material combination comprises a discontinuous layer of facing material. In some embodiments, the article comprising the aerogel/foam material combination comprises a layer of uniform thickness of facing material. In other embodiments, the article comprising the aerogel/foam material combination comprises a layer of facing material that is not a uniform thickness.

In some embodiments, the facing material is in solid contact with the aerogel/foam material combination. Solid contact includes both direct solid contact and indirect solid contact. Two solid objects are said to be in “indirect solid contact” when there are one or more solid materials between them and at least one pathway can be traced from the first solid object to the second solid object that passes only through solid materials. As one example, if solid interlayer is between an aerogel/material combination and a facing material, the material combination and the facing material are said to be in indirect solid contact because a pathway can be traced from the aerogel/material combination, through the solid interlayer (a solid object), and to the facing layer. By contrast, two solid objects are said to be in “direct contact” when they are in direct physical contact with each other.

In certain aspects, the aerogel/foam material combinations described herein can be part of layered (e.g., a multi-layer) article. Generally, a layer is an arrangement of material having a thickness dimension, a width dimension (which is perpendicular to the thickness dimension) that is at least 5 times the thickness dimension, and a depth dimension (which is perpendicular to both the thickness dimension and the width dimension) that is at least 5 times the thickness dimension. In some embodiments, the layer is arranged such that the width dimension is at least 10 times, at least 50 times, at least 100 times, at least 500 times, or at least 1000 times the thickness dimension. In certain embodiments, the layer is arranged such that the depth dimension is at least 10 times, at least 50 times, at least 100 times, at least 500 times, or at least 1000 times the thickness dimension.

In some embodiments, an article comprises a first layer comprising an aerogel/foam material combination (e.g., comprising a melamine-formaldehyde foam and a polymer aerogel at least partially within the outer boundaries of the melamine-formaldehyde foam) adhered to a second layer (e.g., comprising an aerogel/foam material combination, such as a second melamine-formaldehyde foam with polymer aerogel at least partially within the outer boundaries of the melamine-formaldehyde foam). In some embodiments, a plurality of layers of aerogel/foam material combination are adhered to one another in order to achieve a desired thickness of an overall multi-layered article. In some embodiments, the plurality of layers comprises 2 layers, 3 or more layers, 4 or more layers, 5 or more layers, 6 or more layers, 7 or more layers, 8 or more layers, 9 or more layers, 10 or more layers, 15 or more layers, 20 or more layers, 25 or more layers, 30 or more layers, 35 or more layers, 40 or more layers, 45 or more layers, or 50 or more layers. In some embodiments, it can be advantageous to include at least 2 and less than or equal to 10 aerogel/foam material combination layers within the article.

In some embodiments, the aerogel/foam material combination layer(s) are secured with an adhesive. As an illustrative example, in some embodiments, one face of a first aerogel/foam material combination layer (e.g., a layer comprising a melamine-formaldehyde foam and a polyimide aerogel at least partially within the outer boundaries of the melamine-formaldehyde foam) is adhered to a first face of a second aerogel/foam material combination layer (e.g., a second layer comprising a melamine-formaldehyde foam and a polyimide aerogel at least partially within the outer boundaries of the melamine-formaldehyde foam), and a second face of the second aerogel/foam material combination layer is adhered to one face of a third aerogel/foam material combination layer (e.g., a third layer comprising a melamine-formaldehyde foam and a polyimide aerogel at least partially within the outer boundaries of the melamine-formaldehyde foam). One example of such an arrangement is shown in FIG. 12E, in which the top face of first aerogel/foam material combination layer 1206A is adhered (using adhesive 1242A) to the bottom face of second aerogel/foam material combination layer 1206B, and the top face of second aerogel/foam material combination layer 1206B is adhered (using adhesive 1242B) to the bottom face of third aerogel/foam material combination layer 1242C.

The aerogel/foam material combinations described herein can be used in any of a variety of applications.

In some embodiments, the aerogel/foam material combination is used in a vehicle. In some embodiments, the vehicle is an automobile, an airplane, a rocket, and/or a boat. In some embodiments, the aerogel/foam material combination is used as an aircraft wall panel. In some embodiments, the aerogel/foam material combination is used in an engine cover. In some embodiments, the aerogel/foam material combination is used in a battery pack.

In some embodiments, aerogel/foam material combinations are suitable for use as soundproofing, a component in a ballistics shield, panel, armor, protective vest, and/or bullet-proof armor, and/or vibration mitigating insulation. In some embodiments, it can be particularly advantageous to use the aerogel/foam material combination in ballistics armor, a shield, a panel, and/or a protective vest.

In some embodiments, the aerogel/foam material combination is used as a flexible tape. In some embodiments, the flexible tape may be used in construction applications. In some other embodiments, the flexible tape may be used in aerospace applications. In still further embodiments, the flexible tape may be used in automotive applications.

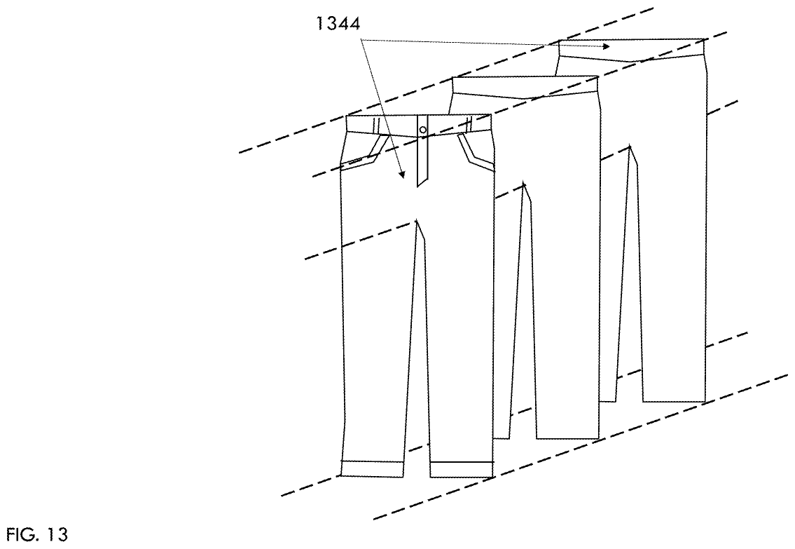

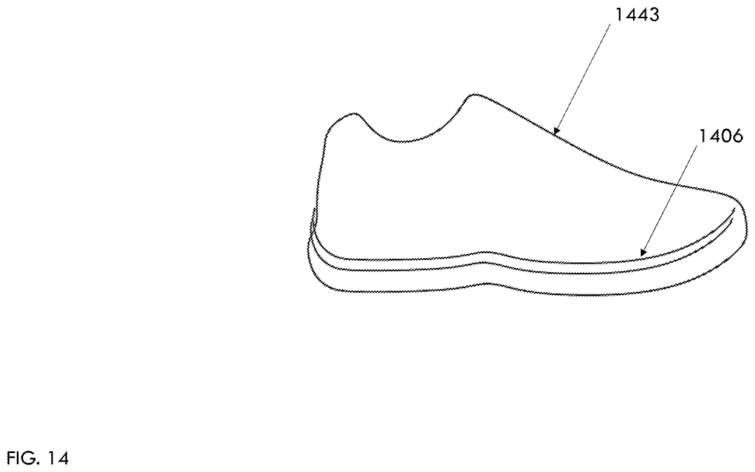

In some embodiments, the aerogel/foam material combination is used in an apparel garment. In some embodiments, the apparel garment is a jacket, a hat, gloves, a shirt, socks, pants, or any other apparel garment. For example, FIG. 13 schematically depicts pants 1344 that include an aerogel/foam material combination. In some embodiments, the aerogel/foam material combination is used in a wetsuit. In some embodiments, the aerogel/foam material combination is used in a shoe, a boot, or an insole. By way of illustration and not limitation, FIG. 14 schematically depicts a shoe 1443 including an insole 1406 comprising an aerogel/foam material combination. In some embodiments, the aerogel/foam material combination is sewn into an apparel garment. In some embodiments, the aerogel/foam material combination is laminated (e.g., chemically laminated) to a textile in an apparel garment. In some embodiments, the aerogel/foam material combination is adhered to a textile in an apparel garment. In some embodiments, the aerogel/foam material combination is sandwiched between two panels in an apparel garment.

### EXAMPLES

The following examples are intended to illustrate certain embodiments of the present invention but do not exemplify the full scope of the invention.

### Example 1: Melamine-Formaldehyde Foam and Polymer Material Combinations

A 2-mm thick melamine-formaldehyde (MF) open-celled foam and polymer sols were used to prepare material combinations of MF foam and polymer aerogels. Variations in density of the MF foam and polymer weight percent of the polymer aerogel were made. Additionally, variations where particulate material for purposes such as improved IR opacity and hydrophobicity were made and various loading levels of the particulate material were tried. Two polymer systems were used to make the material combinations: polyimide and polyurea. Bulk density and water uptake were determined at ambient temperature, and thermal conductivity was measured according to the calibrated hot plate method described elsewhere herein. A table outlining the various material combinations is provided below in Table 1.

TABLE 1
Properties of MF Foam and Polymer Aerogel Material Combinations

| | | | | | | Material | | |
|---|---|---|---|---|---|---|---|---|
| | | | | | | Combination | | |
| | | | Foam Bulk | | | Bulk | Thermal | Water |
| | Polymer | Foam | Density | Polymer | | Density | Conductivity | Uptake |
| Sample | Type | Type | [g/cc] | wt % | Additive | [g/cc] | [mW/m · K] | (%) |
| 1 | Polyimide | MF | 0.01 | 7.5 | | 0.09 | 20.0 ± 1.8 | |
| 2 | Polyimide | MF | 0.03 | 7.5 | | 0.10 | 20.7 ± 1.8 | 59 |
| 2a | Polyimide | MF | 0.03 | 7.5 | | 0.125 | 22.0 ± 2.2 | 74 |
| 2b | Polyimide | MF | 0.03 | 7.5 | | 0.132 | 30.1 ± 4.4 | 145 |
| 3 | Polyimide | MF | 0.05 | 7.5 | | 0.12 | 19.3 ± 2.0 | |
| 4 | Polyimide | MF | 0.07 | 7.5 | | 0.14 | 22.5 ± 1.6 | |
| 5 | Polyimide | MF | 0.09 | 7.5 | | 0.16 | 20.8 ± 2.0 | |
| 6 | Polyimide | MF | 0.03 | 5 | | 0.08 | 22.8 ± 2.1 | |
| 7 | Polyimide | MF | 0.03 | 6.25 | | 0.09 | 21.9 ± 2.0 | |
| 8 | Polyimide | MF | 0.03 | 8.5 | | 0.12 | 23.3 ± 2.5 | |
| 9 | Polyimide | MF | 0.03 | 10 | | 0.13 | 24.6 ± 1.9 | |
| 10 | Polyimide | MF | 0.03 | 12.5 | | 0.14 | 27.5 ± 2.6 | |
| 11 | Polyimide | MF | 0.03 | 7.5 | SiC | 0.12 | 21.2 ± 1.6 | |
| 12 | Polyimide | MF | 0.03 | 7.5 | SiC | 0.11 | 22.0 ± 1.9 | |
| 13 | Polyimide | MF | 0.03 | 7.5 | SiC | 0.12 | 22.2 ± 1.9 | |
| 14 | Polyimide | MF | 0.03 | 7.5 | | 0.10 | 20.2 ± 1.6 | 20.8 |
| 15 | Polyimide | MF | 0.03 | 7.5 | | 0.12 | 19.9 ± 1.8 | 21.9 |
| 16 | Polyimide | MF | 0.03 | 7.5 | | 0.11 | 27.4 ± 3.0 | 18.6 |
| 17 | Polyimide | MF | 0.03 | 7.5 | | 0.13 | 23 ± 2.0 | 18.5 |
| 18 | Polyimide | MF | 0.03 | 7.5 | | 0.11 | 20.4 ± 1.6 | 20.4 |
| 19 | Polyimide | MF | 0.03 | 7.5 | | 0.12 | 25.5 ± 2.4 | 16.8 |
| 20 | Polyurea | MF | 0.03 | | | 0.10 | 24.0 ± 1.0 | |

Polyimide sol was synthesized by reaction of an amine and an anhydride. To make 7.5 wt % polyimide sol, 0.71 g 2,2′-dimethylbenzidine (DMBZ) was dissolved in 79.75 g N-methyl-2-pyrrolidone (NMP). The mixture was stirred until DMBZ was fully dissolved (no particulates visible). After approximately 10 minutes of stirring, 1.96 g of biphenyl-3,3′,4,4′-tetracarboxylic dianhydride (BPDA) was added to this mixture and stirred for 10 minutes. After 10 minutes of stirring. 2.30 g of 4,4′-[1,3-phenylenebis(1-methyl-ethylidene)]bisaniline (bisaniline-m) was added to this mixture, and stirred for 10 minutes. After 10 minutes of stirring, 1.96 g of BPDA was added to this mixture, and stirred for 10 minutes. After 10 minutes of stirring, 0.60 g of 4,4′-oxydianiline (ODA) was added to this mixture and stirred for 10 minutes. After 10 minutes, a mixture of 0.12 g Desmodur N3300A and 8.86 g NMP was added to the first mixture and stirred for 10 minutes. After 10 minutes of stirring 10.90 g acetic anhydride and 2.70 g triethylamine were added in rapid succession. The resulting sol was stirred for 2-5 minutes until well mixed, then a piece of MF foam (approximately 4 inches by 6 inches by 2 mm) was submerged in the polyimide aerogel precursor for approximately 1-2 minutes until it appeared the MF foam had absorbed its maximum capacity of polyimide aerogel precursor. The combination of the polyimide aerogel precursor and MF foam were then removed from the bath of precursor and excess was allowed to drip from the infused foam. After a majority of the excess polyimide aerogel precursor dripped from the foam, the combination of the polyimide aerogel precursor and MF foam were placed in an air-tight container and left for 24 hours at room temperature. After 24 hours the combination of the polyimide gel and MF foam was removed from the container and transferred to a solvent exchange bath (in this case, a sealed container partially filled with approximately 500 mL of acetone). The combination remained submerged in acetone in the container for 72 hours, during which time the acetone was decanted and replaced with an equivalent volume of new acetone twice.

After solvent exchange was complete the combination of the polyimide gel and MF foam was transferred to a pressure vessel and submerged in excess acetone. The pressure vessel was then sealed, and liquid CO₂ was introduced into the pressure vessel. The CO₂-acetone mixture was drained periodically while simultaneously supplying fresh liquid CO₂ until all the acetone was removed. Then, the pressure vessel was isolated from the CO₂ supply while still filled with liquid CO₂. The pressure vessel was heated until the internal temperature reached 54° C., during which time pressure increased. Pressure was regulated by actuation of a solenoid valve and was not allowed to exceed 1400 psi. The CO₂ inside the vessel was at that time in the supercritical state, and it was held at these conditions for three hours, at which point the pressure vessel was slowly vented isothermally, such that the supercritical fluid entered the gaseous state without forming a two-phase liquid-vapor system, until the pressure vessel returned to atmospheric pressure. The pressure vessel was finally cooled to room temperature before the polyimide aerogel and MF foam material combination was retrieved.

Polyurea sol was synthesized from the reaction of an isocyanate and in-situ formed amines. 8.87 g Desmodur N3300 (the isocyanurate trimer of hexamethylene diisocyanate) was dissolved in 70.40 g acetone and stirred until homogenous (approximately 10 minutes). To this mixture 0.84 g deionized water was added and stirred for approximately 20 seconds. Next, 1.64 g triethylamine was added to the mixture, and stirred an additional 20 seconds. MF foam was submerged in the polyurea sol and was then solvent exchanged and dried as described above.

Samples 11-13 were prepared using the polyimide sol described above, except 3 μm silicon carbide (SiC) particulate material was added to the sol and mixed for about 5 minutes before the addition of triethylamine. The remainder of the procedure continued as outlined above. The concentration of SiC was varied across the three samples. Sample 11 had a concentration of 10 g SiC per 1 L of sol, sample 12 had a concentration of 5 g SiC per 1 L of sol, and sample 13 had a concentration of 20 g SiC per 1 L of sol.

Samples 14-19 were prepared using the polyimide sol described above with an additional step. In sample 14, the MF foam was submerged in a bath of acetone and dioctylamine with a molar ratio of 0.075:1 dioctylamine:acetone for about 24 hours. The MF foam was then removed from the bath and submerged in a new bath of acetone for about 24 hours to rinse the foam. The MF foam was then removed from the acetone and allowed to evaporatively dry for about 24 hours prior to submersion in the polyimide sol. The remainder of the material combination preparation procedure continues as outlined above. The Sample 15 combination of polyimide gel and MF foam was submerged in a bath of acetone and dioctylamine with a molar ratio of 0.01:1 dioctylamine:acetone prior to solvent exchange. The combination was then solvent exchanged and dried as described above.

In Sample 16, the MF foam was submerged in a bath of ethanol and 1,1,1,3,3,3-hexamethyldisilazane (HMDZ) with a molar ratio of 0.1:1 HMDZ:ethanol for about 24 hours. The MF foam was then removed from the bath and submerged in a new bath of ethanol for about 24 hours to rinse the foam. The MF foam was then removed from the ethanol and allowed to evaporatively dry for about 24 hours prior to submersion in the polyimide sol. The remainder of the material combination preparation procedure continues as outlined above. The Sample 17 combination of polyimide gel and MF was submerged in a bath of ethanol and HMDZ with a molar ratio of 0.01:1 HMDZ:ethanol prior to solvent exchange. The material combination was then solvent exchanged and dried as described above.

In Sample 18, the MF foam was submerged in a bath of ethanol and hexamethyldisiloxane (HMDSO), with a molar ratio of 0.1:1 HMDSO:ethanol and a drop of 37% HCl for about 24 hours. The MF foam was then removed from the bath and submerged in a new bath of ethanol for about 24 hours to rinse the foam. The MF foam was then removed from the ethanol and allowed to evaporatively dry for about 24 hours prior to submersion in the polyimide sol. The remainder of the material combination preparation procedure continued as outlined above. The Sample 19 combination of polyimide gel and MF foam was submerged in a bath of ethanol and HMDSO with a molar ratio of 0.01:1 HMDSO:ethanol and a drop of 37% HCl prior to solvent exchange. The material combination was then solvent exchanged and dried as described above.

The material combination described by Sample 2 was placed in an evenly heated oven at a temperature of 200° C. for 20 minutes. After the 20 minutes, the material combination (now Sample 2a) was removed from the oven and allowed to cool to ambient temperature before it was characterized. The Sample 2 material combination was placed in an evenly heated oven at a temperature of 300° C. for 20 minutes. After the 20 minutes, the material combination (now Sample 2b) was removed from the oven and allowed to cool to ambient temperature before it was characterized.

Generally, the samples that were produced had thermal conductivities below 30 mW/m-K, were flexible, and had a density of less than 0.3 g/cc.

### Comparative Example 1: Polyurethane Foam and Polymer Material Combinations

As a comparative example, a piece of open-celled polyurethane (PU) foam was submerged in polyimide sol following the same procedure for sol preparation and submersion outlined in Example 1. The polyurethane foam partially dissolved in the polyimide sol and a final material combination was not able to be produced.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an.” as used herein in the specification and in the claims, unless clearly indicated to the contrary, should be understood to mean “at least one.”

The phrase “and/or.” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B.” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either.” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A material combination, comprising:
a melamine-formaldehyde foam comprising an outer boundary; and
a polyimide aerogel at least partially within the outer boundary of the melamine-formaldehyde foam.

2. The material combination of claim 1, wherein:
the polyimide aerogel comprises an outer boundary, and
at least 75 vol % of the melamine-formaldehyde foam falls within the outer boundary of the polyimide aerogel, and/or
at least 75 vol % of the polyimide aerogel falls within the outer boundary of the melamine-formaldehyde foam.

3. The material combination of claim 1, wherein the polyimide aerogel is hydrophobic.

4. The material combination of claim 1, wherein the polyimide aerogel comprises the following moiety:

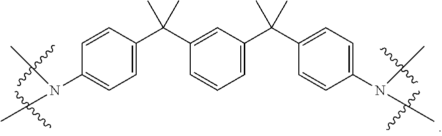 [SMILES: *N(*)c1ccc(C(C)(C)c2cccc(C(C)(C)c3ccc(N(*)*)cc3)c2)cc1]

5. The material combination of claim 1, wherein the polyimide aerogel comprises one or more of the following moieties:

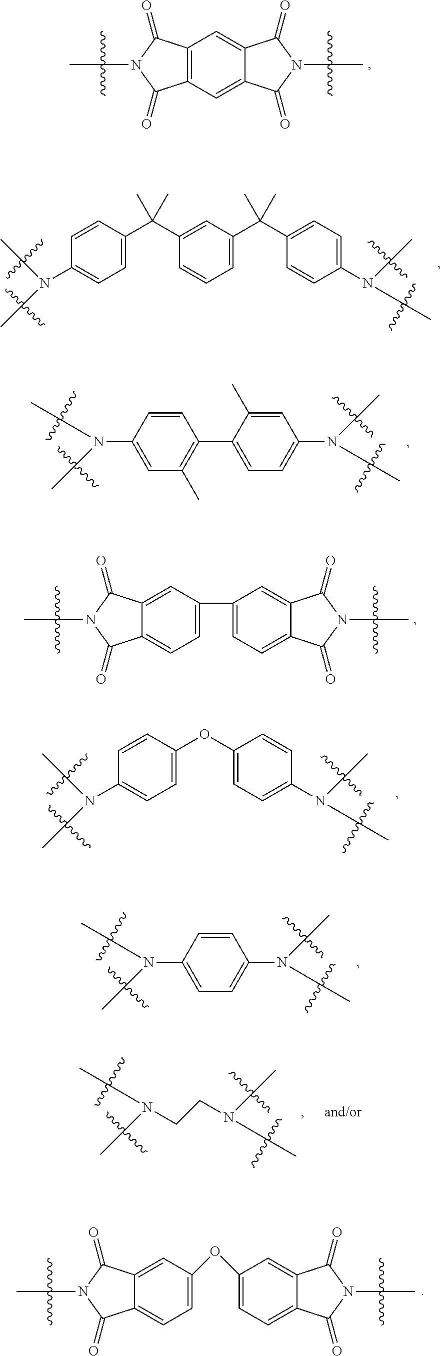

6. The material combination of claim 1, wherein the polyimide aerogel comprises the following moiety:

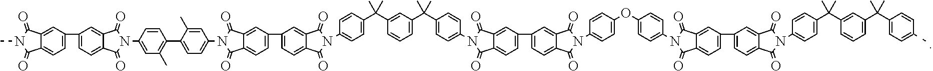

7. The material combination of claim 1, wherein the melamine-formaldehyde foam has a bulk density of greater than or equal to 0.005 g/cc and less than or equal to 0.15 g/cc when isolated from the polyimide aerogel.

8. The material combination of claim 1, wherein the melamine-formaldehyde foam is hydrophobic.

9. The material combination of claim 8, wherein a bulk region of a solid from which the melamine-formaldehyde foam is made is hydrophobic.

10. The material combination of claim 1, wherein hydrophobic material is positioned over a solid from which the melamine-formaldehyde foam is made.

11. The material combination of claim 1, wherein the material combination exhibits a bulk density of greater than or equal to 0.01 g/cc and less than or equal to 0.5 g/cc.

12. The material combination of claim 1, wherein the material combination exhibits a thermal conductivity of greater than or equal to 15 mW/m·K and less than or equal to 35 mW/m·K when measured according to the calibrated hot plate method with an average sample temperature of 25° C.

13. The material combination of claim 1, wherein the material combination exhibits a thermal conductivity of greater than or equal to 15 mW/m·K and less than or equal to 35 mW/m·K when measured according to ASTM Test Method E1225.

14. The material combination of claim 1, wherein:
the material combination exhibits a lower thermal conductivity than the polyimide aerogel when measured separately from the melamine-formaldehyde foam; and
the material combination exhibits a lower thermal conductivity than the melamine-formaldehyde foam when measured separately from the polyimide aerogel.

15. The material combination of claim 1, wherein:
the material combination exhibits a thermal conductivity that is at least 10% lower than the thermal conductivity of the polyimide aerogel when measured separately from the melamine-formaldehyde foam; and
the material combination exhibits a thermal conductivity that is at least 10% lower than the thermal conductivity of the melamine-formaldehyde foam when measured separately from the polyimide aerogel.

16. The material combination of claim 1, wherein:
the material combination exhibits a reduction in thermal conductivity of greater than or equal to 10% relative to the lower of the thermal conductivity of the melamine-formaldehyde foam when measured separately from the polyimide aerogel and the thermal conductivity of the polyimide aerogel when measured separately from the melamine-formaldehyde foam.

17. The material combination of claim 1, wherein, when the material combination is submerged under water at 25° C. for 24 hours, the material combination uptakes a mass of water within its outer boundary of less than or equal to 75% of the dry mass of the material combination prior to submerging in the water.

18. The material combination of claim 1, wherein the material combination meets the criteria for flame time, drip flame time, and/or burn length set forth in Part 25.853a of the United States Federal Aviation Regulations.

19-56. (canceled)

57. A method, comprising:
establishing contact between a melamine-formaldehyde foam and a liquid comprising polyimide aerogel precursor such that polyimide aerogel precursor penetrates an outer boundary of the melamine-formaldehyde foam; and
forming a polyimide aerogel from the polyimide aerogel precursor such that the polyimide aerogel is present within the outer boundary of the melamine-formaldehyde foam.

58-83. (canceled)

84. A material combination, comprising:
a melamine-formaldehyde foam comprising an outer boundary; and
a polymer aerogel at least partially within the outer boundary of the melamine-formaldehyde foam.

85-164. (canceled)
